(19) United States
(12) Patent Application Publication
(10) Pub. No.: US 2004/0133628 A1
(43) Pub. Date: Jul. 8, 2004

(54) Method and system for accessing a piece of content stored on an external content management system

(76) Inventors: Thomas Bennett, Outremont (CA); Sam Guembour, Lasalle (CA)

Correspondence Address: BAKER & DANIELS, 300 NORTH MERIDIAN STREET, SUITE 2700, INDIANAPOLIS, IN, 46204-1782, US

(21) Appl. No.: 10/659,161

(22) Filed: Sep. 10, 2003

(30) Foreign Application Priority Data
Sep. 10, 2002 (CA) 2,402,761

(51) Int. Cl. G06F 15/16

(52) U.S. Cl. 709/201; 719/315

(57) ABSTRACT

A system for a business process hosted on an application server to request content from an external content management system (CMS) independently of the manner in which the content is stored and a method for doing the same. The system comprises a CMS server for managing a content request from the business process to the external CMS; a CMS driver interface operatively associated with the external CMS for transmitting the content request between the external CMS and the CMS server, the CMS driver interface translating a piece of content corresponding to the content request from the external CMS into a specific object representation; and a CMS manager for managing the content request from the business process to the external CMS and keeping track of content available from the external CMS operatively associated with one of the corresponding CMS driver interface.

### FIELD OF THE INVENTION

The present invention relates to a method and system for accessing a piece of content stored on an external Content Management System (CMS) and more particularly to a method and system for a business processes wishing to access and modify content stored on an external CMS, without requiring the business processes to have prior knowledge of how or where the content is stored.

### DESCRIPTION OF THE PRIOR ART

The present invention is directed to ensuring how business processes, typically found in the middle tiers of a multi-tier architecture, can access content independent as to how the content is stored so that both the business processes and the content may continue to evolve independent of each other.

In the context of publishing, content can exist in many formats in many different locations, both from a geographic point of view as well as from a computer system point of view. In order to ensure that a publishing system can have access to all existing content and future content it is necessary to create a uniform method of representing and accessing it.

Existing methods that attempted to address this problem are general and do not sufficiently encapsulate the idea of content from the publishing perspective. These methods include SQL and ODBC, but are only useful if content exists in relational databases. These methods also require middle-ware to handle the accessing of the content.

The challenges in electronic publishing include being able to organize and provide access to content that may exist within or outside an organization, as well as unifying the access and work-flow of the content for users.

### SUMMARY OF THE INVENTION

An object of the invention is to provide a system that can overcome the problems identified in the prior art.

In broad terms, the present invention is directed to an interface defining the way in which a business process can interface with an external Content Management System.

Stated differently, the invention concerns a universal object representation of a CMS defining a partnership between hierarchically organized content and the business processes wishing to access and modify the content, without requiring the business processes to have prior knowledge of how or where the content is stored.

The invention further defines a model to manage multiple content sources each providing access to the abstracted content using the same interface.

According to the present invention, there is provided a method for a business process hosted on an application server to request content from at least one external content management system independently of the manner in which the content is stored. The method comprises the step of making a content request from the business process to one of the at least one external content management system via a content management system server managing the content request from the business process to one of the at least one external content management system; transmitting the content request between one of the at least one external content management system and the content management system server via a content management system driver interface translating a piece of content corresponding to the content request from one of the at least one external content management system into a specific object representation, the content management system driver interface being operatively associated with the at least one external content management system; managing the content request from the business process to one of the at least one external content management system and keeping track of content available from one of said at least one external content management system operatively associated with the corresponding content management system driver interface via a content management system manager; and relaying the specific object representation of the content from the content management system driver interface to the business process via the content management system server.

According to the present invention, there is also provided a system for a business process hosted on an application server to request content from at least one external content management system independently of the manner in which the content is stored. The system comprises a content management system server for managina a content request from the business process to the external content management system; a content management system driver interface operatively associated with the at least one external content management system for transmitting the content request between one of the at least one external content management system and the content management system server, the content management system driver interface translating a piece of content corresponding to the content request from one of the at least one external content management system into a specific object representation; and a content management system manager for managing the content request from the business process to one of the at least one external content management system and keeping track of content available from one of the at least one external content management system operatively associated with one of the corresponding content management system driver interface. The content management system server relays the specific object representation of the content from the content management system driver interface to the business process.

### BRIEF DESCRIPTION OF THE DRAWINGS

The present invention will be better understood after having read a detailed description of preferred embodiments thereof made in reference to the following drawings, in which like numbers refer to like elements:

FIG. 1 is a schematic high-level representation of a system according to a preferred embodiment of the present invention.

FIGS. 2 to 7 are schematic representations of UML class models of a system according to a preferred embodiment of the invention, showing different packages.

FIG. 8 is a schematic representation of relationships between the business process and the external CMS in the context of deployment in a web-server environment, according to a preferred embodiment of the present invention.

### DESCRIPTION OF A PREFERRED EMBODIMENT OF THE INVENTION

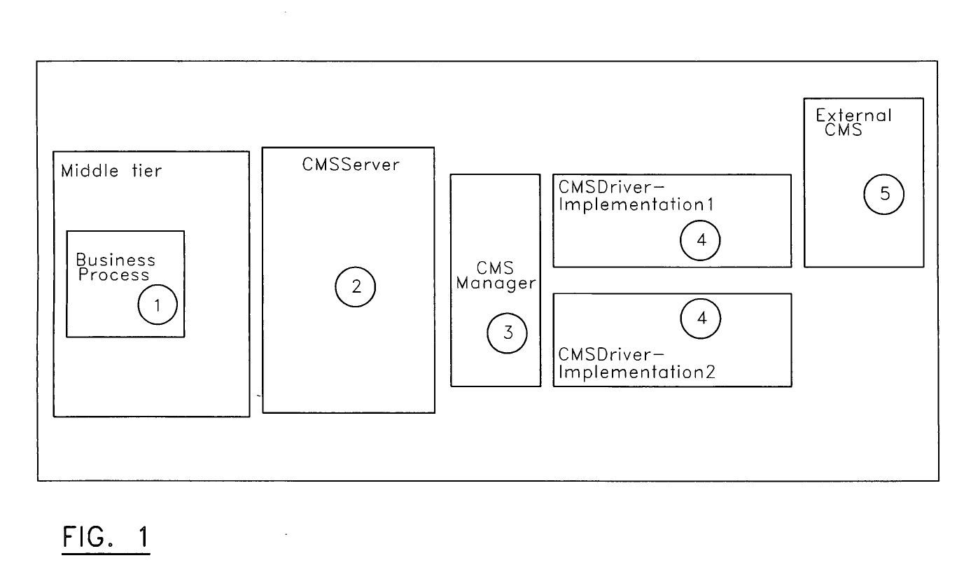

Referring now to FIG. 1, there is shown a high-level representation of a system according to a preferred embodiment of the present invention For a business process 1 hosted on an application server to request content from one external Content Management System 5 (hereinafter referred to as external CMS) independently of the manner in which the content is stored, a universal object representation of a Content Management System (hereinafter referred to as CMS) is provided. This universal object representation of the CMS comprises a Content Management System Server 2, a Content Management System Manager 3, and a Content Management System Driver Interface 4 (hereinafter referred to as CMS Server, CMS Manager and CMS Driver Interface). The CMS Server, CMS Manager and CMS Driver Interface are all implemented according to a set of abstract classes.

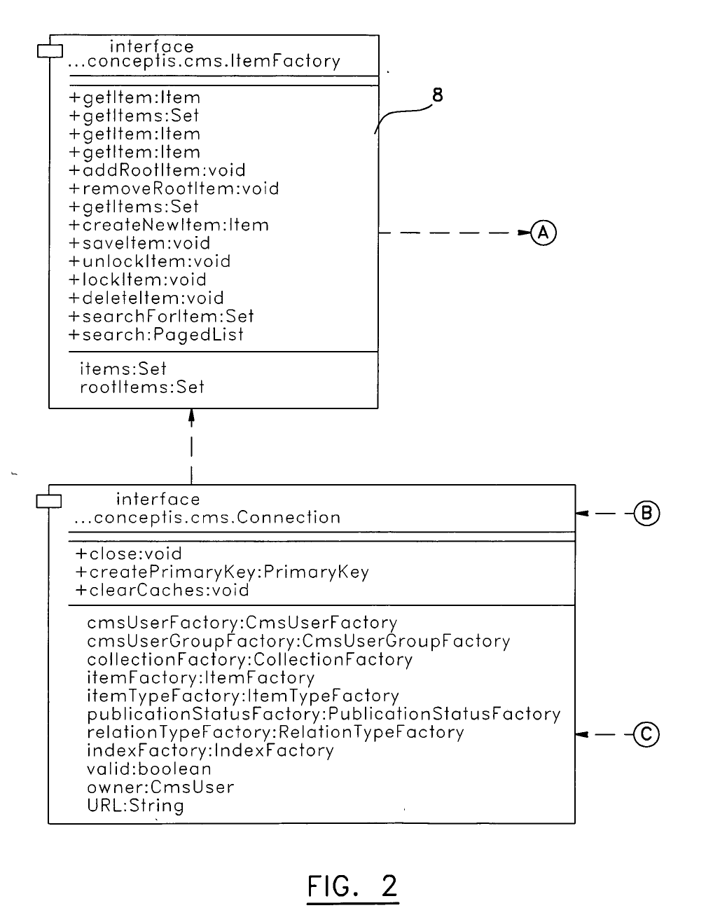

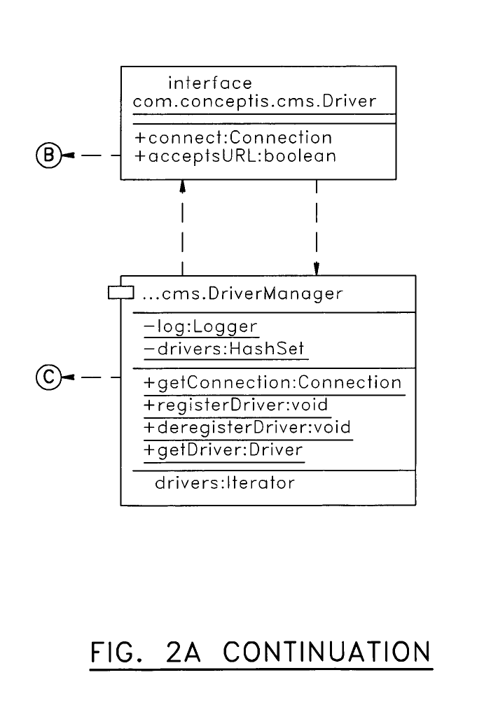

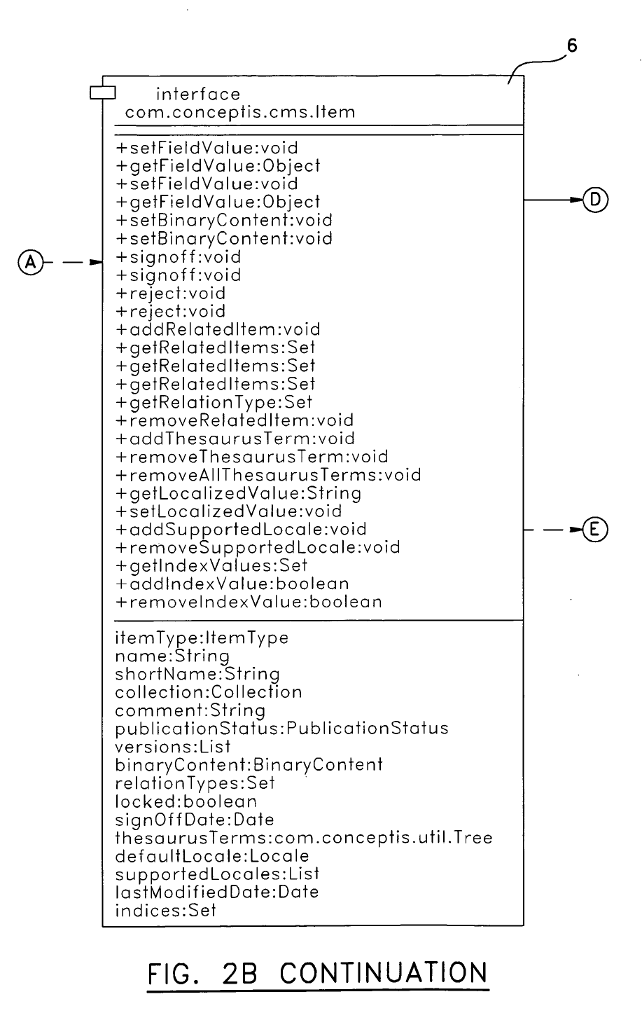

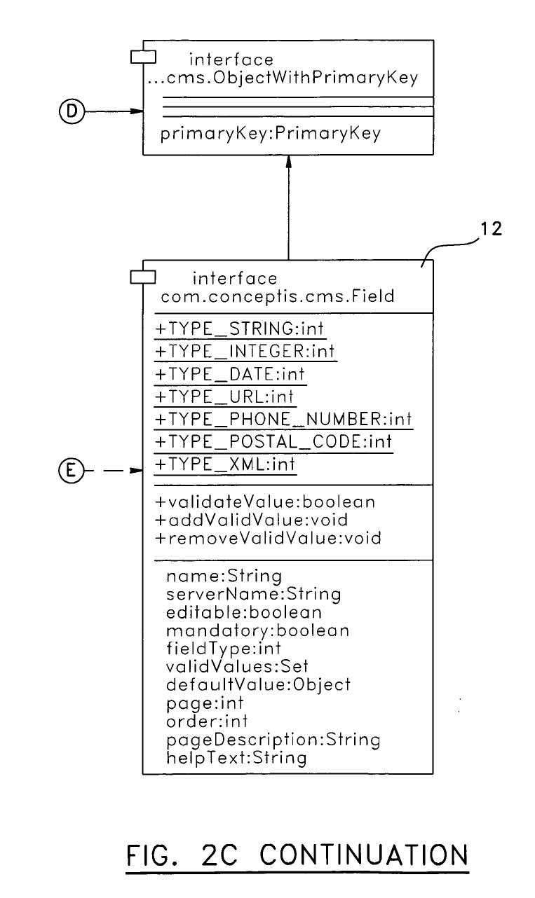

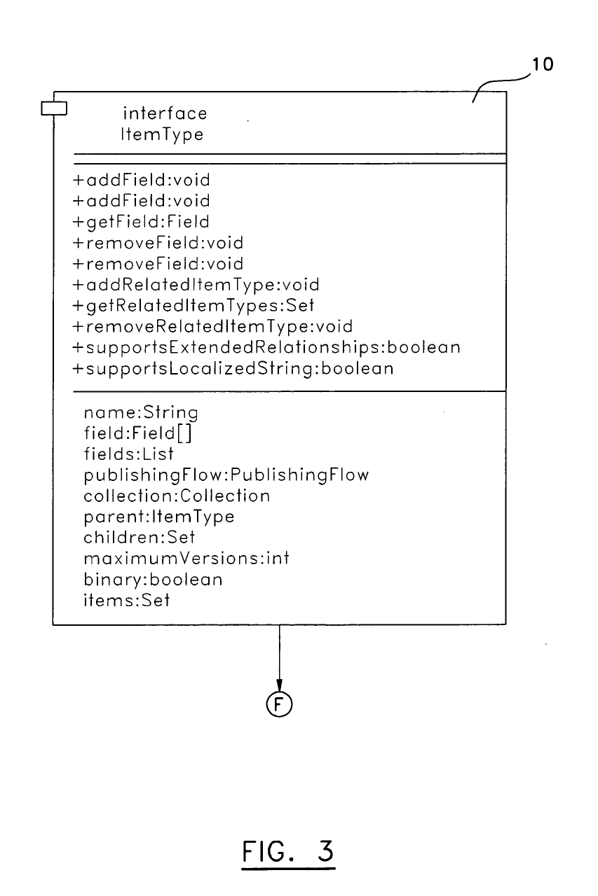

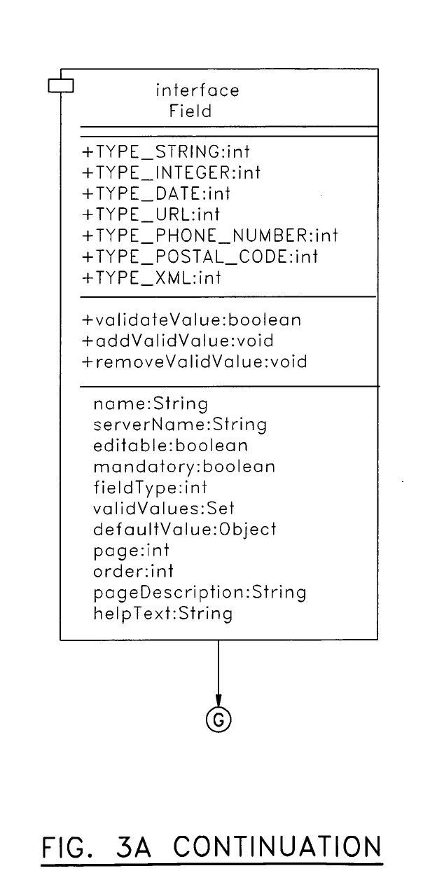

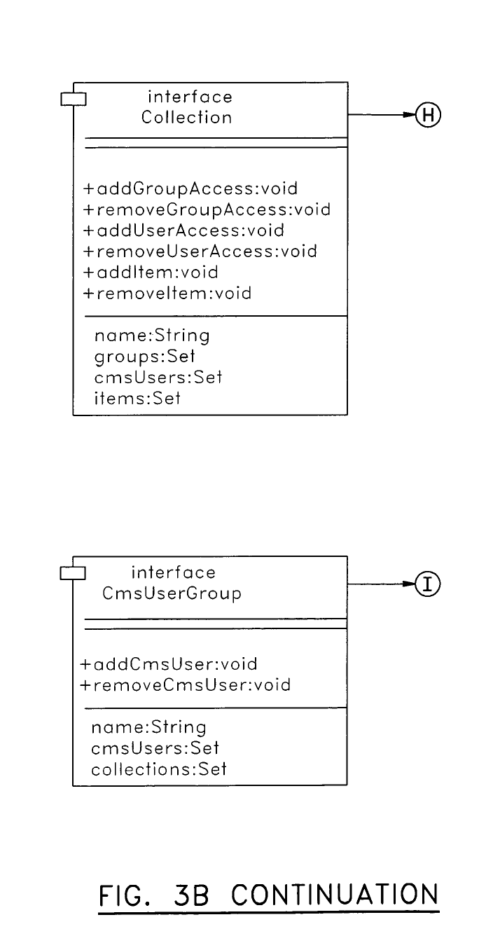

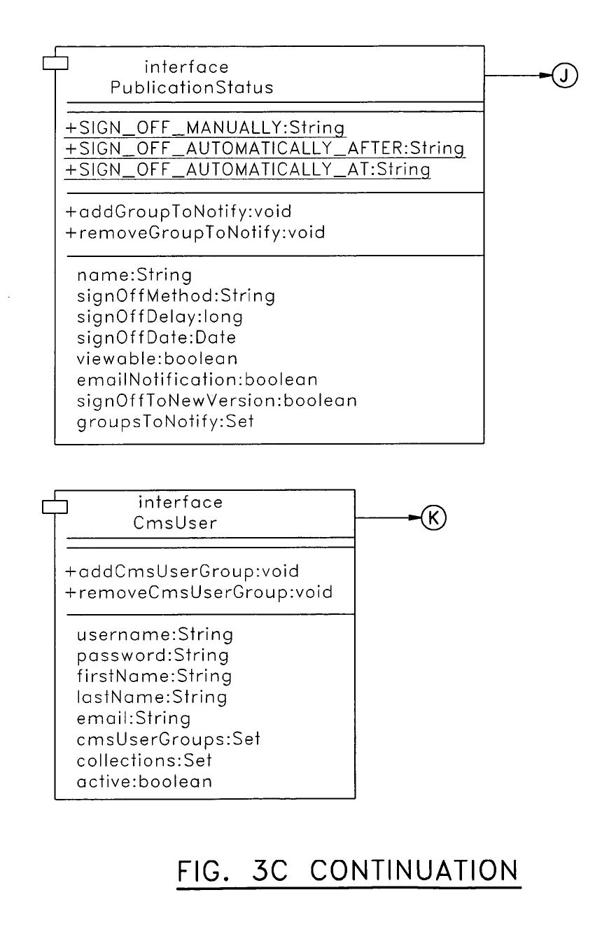

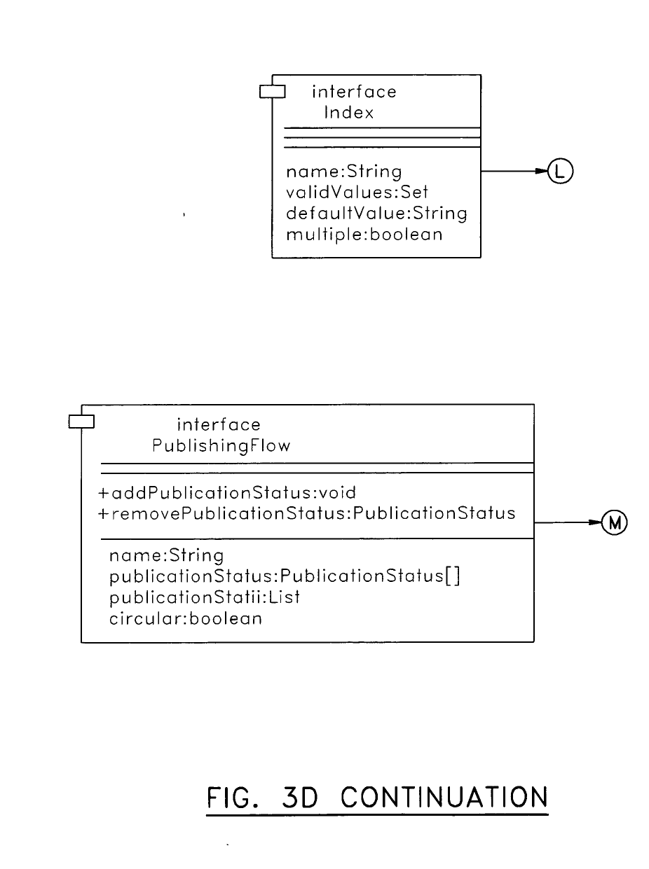

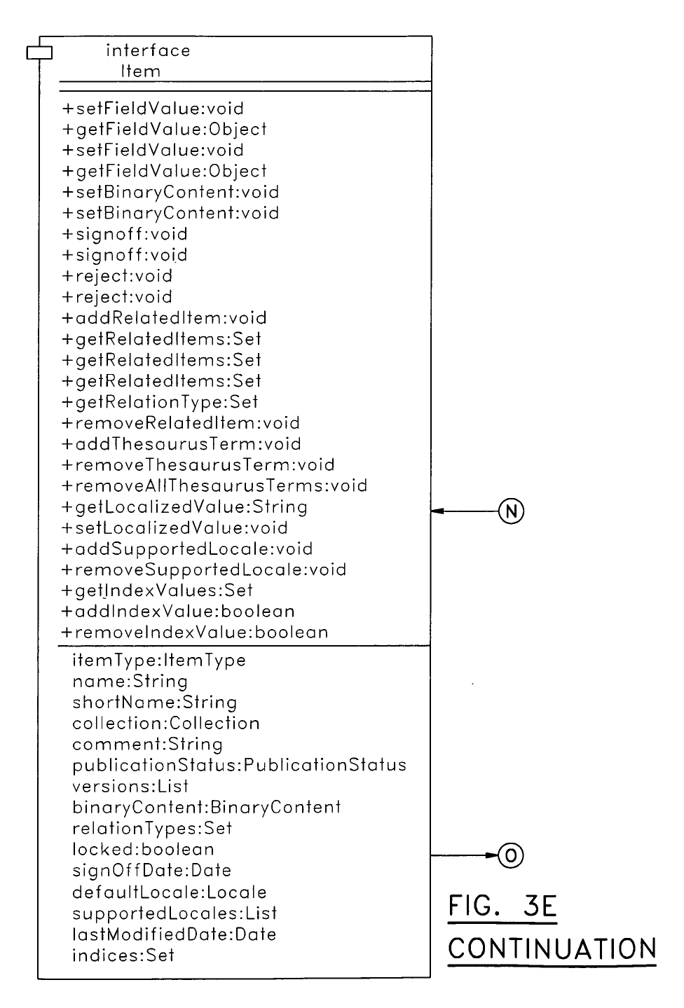

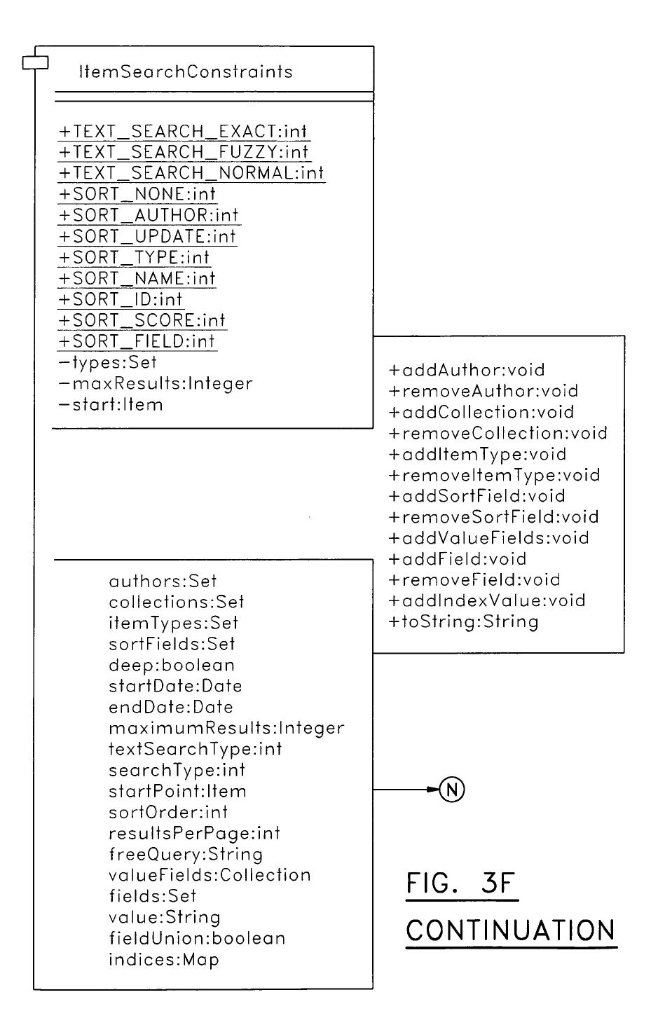

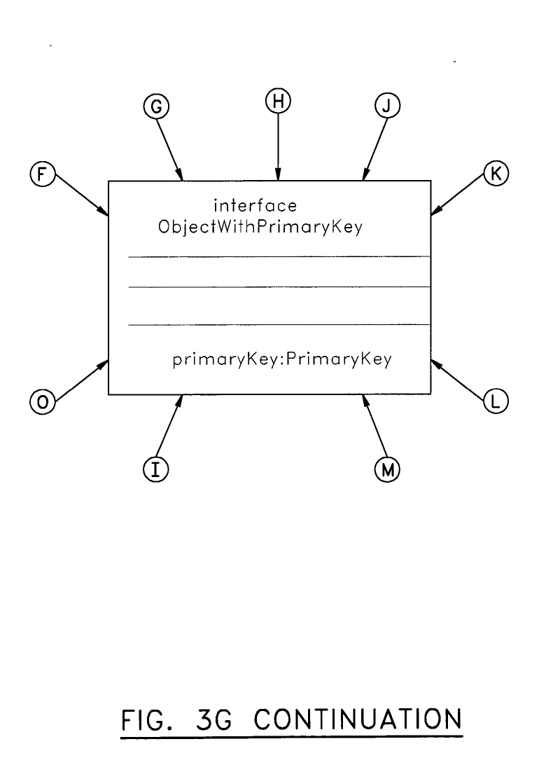

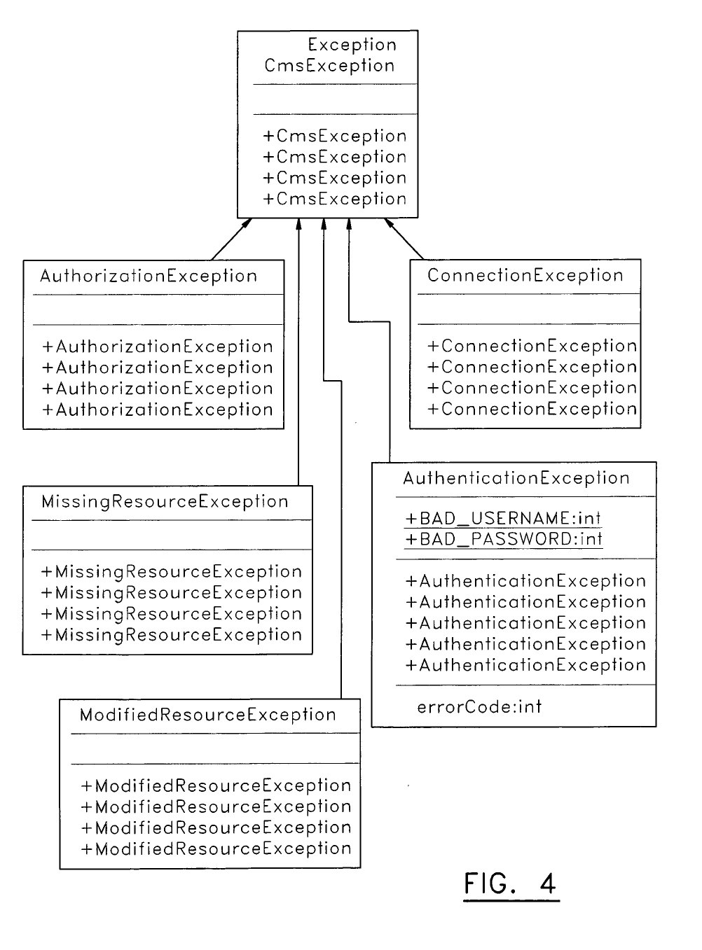

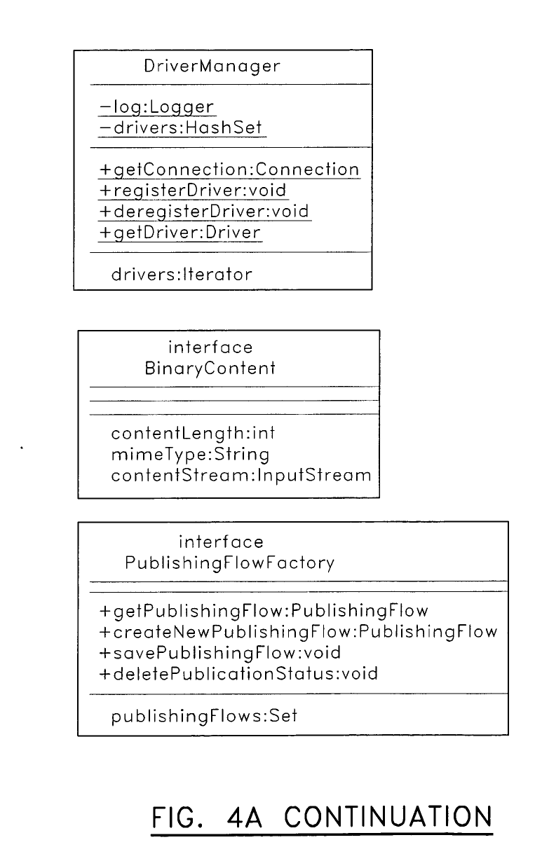

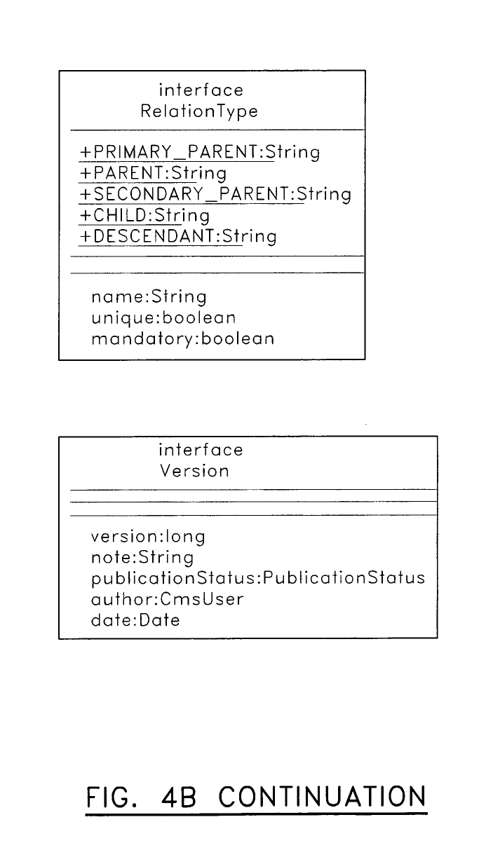

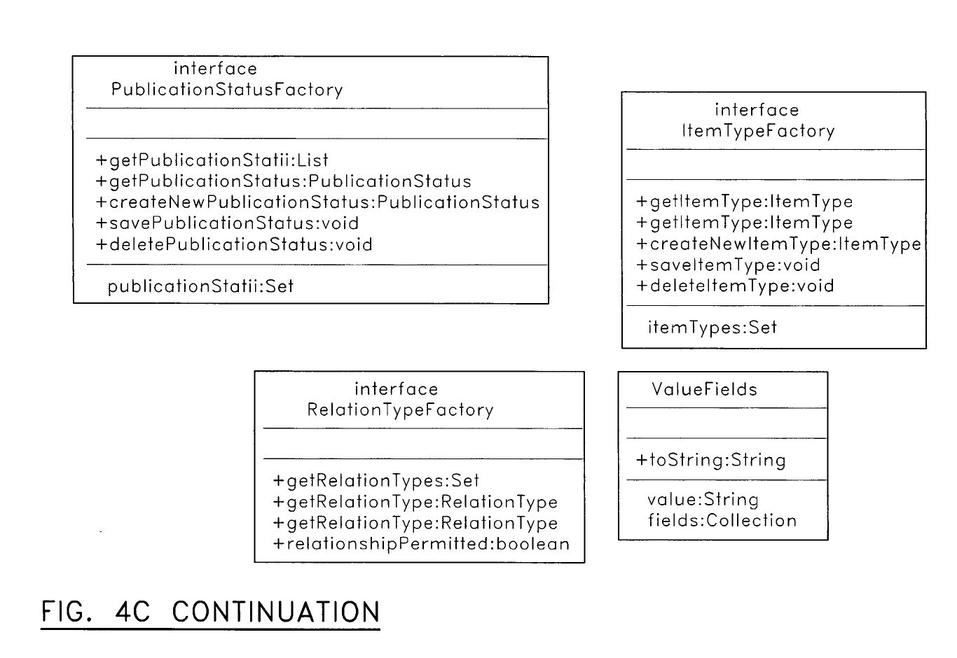

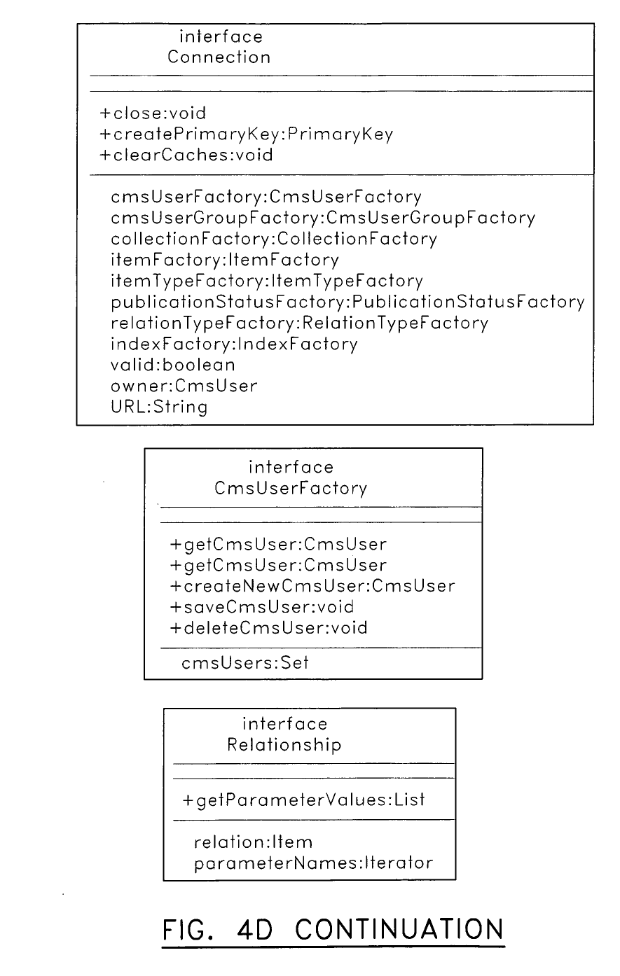

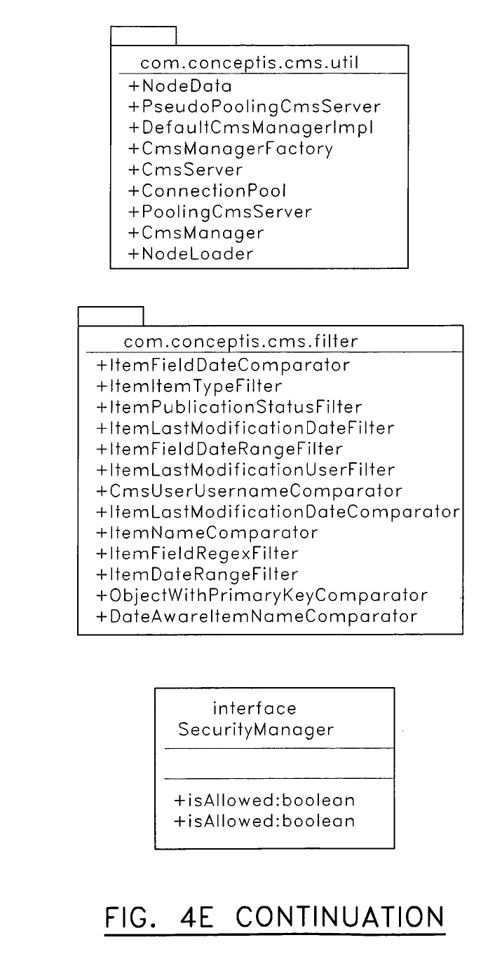

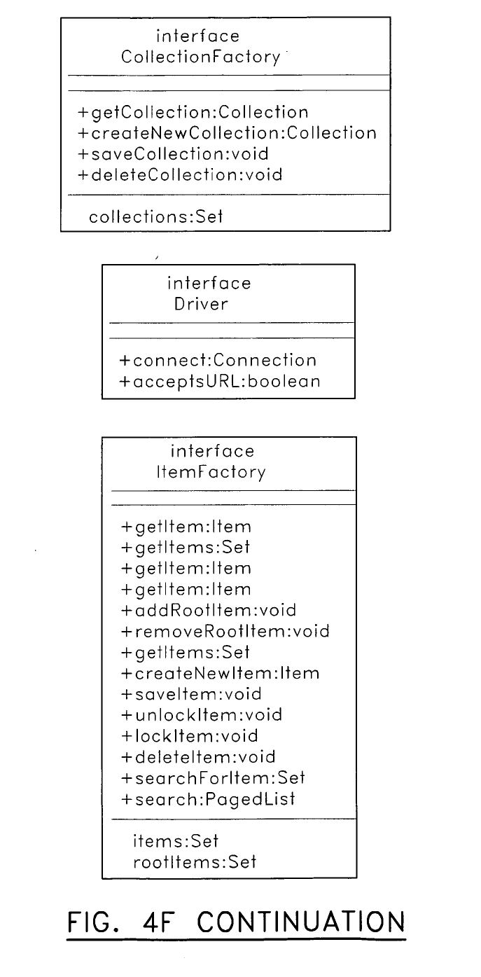

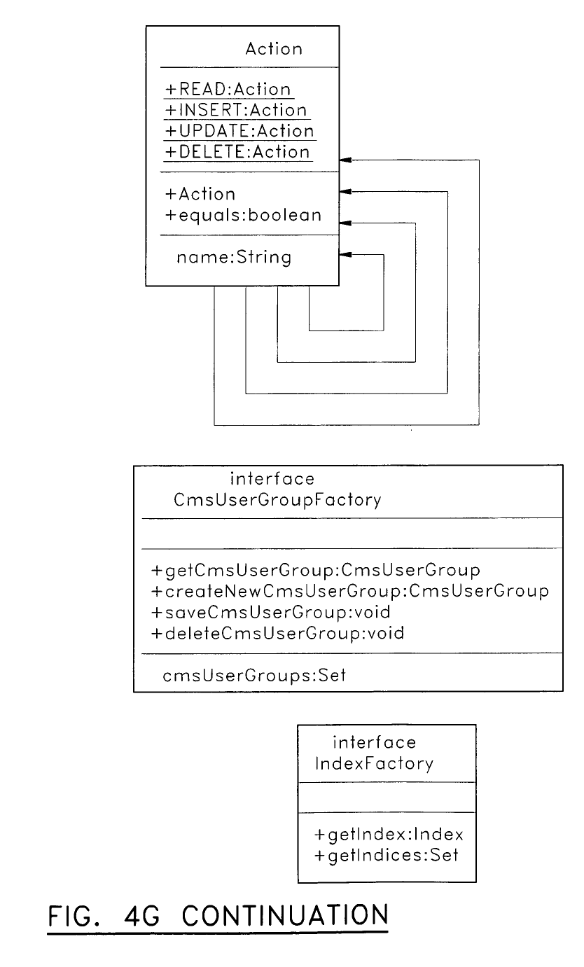

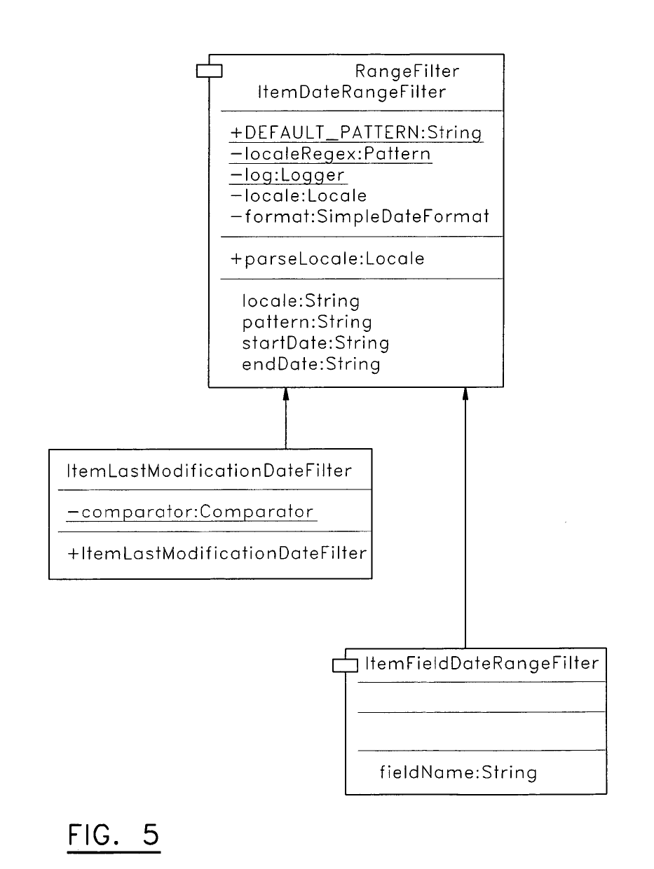

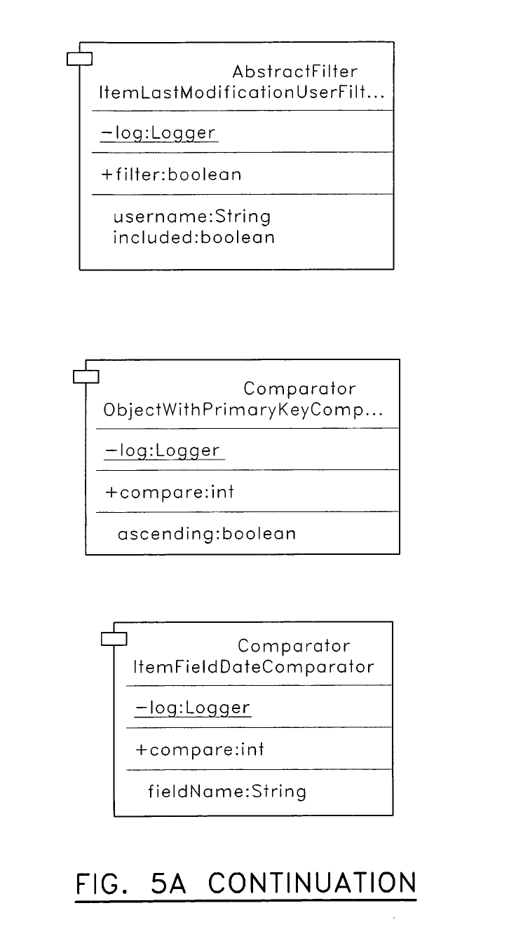

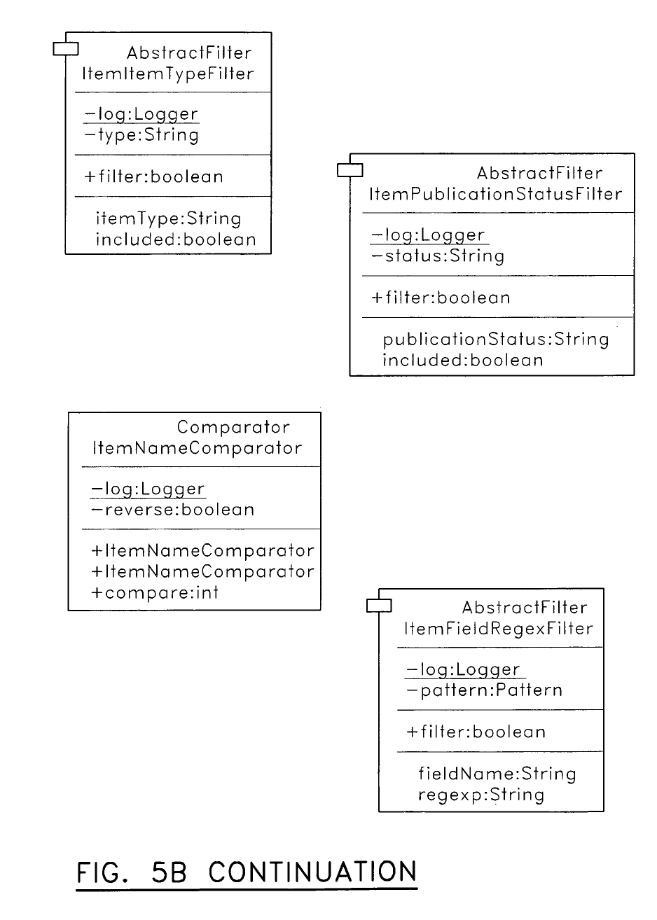

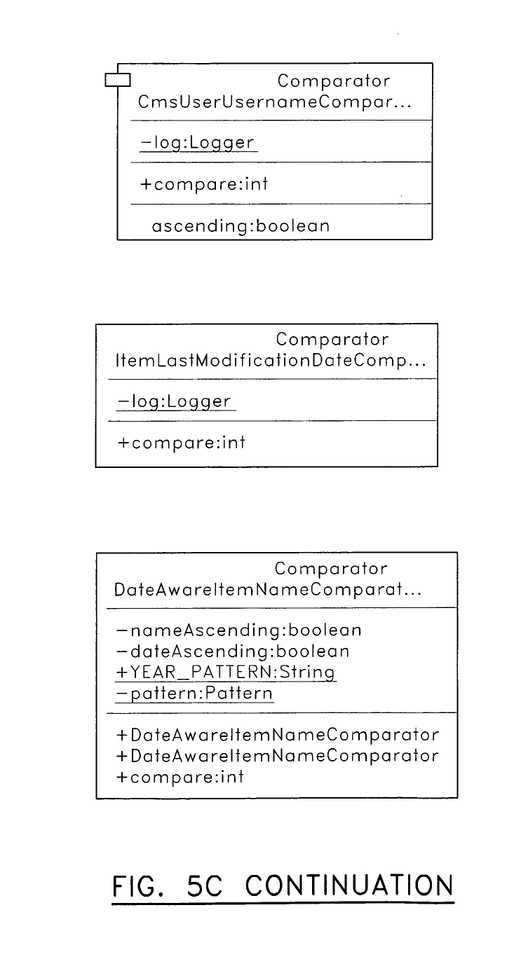

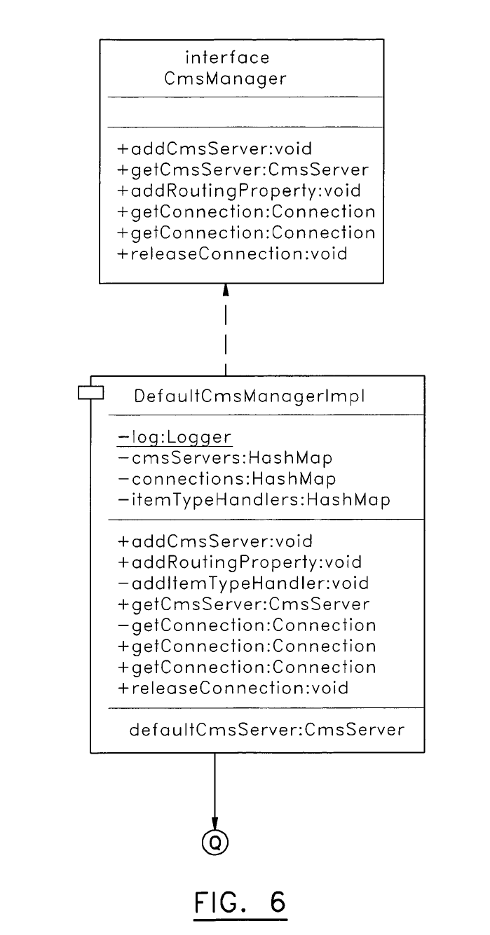

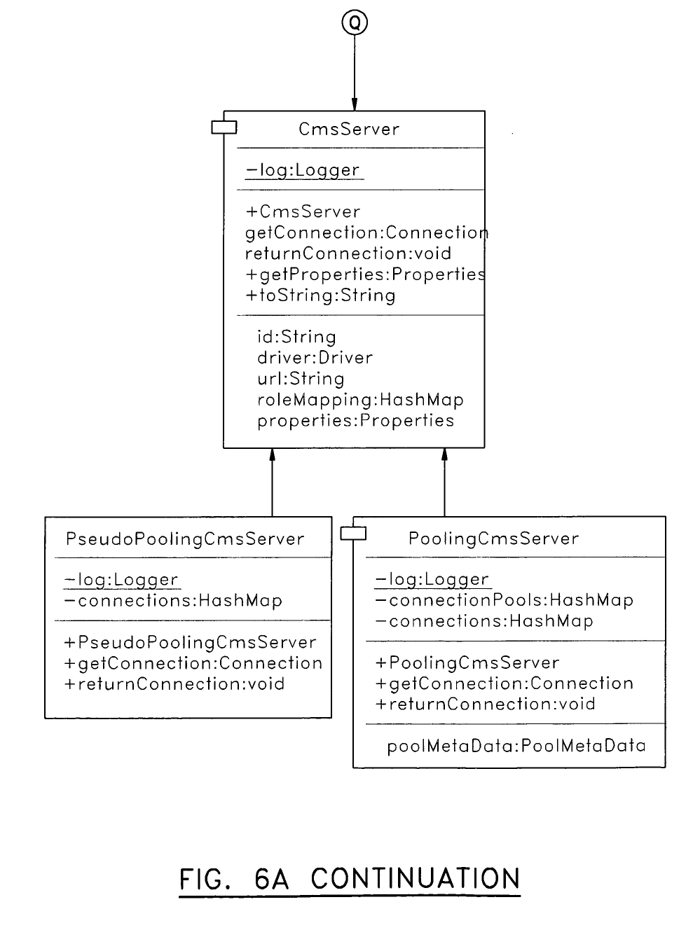

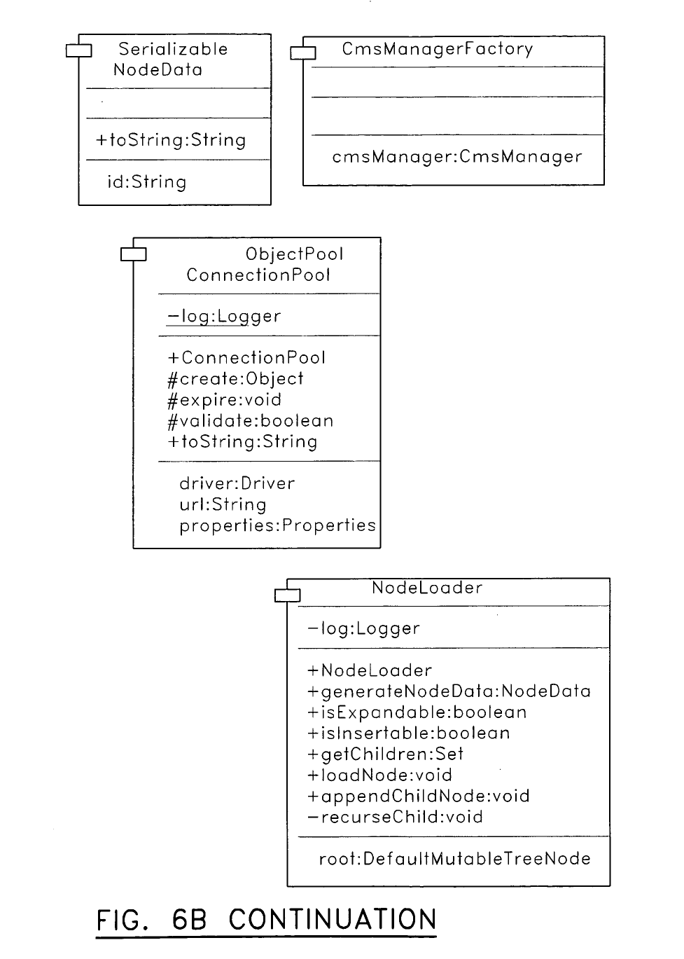

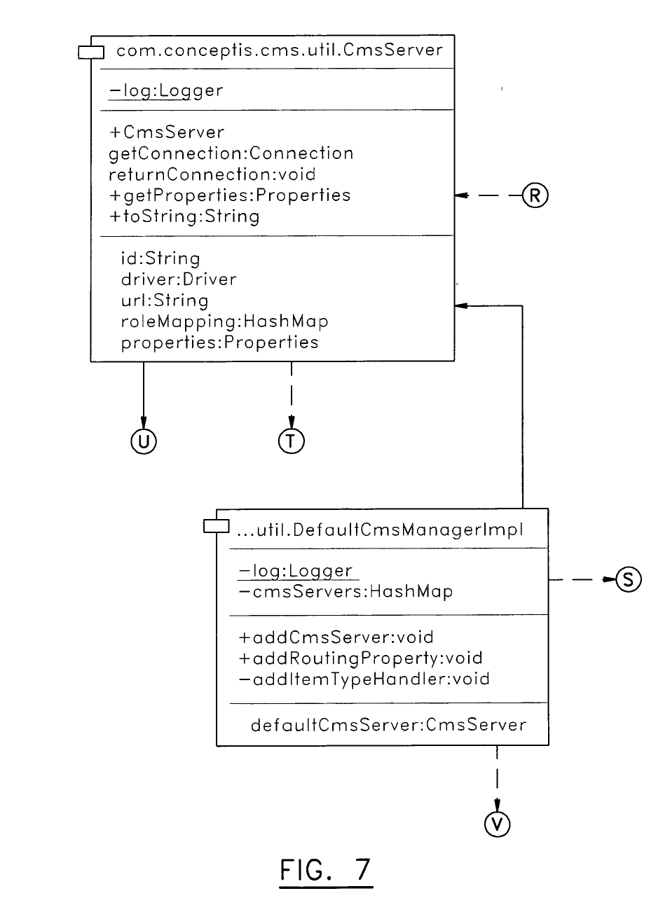

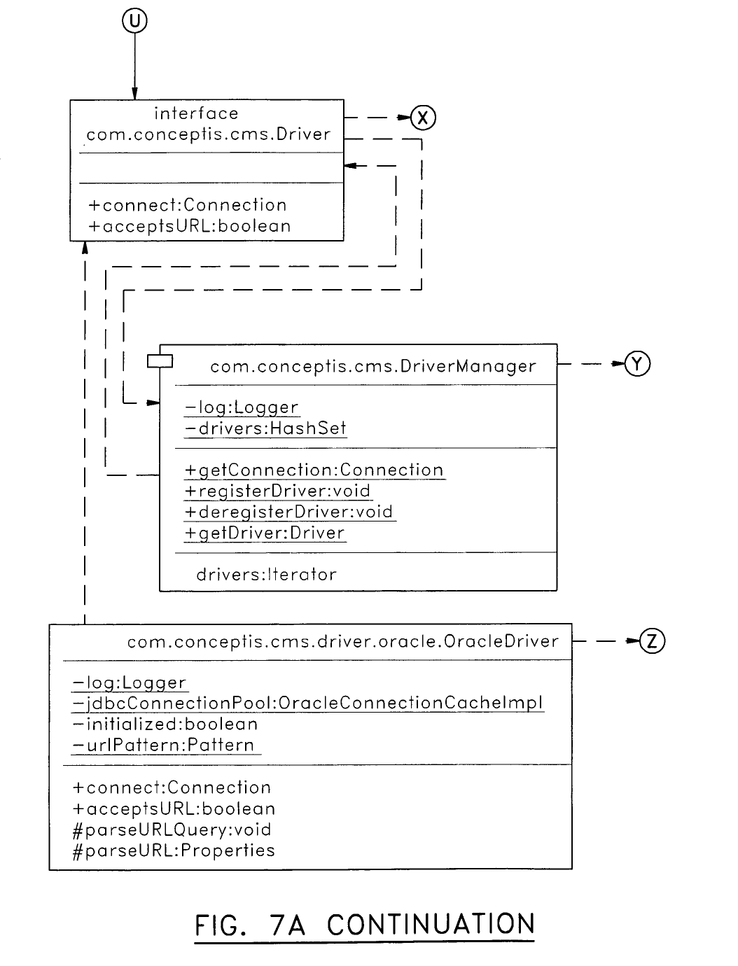

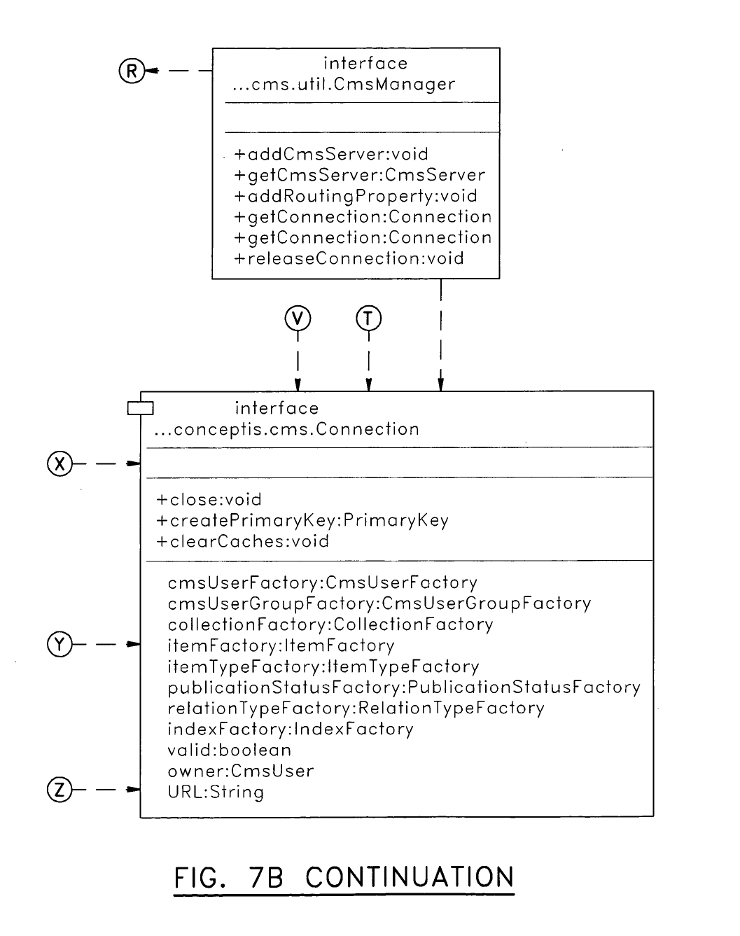

Now turning to FIGS. 2 to 7, a piece of content being managed by the external CMS can be a news article, a JPEG image, or a group of other content items that share a common parent. To this extent a hierarchical and recursive model for content is defined.

In order to abstract the relationship between the business process 1 and content that it may require, an object representation of a piece of content is defined as an Item. Items of content are represented as an instantiation of the Item class 6. The Item class 6 can represent any type of content, such as documents, multimedia files, etc. An ItemFactory class 8 for constructing the Items themselves is also defined. Content Items can be related to each other via a relationship so that one Item can be the parent of one or more Items. The Item is categorized by its type, and can be represented by the ItemType class 10. The business process 1 obtains an instance of an ItemFactory and instructs the ItemFactory to create the instances of the Item it requires. The Item can then provide access to the content data itself, which is stored in Fields class 12, by instructing the Item's ItemType to return a list of the Item's Fields. The business process 1 can manipulate the Items' Field data itself.

In this manner, it is possible for the business process 1 in a middle tier, of a multi-tier software architecture, to be programmed without prior knowledge of the external CMS 5. The business process 1 only needs to reference the content object model by referring to ItemFactory and the Items it creates. The business process 1 only specifies a very generic description of the content It requires in the form of ltemType and Fields. The object model Factory takes care of actually creating the content object itself.

When the business process 1 requires access to a piece of content, which may physically exist in the external CMS, the business process 1 makes a request for a required piece of content to the universal object representation of the CMS. The CMS Driver Interface 4 comprises one or many driver(s) each operatively associated with one corresponding external CMS 5. The driver actually implements the methods to access the content on the external CMS 5 by sending specific parameters, such as an URL and a set of credentials (username, passwords, etc.), and forwards the content request to the external CMS 5. The CMS Driver Interface 4 is responsible for transmitting the content request between the external CMS 5 and the CMS Server 2. The CMS Driver Interface 4 translates a piece of content corresponding to the content request from one external CMS 5 into an Item object representation. The CMS Driver Interface class implements the driver and, as part of its initialization, the driver registers itself with the CMS Manager 3.

Stated differently, the driver defines a set of methods that must be implemented to allow an E-Plafform to communicate with an external CMS. The E-Platform Business Process Core would only need to communicate with the driver to function independently of the content that it needs access to. Thus, the business process that is implemented, primarily in Java, makes requests to the CMS Manager 3 asking for content of a specific type.

The CMS Server 2 manages the content request from the business process 1 to the external CMS 5 using the CMS Driver Interface 4. The CMS Server 2 also relays the Item object representation of the piece of content from the driver to the business process.

The CMS Manager 3 manages the content request from the business process to one of the external CMS 5 and keeps track of content available from one of the external CMS 5 operat%vely assciated with the corresponding driver. To keen track of the content available via a specific driver, the CMS Manager registers the drivers currently running. The CMS Manager can also unregister these drivers. Managing the content sources is implemented through the CMS Manager class that defines methods for adding and connecting to CMS Server's.

The system preferably has a CMS Security Manager for controlling an access to the functionalities of the driver according to specific parameters. The CMS Security Manager controls access to the driver according to the set of credentials.

Business processes 1 access content items individually or as collections by making a request to ItemFactory. The ItemFactory constructs one or more Items according to the request and returns the Items as individual items or as collections of Items. The business process can then interrogate the Items by invoking the Items methods to extract Field information and other Item properties.

The business process gains access to an Items fields by instructing the Item's associated FieldFactory to manufacture the Items fields.

An Item is defined to be unique within an external CMS according to the Items Primary-Key.

Possible packages that can be used for implementing the different CMS class needed are listed hereinabove as examples and for complete comprehension of the preferred embodiment of the system of the present invention:

### 1 CLASS DOCUMENTATION

### 1.1 Package COM.CONCEPTIS.CMS

### 1.1.1 CLASS ACTION

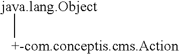

public class Action

extends java.lang.Object

An Action is performed on a SecureResource by a Cmsuser and must be authorized by the SecurityManager to be performed.

An Action is simply identified by its name, and this class already provides a useful set of predefined ActionS.

Field Summary

| | |
|---|---|
| static Action | DELETE |
| | Defines an Action that removes data from the CMS. |
| static Action | INSERT |
| | Defines an Action that creates new data in the CMS. |
| private | name |
| java.lang.String | the name of this Action |
| static Action | READ |
| | Defines an Action that reads data from the CMS. |
| static Action | UPDATE |
| | Defines an Action that modifies existing data in the |
| | CMS. |

Constructor Summary

Action(java.lang.String name)

An Action is performed on a SecureResource by a CmsUser and must be authorized by the SecurityManager to be performed.

Method Summary

| | |
|---|---|
| boolean | equals(java.lang.Object obj) |
| | Returns true if the obj parameter defines an Action |
| | that share the same name as this one; false otherwise. |
| java.lang.String | getName( ) |
| | Returns the name of this Action. |
| private void | setName(java.lang.String name) |
| | Sets the name of this Action. |

Methods inherited from Class java.lang.Object

clone, finalize, getClass, hashCode, notify, notifyAll, toString, wait, wait, wait

Field Detail

1.1.1.1 READ

public static final Action READ

Defines an Action that reads data from the CMS.

1.1.1.2 INSERT

public static final Action INSERT

Defines an Action that creates new data in the CMS.

1.1.1.3 UPDATE

public static final Action UPDATE

Defines an Action that modifies existing data in the CMS.

1.1.1.4 DELETE

public static final Action DELETE

Defines an Action that removes data from the CMS.

1.1.1.5 name

private java.lang.String name

the name of this Action

Constructor Detail

1.1.1.6 Action

public Action(java.lang.String name)

An Action is performed on a SecureResource by a CmsUser and must be authorized by the SecurityManager to be performed.

Parameters:

name—the unique name the identifies this Action

Method Detail

1.1.1.7 getName

public final java.lang.String getName ( )

Returns the name of this Action.

Returns:

the name of this Action

1.1.1.8 setName

private void setName(java.lang.String name)

Sets the name of this Action.

Parameters:

name—the unique name the identifies this Action

1.1.1.9 equals

public boolean equals(java.lang.Object obj)

Returns true if the obj parameter defines an Action that share the same name as this one; false otherwise.

Overrides:

equals in class java.lang.Object

Parameters:

obj—the Object to compra for equality with this Action

Returns:

true if the obj parameter defines an Action that share the same name as this one; false otherwise.

### 1.1.2 CLASS CMSEXCEPTION

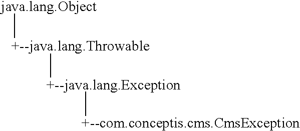

All Implemented Interfaces:

java.io.Serializable

Direct Known Subclasses:

AuthenticationException, AuthorizationException, ConnectionException, MissingResourceException, ModifiedResourceException

public class CmsException

extends java.lang.Exception

Base class for exceptions thrown by the CMS driver.

See Also:

Serialized Form

### Constructor Summary

CmsException ( )

Creates a new instance of CmsException without detail message.

CmsException(java.lang.String msg)

Constructs an instance of CmsException with the specified detail message.

CmsException(java.lang.String msg, java.lang.Throwable cause)

Constructs an instance of cmsexcention with the specified detail message.

CmsException(java.lang.Throwable cause)

Creates a new instance Of CmsException without detail message.

Methods inherited from Class java.lang.Throwable

fillInStackTrace, getcause, getLocalizedMessage, getMessage, getStackTrace, initCause, printStackTrace, printStackTrace, printStackTrace, setStackTrace, toString

Methods inherited from Class java.lang.Object

clone, equals, finalize, getclass, hashCode, notify, notifyAll, wait, wait, wait.

### Constructor Detail

1.1.2.1 CmsException

public CmsException ( )

Creates a new instance of CmsException without detail message.

1.1.2.2 CmsException

public CmsException(java.lang.String msg)

Constructs an instance of CmsException with the specified detail message.

Parameters:

msg—the detail message.

1.1.2.3 CmsException

public CmsException(java.lang.Throwable cause)

Creates a new instance of CmsException without detail message.

Parameters:

cause—the root cause of the exception

1.1.2.4 CmsException

public CmsException(java.lang.String msg, java.lang.Throwable cause)

Constructs an instance of CmsException with the specified detail message.

Parameters:

msg—the detail message.

cause—the root cause of the exception

### 1.1.3 CLASS CONNECTIONEXCEPTION

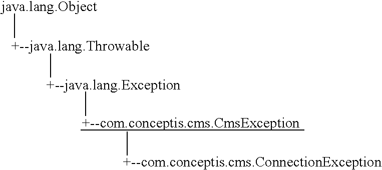

All Implemented Interfaces:

java.io.Serializable

public class ConnectionException

extends CmsException

Indicates that there is a problem connecting the driver to the actual CMS.

See Also:

Serialized Form

### Constructor Summary

ConnectionException( )

Creates a new instance of ConnectionException without detail message.

ConnectionException(java.lang.String msg)

Constructs an instance of ConnectionException with the specified detail message.

ConnectionException(java.lang.String msg, java.lang.Throwable cause)

Constructs an instance of ConnectionException with the specified detail message.

ConnectionException(java.lang.Throwable cause)

Creates a new instance of ConnectionException without detail message.

Methods inherited from Class java.lang.Throwable

fillInStackTrace, getCause, getLocalizedMessage, getMessage, getStackTrace, initCause, printStackTrace, printStackTrace, printStackTrace, setStackTrace, tostring

Methods Iinherited from Class java.lang.Object

clone, equals, finalize, getclass, hashcode, notify, notifyAll, wait, wait, wait

### Constructor Detail

1.1.3.1 ConnectionException

public ConnectionException ( )

Creates a new instance of ConnectionException without detail message.

1.1.3.2 ConnectionException

public ConnectionException(java.lang.String msg)

Constructs an instance of ConnectionException with the specified detail message.

Parameters:

msg—the detail message.

1.1.3.3 ConnectionException

public ConnectionException(java.lang.Throwable cause)

Creates a new instance of ConnectionException without detail message.

Parameters:

cause—the root cause of the exception

1.1.3.4 ConnectionException

public ConnectionException(java.lang.String msg, java.lang.Throwable cause)

Constructs an instance of ConnectionException with the specified detail message.

Parameters:

msg—the detail message.

cause—the root cause of the exception

### 1.1.4 CLASS DRIVERMANAGER

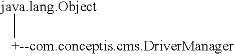

public class DriverManager

extends java.lang.Object

CMS Driver managerment class. This class is capable of registering and unregistering drivers, and providing connections to a CMS via the registered drivers.

DriverS are expected to register themselves with the DriverManager when the class is first loaded by the class loader.

See Also:

Driver

Field Summary

| | |
|---|---|
| private | drivers |
| static java.util.HashSet | The set of registered drivers. |
| private | log |
| static org.apache.log4j.Logger | For logging purposes. |

### Constructor Summary

DriverManager( )

Method Summary

| | |
|---|---|
| static void | deregisterDriver(Driver driver) |
| | Removes a Driver from the collection of |
| | registered drivers. |
| static Connection | getConnection(java.lang.String url) |
| | Attempts to establish a connection to the CMS at |
| | the specified URL. |
| static Driver | getDriver(java.lang.String url) |
| | Provides the driver requested in the URL. |
| static java.util.Iterator | getDrivers( ) |
| | Provides the collection of registered drivers. |
| static void | registerDriver(Driver driver) |
| | Registers a driver with the DriverManager. |

Methods inherited from Class java.lang.Object

clone, equals, finalize, getclass, hashcode, notify, notifyAll, toString, wait, wait, wait

### Field Detail

1.1.4.1 log

private static org.apache.log4j.Logger log

For logging purposes.

1.1.4.2 drivers

private static java.util.HashSet drivers

The set of registered drivers. This is initialized when the class is first loaded. Note that the drivers contain no state information- and mav he shared bv any number of objects.

### Constructor Detail

1.1.4.3 DriverManager

public DriverManager ( )

### Method Detail

1.1.4.4 getConnection

public static Connection getConnection(java.lang.string url) throws CmsException

Attempts to establish a connection to the CMS at the specified URL.

Parameters:

url—the url to attempt to connect to

Returns:

a connection for the database

Throws:

CmsException—if an error occurs

1.1.4.5 registerDriver

public static void registerDriver(Driver driver) throws CmsException

Registers a driver with the DriverManager.

Parameters:

driver—the driver to register

Throws:

CmsException—if an error occurs

1.1.4.6 deregisterDriver

public static void deregisterDriver(Driver driver) throws CmsException

Removes a Driver from the collection of registered drivers.

Parameters:

driver—the driver to unregister

Throws:

CmsException—if an error occurs

1.1.4.7 getDrivers

public static java.util.Iterator getDrivers ( )

Provides the collection of registered drivers.

Returns:

the collection of registered drivers

1.1.4.8 getdriver

public static Driver getDriver(java.lang.String url)

Provides the driver requested in the URL.

Parameters:

url—the url specifying the driver

Returns:

an appropriate driver, null if none could be found

### 1.1.5 CLASS ITEMSEARCHCONSTRAINTS

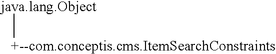

public class ItemSearchConstraints

extends java.lang.Object

Provides constraints on a search for ItemS.

Field Summary

| | |
|---|---|
| private | authors |
| java.util.Set | The set of CmsUserS to limit the results by. |
| private | collections |
| java.util.Set | The set of CollectionS to limit the results by. |
| private boolean | deep |
| | Whether the search should be deep (recursively look |
| | in item children). |
| private | endDate |
| java.util.Date | The end date to constrain the search by. |
| private | fields |
| java.util.Set | The fields to search in. |
| private boolean | fieldUnion |
| | Whether the fields are a union or not. |
| private | freeQuery |
| java.lang.String | The free query search term. |
| private | indices |
| java.util.Map | The indices used to limit the search. |
| private | maxResults |
| java.lang.Integer | The maximum number of results to return. |
| private int | resultsPerPage |
| | The number of results per page, if supported. |
| static int | SORT AUTHOR |
| | Sort by author. |
| static int | SORT FIELD |
| | Sort by field. |
| static int | SORT ID |
| | Sort by Id. |
| static int | SORT NAME |
| | Sort by name. |
| static int | SORT NONE |
| | No sorting. |
| static int | SORT SCORE |
| | Sort by score. |
| static int | SORT TYPE |
| | Sort by item type. |
| static int | SORT UPDATE |
| | Sort by update date. |
| private | sortFields |
| java.util.Set | The fields to sort by. |
| private int | sortOrder |
| | Sort method. |
| private Item | start |
| | The starting point. |
| private | startDate |
| java.util.Date | The start date to constrain the search by. |
| static int | TEXT SEARCH EXACT |
| | Constant for exact text searches. |
| static int | TEXT SEARCH FUZZY |
| | Constant for fuzzy text searches. |
| static int | TEXT SEARCH NORMAL |
| | Constant for normal text searches. |
| private int | textSearchType |
| | The type of text search to perform. |
| private | types |
| java.util.Set | The set of ItemTypeS to limit the results by. |
| private | value |
| java.lang.String | The value to search for. |
| private | valueFields |
| java.util.Collection | The collection of value/fields. |

### Constructor Summary

ItemSearchConstraints ( )

Method Summary

| | |
|---|---|
| void | addAuthor(CmsUser user) |
| | Adds an author id to the search constraints. |
| void | addCollection(java.util.Collection collection) |
| | Adds a collection id to the search constraints. |
| void | addField(Field field) |
| | Deprecated. use value/fields object and free query |
| | value |
| void | addIndexValue(Index index, java.lang.String value) |
| | Adds an index to constrain the search. |
| void | addItemType(ItemType type) |
| | Adds a item type id to the search constraints. |
| void | addSortField(Field field) |
| | Adds a sort field id to the search constraints. |
| void | addValueFields(ValueFields constraint) |
| | Adds a value/fields constraint. |
| java.util.Set | getAuthors( ) |
| | Provides the set of authors used to constrain the |
| | search. |
| java.util.Set | getCollections( ) |
| | Provides the set of collections used to constrain the |
| | search. |
| java.util.Date | getEndDate( ) |
| | Provides the end date of the search constraints. |
| java.util.Set | getFields( ) |
| | Deprecated. use value/fields object and free |
| | query value |
| java.lang.String | getFreeQuery( ) |
| | Provides the free query part. |
| java.util.Map | getIndices( ) |
| | Provides the index values. |
| java.util.Set | getItemTypes( ) |
| | Provides the set of item types used to constrain the |
| | search. |
| java.lang.Integer | getMaximumResults( ) |
| | Provides the maximum number of results this |
| | search is to return. |
| int | getResultsPerPage( ) |
| | Provides the number of results per page. |
| java.util.Set | getSortFields( ) |
| | Provides the set of sort fields used to constrain the |
| | search. |
| int | getSortOrder( ) |
| | Provides the sort order. |
| java.util.Date | getStartDate( ) |
| | Provides the start date of the search constraints. |
| Item | getStartPoint( ) |
| | Provides the starting point. |
| int | getTextSearchType( ) |
| | Provides the text search type. |
| java.lang.String | getValue( ) |
| | Deprecated. use value/fields object and free query |
| | value |
| java.util.Collection | getValueFields( ) |
| | Provides the value/fields constraints. |
| boolean | isDeep( ) |
| | Indicates whether the search is a deep search, |
| | that recursively searches through child links. |
| boolean | isFieldUnion( ) |
| | Deprecated. use value/fields object and free |
| | query value |
| void | removeAuthor(CmsUser user) |
| | Removes an author id from the search constraints. |
| void | removeCollection(java.util.Collection collection) |
| | Removes a collection id from the search constraints. |
| void | removeField(Field field) |
| | Deprecated. use value/fields object and free |
| | query value |
| void | removeItemType(ItemType type) |
| | Removes a item type id from the search constraints. |
| void | removeSortField(Field field) |
| | Removes a sort field id from the search constraints. |
| void | setDeep(boolean deep) |
| | Sets whether the search is a deep search, that |
| | recursively searches through child links. |
| void | setEndDate(java.util.Date date) |
| | Sets the end date of the search constraints. |
| void | setFieldUnion(boolean fieldUnion) |
| | Deprecated. use value/fields object and free |
| | query value |
| void | setFreeQuery(java.lang.String freeQuery) |
| | Sets the free query part. |
| void | setMaximumResults(java.lang.Integer max) |
| | Sets the maximum number of results this search is |
| | to return. |
| void | setResultsPerPage(int resultsPerPage) |
| | Sets the number of results per page. |
| void | setSearchType(int type) |
| | Sets the text search type. |
| void | setSortOrder(int sortOrder) |
| | Sets the sort order. |
| void | setStartDate(java.util.Date date) |
| | Sets the start date of the search constraints. |
| void | setStartPoint(Item start) |
| | Sets the starting point. |
| void | setValue(java.lang.String value) |
| | Deprecated. use value/fields object and free |
| | query value |
| java.lang.String | toString( ) |
| | Provides a string representation of this object. |

Methods inherited from Class java.lang.Object

clone, equals, finalize, getclass, hashCode, notify, notifyAll, wait, wait, wait

### Field Detail

1.1.5.1 TEXT_SEARCH_EXACT

public static final int TEXT_SEARCH_EXACT

Constant for exact text searches.

See Also:

Constant Field Values

1.1.5.2 TEXT_SEARCH_FUZZY

public static final int TEXT_SEARCH_FUZZY

Constant for fuzzy text searches.

See Also:

Constant Field Values

1.1.5.3 TEXT_SEARCH_NORMAL

public static final int TEXT_SEARCH_NORMAL

Constant for normal text searches.

See Also:

Constant Field Values

1.1.6 SORT_NONE

public static final int SORT_NONE

No sorting.

See Also:

Constant Field Values

1.1.6.1 SORT_AUTHOR

public static final int SORT_AUTHOR

Sort by author.

See Also:

Constant Field Values

1.1.6.2 SORT_UPDATE

public static final int SORT_UPDATE

Sort by update date.

See Also:

Constant Field Values

1.1.6.3 SORT_TYPE

public static final int SORT_TYPE

Sort by item type.

See Also:

Constant Field Values

1.1.6.4 SORT_NAME

public static final int SORT_NAME

Sort by name.

See Also:

Constant Field Values

1.1.6.5 SORT_ID

public static final int SORT_ID

Sort by Id.

See Also:

Constant Field Values

1.1.6.6 SORT_SCORE

public static final int SORT_SCORE

Sort by score.

See Also:

Constant Field Values

1.1.6.7 SORT_FIELD

public static final int SORT_FIELD

Sort by field.

See Also:

Constant Field Values

1.1.6.8 authors

private java.util.Set authors

The set of CmsUsers to limit the results by.Null/empty indicates no limiting.

1.1.6.9 collections

private java.util.Set collections

The set of Collections to limit the results by. Null/empty indicates no limiting.

1.1.6.10 types

private java.util.Set types

The set of ItemTypes to limit the results by. Null/empty indicates no limiting.

1.1.6.11 sortFields

private java.util.Set sortFields

The fields to sort by.

1.1.6.12 deep

private boolean deep

Whether the search should be deep (recursively look in item children).

1.1.6.13 startDate

private java.util.Date startDate

The start date to constrain the search by. Null/empty indicates no limiting.

1.1.6.14 endDate

private java.util.Date endDate

The end date to constrain the search by. Null/empty indicates no limiting.

1.1.6.15 maxResults

private java.lang.Integer maxResults

The maximum number of results to return. Null indicates to return all results.

1.1.6.16 textSearchType

private int textsearchType

The type of text search to perform. Defaults to TEXT_SEARCH_NORMAL.

1.1.6.17 sortOrder

private int sortOrder

Sort method.

1.1.6.18 resultsPerPage

private int resultsPerPage

The number of results per page, if supported.

1.1.6.19 start

private Item start

The starting point.

1.1.6.20 valueFields

private java.util.Collection valueFields

The collection of value/fields.

1.1.6.21 freeQuery

private java.lang.String freeQuery

The free query search term.

1.1.6.22 indices

private java.util.Map indices

The indices used to limit the search. Maps index->values

1.1.6.23 value

private java.lang.String value

The value to search for.

1.1.6.24 fields

private java.util.Set fields

The fields to search in. If empty, a full text search will be performed.

1.1.6.25 fieldUnion

private boolean fieldUnion

Whether the fields are a union or not.

### Constructor Detail

1.1.6.26 ItemSearchConstraints

public ItemSearchConstraints ( )

### Method Detail

1.1.6.27 addAuthor

public void addAuthor(CmsUser user)

Adds an author id to the search constraints. If the author is already in the contraints, this method does nothing but does not complain.

Parameters:

user—the author

1.1.6.28 removeAuthor

public void removeAuthor(CmsUser user)

Removes an author id from the search constraints. If the author is not in the contraints, this method does nothing but does not complain.

Parameters:

user—the author

1.1.6.29 getAuthors

public java.util.Set getAuthors ( )

Provides the set of authors used to constrain the search.

Returns:

the set of authors used to constrain the search; may be null

1.1.6.30 addCollection

public void addCollection(java.util.Collection collection)

Adds a collection id to the search constraints. If the collection is already in the constraints, this methods does nothing but does not complain.

Parameters:

collection—the the collection

1.1.6.31 removeCollection

public void removeCollection(java.util.Collection collection)

Removes a collection id from the search constraints. If the collection is not in the contraints, this method does nothing but does not complain.

Parameters:

collection—the collection

1.1.6.32 getCollections

public java.util.Set getCollections ( )

Provides the set of collections used to constrain the search.

Returns:

the set of collection ids used to constrain the search; may be null

1.1.6.33 addItemType

public void addItemType(ItemType type)

Adds a item type id to the search constraints. If the type is already in the constraints, this methods does nothing but does not complain.

Parameters:

type—the item type

1.1.6.34 removeItemType

public void removeItemType(ItemType type)

Removes a item type id from the search constraints. If the type is not in the contraints, this method does nothing but does not complain.

Parameters:

type—the item type

1.1.6.35 getItemTypes

public java.util.Set getItemTypes ( )

Provides the set of item types used to constrain the search.

Returns:

the set of item types used to constrain the search; may be null

1.1.6.36 addSortField

public void addSortField(Field field)

Adds a sort field id to the search constraints. If the field is already in the constraints, this methods does nothing but does not complain.

Parameters:

field—the field

1.1.6.37 removeSortField

public void removeSortField(Field field)

Removes a sort field id from the search constraints. If the field is not in the contraints, this method does nothing but does not complain.

Parameters:

field—the field

1.1.6.38 getSortFields ( )

public java.util.Set getSortFields ( )

Provides the set of sort fields used to constrain the search.

Returns:

the set of field ids used to constrain the search; may be null

1.1.6.39 isDeep

public boolean isDeep ( )

Indicates whether the search is a deep search, that recursively searches through child links.

Returns:

true if the search is deep, false otherwise

1.1.6.40 setDeep

public void setDeep(boolean deep)

Sets whether the search is a deep search, that recursively searches through child links.

Parameters:

deep—true if the search is to be deep, false otherwise

1.1.6.41 getStartDate

public java.util.Date getStartDate ( )

Provides the start date of the search constraints.

Returns:

the starting date that is constraining the search

1.1.6.42 setStartDate

public void setStartDate(java.util.Date date)

Sets the start date of the search constraints.

Parameters:

date—the starting date to constrain the search

1.1.6.43 getEndDate

public java.util.Date getEndDate ( )

Provides the end date of the search constraints.

Returns:

the ending date that is constraining the search

1.1.6.44 setEndDate

public void setEndDate(java.util.Date date)

Sets the end date of the search constraints.

Parameters:

date—the ending date to constrain the search

1.1.6.45 getMaximumResults

public java.lang.Integer getMaximumResults ( )

Provides the maximum number of results this search is to return. Null indicates no limit to the number of results returned.

Returns:

the maximum number of search results (null indicates no limit)

1.1.6.46 setMaximumResults

public void setMaximumResults(java.lang.Integer max)

Sets the maximum number of results this search is to return. Null indicates no limit to the number of results returned.

Parameters:

max—the maximum number of search results (null indicates no limit)

1.1.6.47 getTextSearchType

public int getTextSearchType ( )

Provides the text search type. The default text search type is a “normal” search (neither exact not fuzzy).

Returns:

the type of text searching being done

1.1.6.48 setSearchType

public void setSearchType(int type)

Sets the text search type.

Parameters:

type—the text search type

1.1.6.49 getStartPoint

public Item getStartPoint ( )

Provides the starting point.

Returns:

the starting point

1.1.6.50 setStartPoint

public void setStartPoint(Item start)

Sets the starting point.

Parameters:

start—the starting point

1.1.6.51 getSortOrder

public int getSortOrder ( )

Provides the sort order.

Returns:

sort order

1.1.6.52 setSortOrder

public void setSortOrder(int sortOrder)

Sets the sort order.

Parameters:

sortOrder—the sort order

1.1.6.53 getResultsPerPage

public int getResultsPerPage ( )

Provides the number of results per page.

Returns:

the number of results per page

1.1.6.54 setResultsPerPage

public void setResultoPerPage(int resultsPerPage)

Sets the number of results per page.

Parameters:

resultsPerPage—the number of results per page

1.1.6.55 getFreeQuery

public java.lang.String getFreeQuery ( )

Provides the free query part.

Returns:

the free query part (can be null)

1.1.6.56 setFreeQuery

public void setFreeQuery(java.lang.String freeQuery)

Sets the free query part.

Parameters:

freeQuery—the free query part (can be null)

1.1.6.57 addValueFields

public void addValueFields(ValueFields constraint)

Adds a value/fields constraint.

Parameters:

constraint—the value/fields constraint

1.1.6.58 getValueFields

public java.util.Collection getValueFields ( )

Provides the value/fields constraints.

Returns:

the value/fields constraints (empty, but never null)

1.1.6.59 addField

public void addField(Field field)

Deprecated. use value/fields object andfree query value

Adds a field id to the search constraints. If the field is already in the constraints, this methods does nothing but does not complain.

Parameters:

field—the field

1.1.6.60 removeField

public void removeField(Field field)

Deprecated. use valuefields object andfree query value

Removes a field id from the search constraints. If the field is not in the contraints, this method does nothing but does not complain.

Parameters:

field—the field

1.1.6.61 getFields

public java.util.Set getFields ( )

Deprecated. use value/fields object andfree query value

Provides the set of fields used to constrain the search.

Returns:

the set of field ids used to constrain the search; may be null

1.1.6.62 getValue

public java.lang.String getvalue ( )

Deprecated. use valuefields object andfree query value

Provides the value to search for.

Returns:

the value to search for

1.1.6.63 setValue

public void setvalue(java.lang.String value)

Deprecated. use value/fields object and free query value

Sets the value to search for.

Parameters:

value—the value to search for

1.1.6.64 isFieldUnion

public boolean isFieldUnion ( )

Deprecated. use value/fields object and free query value

Provides the field union.

Returns:

true if any matching fields product a result, false if all fields must match for a result

1.1.6.65 setFieldUnion

public void setFieldUnion(boolean fieldUnion)

Deprecated. use value/fields object and free query value

Sets the field union.

Parameters:

fieldUnion—true if any matching fields product a result, false if all fields must match for a result

1.1.6.66 addIndexValue

public void addIndexValue(Index index, java.lang.String value)

Adds an index to constrain the search.

Parameters:

index—the index

value—the value for the index

1.1.6.67 getIndices

public java.util.Map getIndices ( )

Provides the index values.

Returns:

the index constraints

1.1.6.68 toString

public java.lang.String toString ( )

Provides a string representation of this object.

Overrides:

toString in class java.lang.Object

Returns:

a string representation of this object

### 1.1.7 CLASS MISSINGRESOURCEEXCEPTION

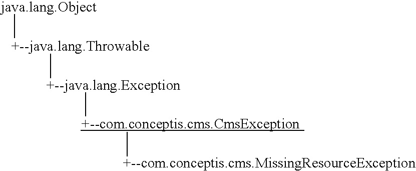

All Implemented Interfaces:

java.io.Serializable

public class MissingResourceException

extends CmsException

Indicates thiat an attempt was made to access a non-existant resource.

See Also:

Serialized Form

### Constructor Summary

MissingResourcException ( )

Creates a new instance Of MissingResourceException without detail message.

MissingResourceException(java. lang. String msg)

Constructs an instance of MissingResourceException with the specified detail message.

MissingResourceException (java.lang.String rnsg, java.lang.Throwable cause)

Constructs an instance of MissingResourceException with the specified detail message.

MissingResourceException (java.lang.Throwable cause)

Creates a new instance Of MissingResourceException without detail message.

Methods inherited -from classia va.lang.Throwable

fillInStackTrace, getcause, getLocalizedMessage, getMessage, getStackTrace, initcause, printStackTrace, printStackTrace, printStackTrace, setStackTrace, tostring

Methods inherited from class java.lang.Object

clone, equals, finalize, getclass, hashCode, notify, notifyAll, wait, wait, wait

### Constructor Detail

1.1.7.1 MissingResourceException

public MissingResourceException ( )

Creates a new instance Of MissingResourceException without detail message.

1.1.7.2 MissingResourceException

public MissingResourceException (java.lang.String msg)

Constructs an instance of MissingResourceException with the specified detail message.

Parameters:

msg—the detail message.

1.1.7.3 MissingResourceException

public MissingResourceException(java.lang.Throwable cause)

Creates a new instance of MissingResourceException without detail message.

Parameters:

cause—the root cause of the exception

1.1.7.4 MissingResourceException

public MissingResourceException(java.lang.String msg, java.lang.Throwable cause)

Constructs an instance of MissingResourceException with the specified detail message.

Parameters:

msg—the detail message.

cause—the root cause of the exception

### 1.1.8 CLASS MISSINGRESOURCEEXCEPTION

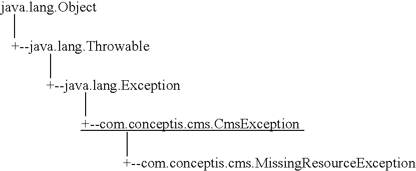

All Implemented Interfaces:

java.io.Serializable

public class MissingResourceException

extends CmsException

Indicates that an attempt was made to access a non-existant resource.

See Also:

Serialized Form

### Constructor Summary

MissingResourceException ( )

Creates a new instance of MissingResourceException without detail message.

MissingResourceException(java.lang.String msg)

Constructs an instance of MissingResourceException with the specified detail message.

MissingResourceException(java.lang.String msg, java.lang.Throwable cause)

Constructs an instance of MissingResourceException with the specified detail message.

MissingResourceException(java.lang.Throwable cause)

Creates a new instance of MissingResourceException without detail message.

Methods inherited from Class java.lang.Throwable

fillInStackTrace, getcause, getLocalizedMessage, getMessage, getstackTrace, initCause, printStackTrace, printStackTrace, printStackTrace, setStackTrace, toString

Methods inherited from Class java.lang.Object

clone, equals, finalize, getclass, hashCode, notify, notifyAll, wait, wait, wait

### Constructor Detail

1.1.8.1 MissingResourceException

public MissingResourceException ( )

Creates a new instance of MissingResourceException without detail message.

1.1.8.2 MissingResourceException

public MissingResourceException(java.lang.String msg)

Constructs an instance of MissingResourceException with the specified detail message.

Parameters:

msg—the detail message.

1.1.8.3 MissingResourceException

public MissingResourceException(java.lang.Throwable cause)

Creates a new instance of MissingResourceException without detail message.

Parameters:

cause—the root cause of the exception

1.1.8.4 MissingResourceException

public MissingResourceException(java.lang.String msg, java.lang.Throwable cause)

Constructs an instance of MissinqResourceException with the specified detail message.

Parameters:

msg—the detail message.

cause—the root cause of the exception

### 1.1.9 CLASS MODIFIEDRESOURCEEXCEPTION

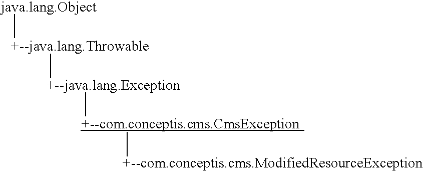

All Implemented Interfaces:

java.io.Serializable

public class ModifiedResourceException

extends CmsException

Indicates that a resource has been modified since it was last accessed.

See Also:

Serialized Form

### Constructor Summary

ModifiedResourceException ( )

Creates a new instance of ModifiedResourceException without detail message.

ModifiedResourceException(java.lang.String msg)

Constructs an instance of ModifiedResourceException with the specified detail message.

ModifiedResourceException(java.lang.String msg, java.lang.Throwable cause)

Constructs an instance of ModifiedResourceException with the specified detail message.

ModifiedResourceException(java.lang.Throwable cause)

Creates a new instance of ModifiedResourceException without detail message.

Methods inherited from Class java.lang.Throwable

fillInstackTrace, getcause, getLocalizedMessage, getMessage, getStackTrace, initcause, printStackTrace, printStackTrace, printStackTrace, setStackTrace, tostring

Methods inherited from Class java.lang.Object

clone, equals, finalize, getclass, hashcode, notify, notifyAll, wait, wait, wait

### Constructor Detail

1.1.9.1 ModifiedResourceException

public ModifiedResourceException ( )

Creates a new instance of ModifiedResourceException without detail message.

1.1.9.2 ModifiedResourceException

public ModifiedResourceException(java.lang.String msg)

Constructs an instance of ModifiedResourceException with the specified detail message.

Parameters:

msg—the detail message.

1.1.9.3 ModifiedResourceException

public ModifiedResourceException(java.lang.Throwable cause)

Creates a new instance of ModifiedResourceException without detail message.

Parameters:

cause—the root cause of the exception

1.1.9.4 ModifiedResourceException

public ModifiedResourceException(java.lang.String msg, java.lang.Throwable cause)

Constructs an instance of ModifiedResourceException with the specified detail message.

Parameters:

msg—the detail message.

cause—the root cause of the exception

### 1.1.10 CLASS VALUEFIELDS

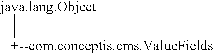

public class ValueFields

extends java.lang.Object

Stores a string value and a collection of fields.

Field Summary

| | |
|---|---|
| private | fields |
| java.util.Collection | The collection of fields. |
| private | value |
| java.lang.String | The value. |

### Constructor Summary

ValueFields ( )

Method Summary

| | |
|---|---|
| java.util.Collection | getFields( ) |
| | Provides the fields. |
| java.lang.String | getValue( ) |
| | Provides the value. |
| void | setFields(java.util.Collection fields) |
| | Sets the fields. |
| void | setValue(java.lang.String value) |
| | Sets the value. |
| java.lang.String | toString( ) |
| | Provides a String representation of the constraint. |

Methods inherited from Class java.lang.Object

clone, equals, finalize, getclass, hashcode, notify, notifyAll, wait, wait, wait _____,,,__,,, .......a. ..-.---.-.-.-. ......................I........

### Field Detail

1.1.10.1 value

private java.lang.String value

The value.

1.1.10.2 fields

private java.util.Collection fields

The collection of fields.

### Constructor Detail

1.1.10.3 ValueFields

public ValueFields ( )

1.1.10.4 getValue

public java.lang.String getValue ( )

Provides the value.

Returns:

the value

1.1.10.5 setValue

public void setValue(java.lang.String value)

Sets the value.

Parameters:

value—the value to search for

1.1.10.6 getFields

public java.util.Collection getFields ( )

Provides the fields.

Returns:

the fields to search through

1.1.10.7 setFields

public void setFields(java.util.Collection fields)

Sets the fields.

Parameters:

fields—the fields to search for

1.1.10.8 toString

public java.lang.String toString ( )

Provides a String representation of the constraint.

Overrides:

tostring in class java.lang.Object

Returns:

a string representation of the constraint

### 1.1.11 INTERFACE BINARYCONTENT

public interface BinaryContent

Data holding class to store information on the binary content associated with an item.

Method Summary

| | |
|---|---|
| int | getContentLength( ) |
| | Get the content length of the input binary stream |
| | obtained. |
| java.io.InputStream | getContentStream( ) |
| | Get the content of the input binary stream obtained. |
| java.lang.String | getMimeType( ) |
| | Get the MIME type of the input binary stream |
| | obtained. |

### Method Detail

1.1.11.1 getContentLength

public int getContentLength ( )

Get the content length of the input binary stream obtained.

Returns:

the length of the binary content

1.1.11.2 getMimeType

public java.lang.String getMimeType ( )

Get the MIME type of the input binary stream obtained.

Returns:

the MIME type of the binary content.

1.1.11.3 getContentStream

public java.io.InputStream getContentStream ( )

Get the content of the input binary stream obtained.

Returns:

an InputStream connected to the binary content.

### 1.1.12 INTERFACE CMSUSER

All Superinterfaces:

ObjectWithPrimaryKey

public interface CmsUser

extends ObjectWithPrimaryKey

A CmsUser is the end-user of the Content Management System, the actual user of the administration interface, or the user of the web site etc.

Method Summary

| | |
|---|---|
| void | addCmsUserGroup(CmsUserGroup userGroup) |
| | Adds the user to the specified CmsUserGroup |
| java.util.Set | getCmsUserGroups( ) |
| | Returns a Set of all the CmsUserGroupS of which this |
| | CmsUser is a member. |
| java.util.Set | getCollections( ) |
| | Returns a Set of all the CollectionS that this user |
| | has access to. |
| java.lang.String | getEmail( ) |
| | Returns the email of this CmsUser. |
| java.lang.String | getFirstName( ) |
| | Returns the first name of this CmsUser. |
| java.lang.String | getLastName( ) |
| | Returns the last name of this CmsUser. |
| java.lang.String | getPassword( ) |
| | Returns the password of this CmsUser. |
| java.lang.String | getUsername( ) |
| | Returns the username of this CmsUser. |
| boolean | isActive( ) |
| | Indicates whether the user is active. |
| void | removeCmsUserGroup(CmsUserGroup userGroup) |
| | Removes the user from the specified CmsUserGroup |
| void | setActive(boolean active) |
| | Sets whether the user is active. |
| void | setEmail(java.lang.String email) |
| | Sets the email of this CmsUser. |
| void | setFirstName(java.lang.String firstName) |
| | Sets the first name of this CmsUser. |
| void | setLastName(java.lang.String lastName) |
| | Sets the last name of this CmsUser. |
| void | setPassword(java.lang.String password) |
| | Sets the password of this CmsUser. |
| void | setUsername(java.lang.String username) |
| | Sets the username of this CmsUser. |

Methods inherited from interface com.conceptis.cms.ObjectWithPrimaryKey

getPrimaryKey

### Method Detail

1.1.12.1 setUsername

public void setUsername(java.lang.String username)

throws AuthorizationException, ConnectionException

Sets the username of this CmsUser.

Parameters:

username—the name of this CmsUser

Throws:

AuthorizationException—if the current user does not have permission to perform this operation

ConnectionException—if there is a problem interacting with the CMS; this will only be thrown if the driver implementation choses to use deferred data loading (for performance reason).

1.1.12.2 getUsername

public java.lang.String getUsername ( )

throws AuthorizationException, ConnectionException

Returns the Username of this CmsUser.

Returns:

the Username of this CmsUser

Throws:

AuthorizationException—if the current user does not have permission to perform this operation

ConnectionException—if there is a problem interacting with the CMS; this will only be thrown if the driver implementation choses to use deferred data loading (for performance reason).

1.1.12.3 setPassword

public void setPassword(java.lang.String password)

throws AuthorizationException, ConnectionException

Sets the password of this CmsUser.

Parameters:

password—the password of this CmsUser.

Throws:

AuthorizationException—if the current user does not have permission to perform this operation

ConnectionException—if there is a problem interacting with the CMS; this will only be thrown if the driver implementation choses to use deferred data loading (for performance reason).

1.1.12.4 getPassword

public java.lang.String getpassword ( )

throws AuthorizationException, ConnectionException

Returns the password of this CmsUser. Note that some implementations may throw an UnsupportedoperationException if it is not possible to retreive a user's password from the data repository

Returns:

the password of this CmsUser; this may be null

Throws:

AuthorizationException—if the current user does not have permission to perform this operation

ConnectionException—if there is a problem interacting with the CMS; this will only be thrown if the driver implementation choses to use deferred data loading (for performance reason).

1.1.12.5 setFirstName

public void setFirstName(java.lang.String firstName)

throws AuthorizationException, ConnectionException

Sets the first name of this CmsUser.

Parameters:

firstName—the first name of this CmsUser

Throws:

AuthorizationException—if the current user does not have permission to perform this operation

ConnectionException—if there is a problem interacting with the CMS; this will only be thrown if the driver implementation choses to use deferred data loading (for performance reason).

1.1.12.6 getFirstName

public java.lang.String getFirstName ( )

throws AuthorizationException, ConnectionException

Returns the first name of this CmsUser.

Returns:

the first name of this CmsUser

Throws:

AuthorizationException—if the current user does not have permission to perform this operation

ConnectionException—if there is a problem interacting with the CMS; this will only be thrown if the driver implementation choses to use deferred data loading (for performance reason).

1.1.12.7 setLastName

public void setLastName(java.lang.String lastName)

throws AuthorizationException, ConnectionException

Sets the last name of this CmsUser.

Parameters:

lastName—the last name of this CmsUser

Throws:

AuthorizationException—if the current user does not have permission to perform this operation

ConnectionException—if there is a problem interacting with the CMS; this will only be thrown if the driver i-plementation choses to use defer ed data loading (frc performance reason).

1.1.12.8 getLastName

public java.lang.String getLastName ( )

throws AuthorizationException, ConnectionException

Returns the last name of this CmsUser.

Returns:

the last name of this CmsUser

Throws:

AuthorizationException—if the current user does not have permission to perform this operation

ConnectionException—if there is a problem interacting with the CMS; this will only be thrown if the driver implementation choses to use deferred data loading (for performance reason).

1.1.12.9 setEmail

public void setEmail(java.lang.String email)

throws AuthorizationException, ConnectionException

Sets the email of this CmsUser.

Parameters:

email—the email of this CmsUser

Throws:

AuthorizationException—if the current user does not have permission to perform this operation

ConnectionException—if there is a problem interacting with the CMS; this will only be thrown if the driver implementation choses to use deferred data loading (for performance reason).

1.1.12.10 getEmail

public java.lang.String getEmail ( )

throws AuthorizationException, ConnectionException

Returns the email of this CmsUser.

Returns:

the email of this CmsUser

Throws:

AuthorizationException—if the current user does not have permission to perform this operation

ConnectionException—if there is a problem interacting with the CMS; this will only be thrown if the driver implementation choses to use deferred data loading (for performance reason).

1.1.12.11 getCmsUserGroups

public java.util.Set getCmsUserGroups ( )

throws AuthorizationException, ConnectionException

Returns a Set of all the CmsUserGroupS of which this CmsUser is a member.

Returns:

a Set of all the CmsUserGroups of which this CmsUser is a member

Throws:

AuthorizationException—if the current user does not have permission to perform this operation

ConnectionException—if there is a problem interacting with the CMS; this will only be thrown if the driver implementation choses to use deferred data loading (for performance reason).

1.1.12.12 addCmsUserGroup

public void addCmsUserGroup(CmsUserGroup userGroup)

throws AuthorizationException, ConnectionException

Adds the user to the specified CmsUserGroup

Parameters:

userGroup—the user group to add

Throws:

AuthorizationException—if the current user does not have permission to perform this operation

ConnectionException—if there is a problem interacting with the CMS; this will only be thrown if the driver implementation choses to use deferred data loading (for performance reason).

1.1.12.13 removeCmsUserGroup

public void removeCmsUserGroup(CmsUserGroup userGroup)

throws AuthorizationException, ConnectionException

Removes the user from the specified CmsUserGroup

Parameters:

userGroup—the user group to remove

Throws:

AuthorizationException—if the current user does not have permission to perform this operation

ConnectionException—if there is a problem interacting with the CMS; this will only be thrown if the driver implementation choses to use deferred data loading (for performance reason).

1.1.12.14 getCollections

public java.util.Set getCollections ( )

throws AuthorizationException, ConnectionException

Returns a Set of all the Collections that this user has access to.

Returns:

the set of collections that the user has access to

Throws:

AuthorizationException—if the current user does not have permission to perform this operation

ConnectionException—if there is a problem interacting with the CMS; this will only be thrown if the driver implementation choses to use deferred data loading (for performance reason).

1.1.12.15 isActive

public boolean isActive ( )

throws AuthorizationException, ConnectionException

Indicates whether the user is active. Inactive user's are restricted in the actions they may perform.

Returns:

true if the user is active, false otherwise

Throws:

AuthorizationException—if the current user does not have permission to perform this operation

ConnectionException—if there is a problem interacting with the CMS; this will only be thrown if the driver implementation choses to use deferred data loading (for performance reason).

1.1.12.16 setActive

public void setActive(boolean active)

throws AuthorizationException, ConnectionException

Sets whether the user is active. Inactive user's are restricted in the actions they can perform.

Parameters:

active—true if the user is active, false otherwise

Throws:

AuthorizationException—if the current user does not have permission to perform this operation

ConnectionException—if there is a problem interacting with the CMS; this will only be thrown if the driver implementation choses to use deferred data loading (for performance reason).

### 1.1.13 INTERFACE CMSUSERFACTORY

public interface CmsUserFactory

Interacts with the CMS to provide access to users of the CMS.

Method Summary

| | |
|---|---|
| CmsUser | createNewCmsUser( ) |
| | Creates a new CmsUser instance, uninitialized, |
| | not stored in the CMS. |
| void | deleteCmsUser(CmsUser cmsUser) |
| | Deletes this CmsUser. |
| CmsUser | getCmsUser(com.conceptis.util.PrimaryKey key) |
| | Provides the CmsUser with the specified key |
| CmsUser | getCmsUser(java.lang.String username) |
| | Provides the CmsUser with the specified username. |
| java.util.Set | getCmsUsers( ) |
| | Provides the set of all CmsUserS in the CMS. |
| void | saveCmsUser(CmsUser cmsUser) |
| | Saves the specified CmsUser. |

### Method Detail

1.1.13.1 getCmsUsers

public java.util.Set getCmsUsers ( )

throws ConnectionException, AuthorizationException

Provides the set of all CmsUsers in the CMS.

Returns:

the set of all CmsUsers (may be empty but never null)

Throws:

ConnectionException—if there is a problem interacting with the CMS

AuthorizationException—if the current user does not have permission to perform this operation

1.1.13.2 getCmsUser

public CmsUser getCmsUser(com.conceptis.util.PrimaryKey key)

throws ConnectionException, AuthorizationException, MissingResourceException

Provides the CmsUser with the specified key

Parameters:

key—the primary key of the CmsUser

Returns:

the CmsUser with the specified key

Throws:

ConnectionException—if there is a problem interacting with the CMS

AuthorizationException—if the current user does not have permission to perform this operation

MissingResourceException—if the CmsUser specified by the key does not exist

1.1.13.3 getCmsUser

public CmsUser getCmsUser(java.lang.String Username)

throws ConnectonException, AuthorizationException, MissingResourceException

Provides the CmsUser with the specified Username.

Parameters:

Username—the Username being searched for

Returns:

the CmsUser with the specified Username

Throws:

ConnectionException—if there is a problem interacting with the CMS

AuthorizationException—if the current user does not have permission to perform this operation

MissingResourceException—if the CmsUser specified by the key does not exist

1.1.13.4 createNewCmsUser

public CmsUser createNewCmsUser ( )

Creates a new CmsUser instance, uninitialized, not stored in the CMS. Once correctly initialized, this instance may then be inserted in the CMS using the saveCmsUser (com. conceptis. cms. CmsUser) method.

Returns:

the newly created CmsUser

1.1.13.5 saveCmsUser

public void saveCmsUser(CmsUser cmsUser)

throws ConnectionException, AuthorizationException, MissingResourceException

Saves the specified CmsUser. This will change the CmsUser's entry in the CMS to reflect the state of the cmsUser parameter.

Parameters:

CmsUser—the <CODECMSUSER<code>to insert/update

Throws:

ConnectionException—if there is a problem interacting with the CMS

AuthorizationException—if the current user does not have permission to perform this operation

MissingResourceException—if a previously existing CmsUser does not exist any longer

1.1.13.6 deleteCmsUser

public void deleteCmsUser(CmsUser CmsUser)

throws ConnectionException, AuthorizationException, MissingResourceException

Deletes this CmsUser. This may have unintended consequences. Note that some implementations may throw an UnsupportedoperationException if the deletion of CmsUserS is not possible.

Parameters:

CmsUser—the CmsUser to delete

Throws:

ConnectionException—if there is a problem interacting with the CMS

AuthorizationException—if the current user does not have permission to perform this operation

MissingResourceException—if the CmsUser does not exist any longer

### 1.1.14 INTERFACE CMSUSERGROUP

All Superinterfaces:

ObjectWithPrimaryKey

public interface CmsUserGroup

extends ObjectWithPrimaryKey

A CmsUserGroup is used to grant security-related permissions to a group of CmsUsers.

Method Summary

| | |
|---|---|
| void | addCmsUser(CmsUser cmsUser) |
| | Registers the given CmsUser as a member of this |
| | CmsUserGroup. |
| java.util.Set | getCmsUsers( ) |
| | Returns a Set of all the CmsUserS that are registered |
| | as member of this CmsUserGroup. |
| java.util.Set | getCollections( ) |
| | Provides the set of collections that this group |
| | has access to. |
| java.lang.String | getName( ) |
| | Returns the name of this CmsUserGroup. |
| void | removeCmsUser(CmsUser cmsUser) |
| | Unregisters the given CmsUser as a member of this |
| | CmsUserGroup. |
| void | setName(java.lang.String name) |
| | Sets the name of this CmsUserGroup. |

Methods inherited from interface com.conceptis.cms.ObjectWithPrimaryKey

getPrimaryKey

### Method Detail

1.1.14.1 setName

public void setName(java.lang.String name)

throws AuthorizationException, ConnectionException

Sets the name of this CmsUserGroup.

Parameters:

name—the name of this CmsUserGroiLp

Throws:

AuthorizationException—if the current user does not have permission to perform this operation

ConnectionException—if there is a problem interacting with the CMS; this will only be thrown if the driver implementation choses to use deferred data loading (for performance reason).

1.1.14.2 getName

public java.lang.String getName ( )

throws AuthorizationException, ConnectionException

Returns the name of this CmsUserGroup.

Returns:

the name of this CmsUserGroup

Throws:

AuthorizationException—if the current user does not have permission to perform this operation

ConnectionException—if there is a problem interacting with the CMS; this will only be thrown if the driver implementation choses to use deferred data loading (for performance reason).

1.1.14.3 addCmsUser

public void addCmsUser(CmsUser cmsUser)

throws AuthorizationException, ConnectionException

Registers the given CmsUser as a member of this CmsUserGroup.

Parameters:

CmsUser—the CmsUser to register as a member of this CmsUserGroup

Throws:

AuthorizationException—if the current user does not have permission to perform this operation

ConnectionException—if there is a problem interacting with the CMS; this will only be thrown if the driver implementation choses to use deferred data loading (for performance reason).

1.1.14.4 removeCmsUser

public void removeCmsUser(CmsUser CmsUser)

throws AuthorizationException, ConnectionException

Unregisters the given CmsUser as a member of this CmsUserGroup.

Parameters:

CmsUser—the CmsUser to unregister as a member of this CmsUserGroup

Throws:

AuthorizationException—if the current user does not have permission to perform this operation

ConnectionException—if there is a problem interacting with the CMS; this will only be thrown if the driver impnenle tntion choses to use deferred data loading (for performance reason).

1.1.14.5 getCmsUsers

public java.util.Set getCmsUsers ( )

throws AuthorizationException, ConnectionException

Returns a Set of all the CmsUsers that are registered as member of this CmsUserGroup.

Returns:

a Set of all the CmsUsers that are registered as member of this CmsUserGroup

Throws:

AuthorizationException—if the current user does not have permission to perform this operation

ConnectionException—if there is a problem interacting with the CMS; this will only be thrown if the driver implementation choses to use deferred data loading (for performance reason).

1.1.14.6 getCollections

public java.util.Set getCollections ( )

throws AuthorizationException, ConnectionException

Provides the set of collections that this group has access to.

Returns:

the set of collections that this group has access to

Throws:

AuthorizationException—if the current user does not have permission to perform this operation

ConnectionException—if there is a problem interacting with the CMS; this will only be thrown if the driver implementation choses to use deferred data loading (for performance reason).

1.1.15 INTERFACE CMSUSERGROUPFACTORY

public interface CmsUserGroupFactory

A CmsUserGroupFactory interacts directly with the CMS server to perform any action that creates, modifies, deletes or simply loads the data of the CmsUserGroupS.

Method Summary

| | |
|---|---|
| CmsUserGroup | createNewCmsUserGroup( ) |
| | Creates a new CmsUserGroup instance, uninitialized, |
| | not stored in the CMS. |
| void | deleteCmsUserGroup(CmsUserGroup cmsUserGroup) |
| | Deletes this CmsuserGroup. |
| CmsUserGroup | getCmsUserGroup(com.conceptis.util.PrimaryKey key) |
| | Provides the CmsUserGroup with the specified key. |
| java.util.Set | getCmsUserGroups( ) |
| | Returns a Set containing all the CmsUserGroupS |
| | defined in our CMS. |
| void | saveCmsUserGroup(CmsUserGroup cmsUserGroup) |
| | Saves the specified CmsUserGroup. |

### Method Detail

1.1.15.1 getCmsUserGroups

public java.util.Set getCmsUserGroups ( )

throws ConnectionException, AuthorizationException

Returns a Set containing all the CmsUserGroups defined in our CMS.

Returns:

a Set of all CmsUserGroupS (may be empty but never null)

Throws:

ConnectionException—if there is a problem interacting with the CMS

AuthorizationException—if the current user does not have permission to perform this operation

1.1.15.2 getCmsUserGroup

public CmsUserGroup getCmsUserGroup(com.conceptis.util.PrimaryKey key)

throws ConnectionException, AuthorizationException, MissingResourceException

Provides the CmsUserGroup with the specified key.

Parameters:

key—the primary key of the CmsUserGroup

Returns:

the CmsUserGroup with the specified key

Throws:

ConnectionException—if there is a problem interacting with the CMS

AuthorizationException—if the current user does not have permission to perform this operation

MissingResourceException—if the CmsUserGroup specified by the key does not exist

1.1.15.3 createNewCmsUserGroup

public CmsUserGroup createN wCmsUserGroup ( )

Creates a new CmsUserGroup instance, uninitialized, not stored in the CMS. Once correctly initialized, this instance may then be inserted in the CMS using the saveCmsUserGroup (com. conceptis. cms. CmsUserGroup) method.

Returns:

the newly created CmsUserGroup

1.1.15.4 saveCmsUserGroup

public void saveCmsUserGroup(CmsUserGroup cmsUserGroup)

throws ConnectionException, AuthorizationException, MissingResourceException

Saves the specified CmsUserGroup. This will change the CmsUserGroup's entry in the

CMS to reflect the state of the CmsUserGroup parameter.

Parameters:

cmsUserGroup—the CmsUserGroup to insert/update

Throws:

ConnectionException—if there is a problem interacting with the CMS

AuthorizationException—if the current user does not have permission to perform this operation

MissingResourceException—if a previously existing CmsUserGroup does not exist any longer

1.1.15.5 deleteCmsUserGroup

public void deleteCmsUserGroup(CmsUserGroup cmsUserGroup)

throws ConnectionException, AuthorizationException, MissingResourceException

Deletes this CmsUserGroup. This may have unintended consequences. Note that some implementations may throw an UnsupportedoperationException if the deletion of CmsUserGroups is not possible.

Parameters:

cmsUserGroup—the CMsUserGroup to delete

Throws:

ConnectionException—if there is a problem interacting with the CMS

AuthorizationException—if the user does not have permission to perform this operation

MissingResourceException—if the CmsUserGroup does not exist any longer

### 1.1.16 INTERFACE COLLECTION

All Superinterfaces:

extends ObjectWithPrimaryKey

public interface Collection

extends ObjectWithPrimaryKey

A Collection is used to regroup several ItemS together, and can be used to globally assign security properties.

Method Summary

| | |
|---|---|
| void | addGroupAccess(CmsUserGroup group) |
| | Adds a group that has access to this collection. |
| void | addItem(Item item) |
| | Adds an item to this collection. |
| void | addUserAccess(CmsUser userToAdd) |
| | Adds a user that has access to this collection. |
| java.util.Set | getCmsUsers( ) |
| | Provides the set of CmsUserS that have access |
| | to this collection. |
| java.util.Set | getGroups( ) |
| | Provides the set of groups that have access |
| | to this collection. |
| java.util.Set | getItems( ) |
| | Provides the set of ItemS that are present |
| | in this collection. |
| java.lang.String | getName( ) |
| | Returns the name of this Collection. |
| void | removeGroupAccess(CmsUserGroup group) |
| | Removes a group from the access list of this collection. |
| void | removeItem(Item item) |
| | Removes an item from this collection. |
| void | removeUserAccess(CmsUser userToRemove) |
| | Removes a user from the access list of this collection. |
| void | setName(java.lang.String name) |
| | Sets the name of this Collection. |

Methods inherited from interface com.conceptis.cms.ObjectWithPrimaryKey

getPrimaryKey

1.1.16.1 setName

public void setName(java.lang.String name)

throws AuthorizationException, ConnectionException

Sets the name ofthis Collection.

Parameters:

name—the name of this Collection

Throws:

AuthorizationException—if the current user does not have permission to perform this operation

ConnectionException—if there is a problem interacting with the CMS; this will only be thrown if the driver implementation choses to use deferred data loading (for performance reason).

1.1.16.2 getName

public java.lang.String getName ( )

throws AuthorizationException, ConnectionException

Returns the name of this Collection.

Returns:

the name of this Collection

Throws:

AuthorizationException—if the current user does not have permission to perform this operation

ConnectionException—if there is a problem interacting with the CMS; this will only be thrown if the driver implementation choses to use deferred data loading (for performance reason).

1.1.16.3 addGroupAccess

public void addGroupAccess(CmsUserGroup group)

throws AuthorizationException, ConnectionException

Adds a group that has access to this collection. If the group already has access to this collection, this method will do nothing, but will not complain.

Parameters:

group—the group to add to the access list of this collection

Throws:

AuthorizationException—if the current user does not have permission to perform this operation

ConnectionException—if there is a problem interacting with the CMS; this will only be thrown if the driver implementation choses to use deferred data loading (for performance reason).

1.1.16.4 removeGroupAccess

public void removeGroupAccess(CmsUserGroup group)

throws AuthorizationException, ConnectionException

Removes a group from the access list of this collection. If the group did not have access to this collection, this method will do nothing, but will not complain.

Parameters:

group—the group to remove from the access list of this collection

Throws:

AuthorizationException—if the current user does not have permission to perform this operation ConnectionException—if there is a problem interacting with the CMS; this will only be thrown if the driver implementation choses to use deferred data loading (for performance reason).

1.1.16.5 getGroups

public java.util.Set getGroups ( )

throws AuthorizationException, ConnectionException,

MissingResourceException

Provides the set of groups that have access to this collection.

Returns:

the set of the code>CmsGroups that have access, in no particular order

Throws:

AuthorizationException—if the current user does not have permission to perform this operation

ConnectionException—if there is a problem interacting with the CMS; this will only be thrown if the driver implementation choses to use deferred data loading (for performance reason).

MissingResourceException—if the groups cannot be accessed

1.1.16.6 addUserAccess

public void addUserAccess(CmsUser userToAdd)

throws AuthorizationException, ConnectionException

Adds a user that has access to this collection. If the user already has access to this collection, this method will do nothing, but will not complain.

Parameters:

userToAdd—the user to add to the access list for this collection

Throws:

AuthorizationException—if the current user does not have permission to perform this operation

ConnectionException—if there is a problem interacting with the CMS; this will only be thrown if the driver implementation choses to use deferred data loading (for performance reason).

1.1.16.7 removeUserAccess

public void removeuserAccess(CmsUser userToRemove)

throws AuthorizationException, ConnectionException

Removes a user from the access list of this collection. If the user did not have access to this collection, this method will do nothing, but will not complain.

Parameters:

userToRemove—the user to remove from the access list of this collection

Throws:

AuthorizationException—if the current user does not have permission to perform this operation

ConnectionException—if there is a problem interacting with the CMS; this will only be thrown if the driver implementation choses to use deferred data loading (for performance reason).

1.1.16.8 getCmsUsers

public java.util.Set getCmsUsers ( )

throws AuthorizationException, ConnectionException, MissingResourceException

Provides the set of CmsUsers that have access to this collection.

Returns:

the set of the users that have access, in no particular order

Throws:

AuthorizationException—if the current user does not have permission to perform this operation

ConnectionException—if there is a problem interacting with the CMS; this will only be thrown if the driver implementation choses to use deferred data loading (for performance reason).

MissingResourceException—if the users cannot be accessed

1.1.16.9 addItem

public void addItem(Item item)

throws AuthorizationException, ConnectionException

Adds an item to this collection. If the item was already in the collection, this method will do nothing, but will not complain

Parameters:

item—the item to add to this collection

Throws:

AuthorizationException—if the current user does not have permission to perform this operation

ConnectionException—if there is a problem interacting with the CMS; this will only be thrown if the driver implementation choses to use deferred data loading (for performance reason).

1.1.16.10 removeItem

public void removeItem(Item item)

throws AuthorizationException, ConnectionException

Removes an item from this collection. If the item was not in the collection, this method will do nothing, but will not complain.

Parameters:

item—the item to remove from this collection

Throws:

AuthorizationException—if the current user does not have permission to perform this operation P ConnectionException—if there is a problem interacting with the CMS; this will only be thrown if the driver implementation choses to use deferred data loading (for performance reason).

1.1.16.11 getItems

public java.util.Set getItems ( )

throws AuthorizationException, ConnectionException

Provides the set of Items that are present in this collection.

Returns:

the set of the items in the collection, in no particular order

Throws:

AuthorizationException—if the current user does not have permission to perform this operation

ConnectionException—if there is a problem interacting with the CMS; this will only be thrown if the driver implementation choses to use deferred data loading (for performance reason).

### 1.1.17 INTERFACE COLLECTION FACTORY

public interface CollectionFactory

Interacts with the CMS to provide access to collections of the CMS.

Method Summary

| | |
|---|---|
| Collection | createNewCollection( ) |
| | Creates a new Collection instance, uninitialized, |
| | not stored in the CMS. |
| void | deleteCollection(Collection collection) |
| | Deletes this Collection. |
| Collection | getCollection(com.conceptis.util.PrimaryKey key) |
| | Provides the Collection with the specified key. |
| java.util.Set | getCollections( ) |
| | Provides the set of all CollectionS. |
| void | saveCollection(Collection collection) |
| | Saves the specified Collection. |

### Method Detail

1.1.17.1 getcollections

public java.util.Set getcollections ( )

throws ConnectionException, AuthorizationException

Provides the set of all Collections.

Returns:

the set of all Collection (may be empty but never null)

Throws:

ConnectionException—if there is a problem interacting with the CMS

AuthorizationException—if the current user does not have permission to perform this operation

1.1.17.2 getCollection

public Collection getCollection(com.conceptis.util.PrimaryKey key)

throws ConnectionException, AuthorizationException, MissingResourceException

Provides the Collection with the specified key.

Parameters:

key—the primary key of the Collection

Returns:

the Collection with the specified key

Throws:

ConnectionException—if there is a problem interacting with the CMS

AuthorizationException—if the current user does not have permission to perform this operation

MissingResourceException—if the Collection specified by the key does not exist

1.1.17.3 createNewCollection

public Collection createNewCollection ( )

Creates a new Collection instance, uninitialized, not stored in the CMS. Once correctly initialized, this instance may then be inserted in the CMS using the saveCollection(com.conceptis.cms.Collection) method.

Returns:

the newly created Collection

1.1.17.4 saveCollection

public void saveCollection(Collection collection)

throws ConnectionException, AuthorizationException, MissingResourceException

Saves the specified Collection. This will change the Collection's entry in the CMS to reflect the state of the collection parameter.

Parameters:

collection—the Collection to insert/update

Throws:

ConnectionException—if there is a problem interacting with the CMS

AuthorizationException—if the current user does not have permission to perform this operation

MissingResourceException—if a previously existing Collection does not exist any longer

1.1.17.5 deleteCollection

public void deleteCollection(Collection collection)

throws ConnectionException, AuthorizationException, MissingResourceException

Deletes this Collection. This may have unintended consequences. Note that some implementations may throw an UnsupportedOperationException if the deletion of Collections is not possible.

Parameters:

collection—the Collection to delete

Throws:

ConnectionException—if there is a problem interacting with the CMS

AuthorizationException—if the user does not have permission to perform this operation

MissingResourceException—if the Collection does not exist any longer

### 1.1.18 INTERFACE CONNECTION

public interface Connection

Provides access to factories that can be used to interact with the CMS.

Method Summary

| | |
|---|---|
| void | clearCaches( ) |
| | Clears the caches of all factories. |
| void | close( ) |
| | Closes the connection. |
| com.conceptis.util.PrimaryKey | createPrimaryKey(java.lang.String key) |
| | This method returns a PrimaryKey |
| | of the appropriate type. |
| CmsUserFactory | getCmsUserFactory( ) |
| | Provides a CmsUserFactory that utilizes |
| | this connection. |
| CmsUserGroupFactory | getCmsUserGroupFactory( ) |
| | Provides a CmsUserGroupFactory that |
| | utilizes this connection. |
| CollectionFactory | getCollectionFactory( ) |
| | Provides a CollectionFactory that |
| | utilizes this connection. |
| IndexFactory | getIndexFactory( ) |
| | Provides a IndexFactory that |
| | utilizes this connection. |
| ItemFactory | getItemFactory( ) |
| | Provides a ItemFactory that |
| | utilizes this connection. |
| ItemTypeFactory | getItemTypeFactory( ) |
| | Provides a ItemTypeFactory that |
| | utilizes this connection. |
| CmsUser | getOwner( ) |
| | This method returns the CmsUser |
| | associated with this connection. |
| PublicationStatusFactory | getPublicationStatusFactory( ) |
| | Provides a PublicationFlowFactory |
| | that utilizes this connection. |
| RelationTypeFactory | getRelationTypeFactory( ) |
| | Provides a RelationTypeFactory that |
| | utilizes this connection. |
| java.lang.String | getURL( ) |
| | This method provides the URL that was |
| | used to establish the connection. |
| boolean | isValid( ) |
| | This method returns true if this |
| | Connection can still be used to connect |
| | to the CMS. |

### Method Detail

1.1.18.1 close

public void close ( )

throws ConnectionException

Closes the connection. This frees up whatever resources were in use to interact with the CMS.

Throws:

ConnectionException—if there is a problem closing the connection

1.1.18.2 getCmsUserFactory

public CmsUserFactory getCmsUserFactory ( )

Provides a CmsUserFactory that utilizes this connection.

Returns:

a factory for CmsUsers.

1.1.18.3 getCmsUserGroupFactory

public CmsUserGroupFactory getCmsUserGroupFactory ( )

Provides a CMsUserGroupFactory that utilizes this connection.

Returns:

a factory for CmsUserGroups.

1.1.18.4 getCollectionFactory

public CollectionFactory getCollectionFactory ( )

Provides a CollectionFactory that utilizes this connection.

Returns:

a factory for Collections.

1.1.18.5 getItemFactory

public ItemFactory getItemFactory ( )

Provides a ItemFactory that utilizes this connection.

Returns:

1.1.18.6 getItemTypeFactory

public ItemTypeFactory getItemTypeFactory ( )

Provides a ItemTypeFactory that utilizes this connection.

Returns:

a factory for CollectionTypeS.

1.1.18.7 getPublicationStatusFactory

public PublicationStatusFactory getPublicationStatusFactory ( )

Provides a PublicationFlowFactory that utilizes this connection.

Returns:

a factory for PublicationFlowS.

1.1.18.8 getRelationTypeFactory

public RelationTypeFactory getRelationTypeFactory ( )

Provides a RelationTypeFactory that utilizes this connection.

Returns:

a factory for RelationTypeS.

1.1.18.9 getIndexFactory

public IndexFactory getIndexFactory ( )

Provides a IndexFactory that utilizes this connection.

Returns:

a factory for Indexes.

1.1.18.10 isValid

public boolean isValid ( )

This method returns true if this connection can still be used to connect to the CMS.

The validation procedure is driver-dependent, but must be very light (almost no data transfer) and fast, because this operation may be performed very often (by a pooling mechanism for example).

Returns:

true is this connection is still valid; false otherwise.

1.1.18.11 getOwner

public CmsUser getOwner ( )

This method returns the CmsUser associated with this connection. Since methods may throw AuthorizationExceptions depending on the security permissions for this user, it is useful for business logic to be able to preemptively know whether or not these operations will be successful prior to calling them. Using this method, this becomes possible.

Returns:

The CmsUser associated with this connection.

1.1.18.12 createPrimaryKey

public com.conceptis.util.PrimaryKey createPrimaryKey(java.lang.String key)

This method returns a PrimaryKey of the appropriate type. Since PrimaryKeys will often be in a serialized form, this method allows the instantiation of the appropriate key type.

Parameters:

key—The string (serialized) representation of the primary key, typically received from a web application.

Returns:

The PrimaryKey associated with the specified parameter.

1.1.18.13 getURL

public java.lang.String getURL ( )

This method provides the URL that was used to establish the connection.

Returns:

the URL used to establish the connection

1.1.18.14 clearCaches

public void clearcaches ( )

Clears the caches of all factories.

### 1.1.19 INTERFACE DRIVER

public interface Driver

Represents a driver for a CMS. The driver is able to provide Connections to objects that request them, with the correct URL and set of credentials (Username, password, etc—driver dependent information).

A well behaved implementation of the Driver interface is expected to register itself with the DriverManager class when the class is first loaded. A failure to do this will result in the driver implementation being unavilable to the runtime environment.

See Also:

DriverManager

Method Summary

| | |
|---|---|
| boolean | acceptsURL(java.lang.String url) |
| | Tests whether this driver understands the specified URL. |
| Connection | connect(java.lang.String url, java.util.Properties properties) |
| | Opens a connection to the specified URL. |

### Method Detail

1.1.19.1 connect

public Connection connect(java.lang.String url, java.util.Properties properties)

throws ConnectionException, AuthenticationException, AuthorizationException

Opens a connection to the specified URL.

Parameters:

url—the url to open a connection to.

properties—configuration options for the desired connection

Returns:

a connection to the CMS (null if it could not be opened)

Throws:

ConnectionException—thrown if there is a problem

AuthenticationException—thrown if the usemame/password combination is invalid

AuthorizationException—if the site is inaccessible

1.1.19.2 acceptsURL

public boolean acceptsURL(java.lang.String url)

Tests whether this driver understands the specified URL.

Parameters:

url—the url to test

Returns:

true if the driver believes it can handle the url, false otherwise

1.1.20 INTERFACE FIELD

All Superinterfaces:

ObjectWithPrimaryKey

public interface Field

extends ObjectWithPrimaryKey

A Field is an editable parameter. Their behavior are defined in ItemTypes(valid values, type, etc.), and the values are assigned when using an Item.

Field Summary

| | |
|---|---|
| static int | TYPE DATE |
| | Fields of type TYPE_DATE hold an instance of java.util.Date. |
| static int | TYPE INTEGER |
| | Fields of type TYPE_INTEGER hold an instance of java.lang.Integer. |
| static int | TYPE PHONE NUMBER |
| | Fields of type TYPE_PHONE_NUMBER hold an instance of |
| | java.lang.String that must respect a specific format. |
| static int | TYPE POSTAL CODE |
| | Fields of type TYPE_POSTAL_CODE hold an instance of java.lang.String |
| | that must respect a specific format. |
| static int | TYPE STRING |
| | Fields of type TYPE_STRING hold an instance of java.lang.String with |
| | no specific constraint. |
| static int | TYPE URL |
| | Fields of type TYPE_URL hold an instance of java.net.URL. |
| static int | TYPE XML |
| | Fields of type TYPE_XML hold an instance of java.lang.String that must |
| | be a valid XML string. |

Method Summary

| | |
|---|---|
| void | addValidValue(java.lang.Object value) |
| | Adds a new valid value for this Field definition. |
| java.lang.Object | getDefaultValue( ) |
| | Provides the default value for this Field definition. |
| int | getFieldType( ) |
| | Returns the type of this Field. |
| java.lang.String | getHelpText( ) |
| | Provides the help text for the field, if available. |
| java.lang.String | getName( ) |
| | Returns the name of this Field. |
| int | getOrder( ) |
| | Provides the order of the field. |
| int | getPage( ) |
| | Provides the page number of the field, used for display purposes. |
| java.lang.String | getPageDescription( ) |
| | Provides the name of the page the field is on. |
| java.lang.String | getServerName( ) |
| | Provides the server name of this Field |
| java.util.Set | getValidValues( ) |
| | Returns a Set of all valid values defined for this Field. |
| boolean | isEditable( ) |
| | This feature is not supported in this version of the CMS API, and |
| | will always throw an UnsupportedOperationException. |
| boolean | isMandatory( ) |
| | Indicates whether the field is mandatory. |
| void | removeValidValue(java.lang.Object value) |
| | Removes a valid value for this Field definition. |
| void | setDefaultValue(java.lang.Object value) |
| | Sets the default value for this Field definition. |
| void | setEditable(boolean editable) |
| | This feature is not supported in this version of the CMS API, and |
| | will always throw an UnsupportedOperationException. |
| void | setFieldType(int newType) |
| | Stes the type of this Field. |
| void | setMandatory(boolean mandatory) |
| | Sets whether the field is mandatory or not. |
| void | setName(java.lang.String name) |
| | Sets the name of this Field. |
| void | setServerName(java.lang.String name) |
| | Sets the name of this Field. |
| boolean | validateValue(java.lang.Object value) |
| | This helper method provides a way to validate a value before |
| | setting it in an Item. |

Methods inherited from interface com.conceptis.cms.ObjectWithPrimaryKey

getPrimaryKey

### Field Detail

1.1.20.1 TYPE_STRING

public static final int TYPE_STRING

Fields of type TYPE_STRING hold an instance of java.lang. String with no specific constraint.

See Also:

Constant Field Values

1.1.20.2 TYPE_INTEGER

public static final int TYPE_INTEGER

Fields of type TYPE_INTEGER hold an instance of java.lang.Integer.

See Also:

Constant Field Values

1.1.20.3 TYPE_DATE

public static final int TYPE_DATE

FieldS of type TYPE_DATE hold an instance of java.util.Date.

See Also:

Constant Field Values

1.1.20.4 TYPE_URL

public static final int TYPE_URL

Fields of type TYPE_URL hold an instance of java.net.URL.

See Also:

Constant Field Values

1.1.20.5 TYPE_PHONE_NUMBER

public static final int TYPE_PHONE_NUMBER

Fields of type TYPE_PHONE_NUMBER hold an instance of java.lang. String that must respect a specific format.

See Also:

Constant Field Values

1.1.20.6 TYPE_POSTAL_CODE

public static final int TYPE_POSTAL_CODE

Fields of type TYPE_POSTAL_CODE hold an instance of java.lang. String that must respect a specific format.

See Also:

Constant Field Values

1.1.20.7 TYPE_XML

public static final int TYPE_XML

Fields of type TYPE_XML hold an instance of java.lang.String that must be a valid XML string.

See Also:

Constant Field Values

### Method Detail

1.1.20.8 setName

public void setName(java.lang.String name)

throws AuthorizationException, ConnectionException

Sets the name of this Field.

Parameters:

name—the name of this Field

Throws:

AuthorizationException—if the current user does not have permission to perform this operation ConnectionException—if there is a problem interacting with the CMS; this will only be thrown if the driver implementation choses to use deferred data loading (for performance reason).

1.1.20.9 getName

public java.lang.String getName ( )

throws AuthorizationException, ConnectionException

Returns the name of this Fiel

Returns:

the name of this Field

Throws:

AuthorizationException—if the current user does not have permission to perform this operation

ConnectionException—if there is a problem interacting with the CMS; this will only be thrown if the driver implementation choses to use deferred data loading (for performance reason).

1.1.20.10 getServerName

public java.lang.string getServerName ( )

throws AuthorizationException, ConnectionException

Provides the server name of this Field

Returns:

the server name of this field

Throws:

AuthorizationException—if the current user does not have permission to perform this operation

ConnectionException—if there is a problem interacting with the CMS; this will only be thrown if the driver implementation choses to use deferred data loading (for performance reason).

1.1.20.11 setServerName

public void setServerName(java.lang.String name)

throws AuthorizationException, ConnectionException

Sets the name of this Field.

Parameters:

name—the server name of this Field

Throws:

AuthorizationException—if the current user does not have permission to perform this operation

ConnectionException—if there is a problem interacting with the CMS; this will only be thrown if the driver implementation choses to use deferred data loading (for performance reason).

1.1.20.12 isEditable

public boolean isEditable ( )

throws AuthorizationException, ConnectionException

This feature is not supported in this version of the CMS API, and will always throw an UnsupportedoperationException.

Indicates whether the field is editable.

Returns:

true if the field is editable, false othervvise

Throws:

AuthorizationException—if the current user does not have permission to perform this operation

ConnectionException—if there is a problem interacting with the CMS; this will only be thrown if the driver implementation choses to use deferred data loading (for performance reason).

1.1.20.13 setEditable

public void setEditable(boolean editable)

throws AuthorizationException, ConnectionException

This feature is not supported in this version of the CMS API, and will always throw an UnsupportedoperationException.

Sets the editability of the field.

Parameters:

editable—true if the field should be editable, false otherwise

Throws:

AuthorizationException—if the current user does not have permission to perform this operation

ConnectionException—if there is a problem interacting with the CMS; this will only be thrown if the driver implementation choses to use deferred data loading (for performance reason).

1.1.20.14 isMandatory

public boolean isMandatory ( )

throws AuthorizationException, ConnectionException

Indicates whether the field is mandatory.

Returns:

true if the field is mandatory, false otherwise

Throws:

AuthorizationException—if the current user does not have permission to perform this operation

ConnectionException—if there is a problem interacting with the CMS; this will only be thrown if the driver implementation choses to use deferred data loading (for performance reason).

1.1.20.15 setMandatory

public void setMandatory(boolean mandatory)

throws AuthorizationException, ConnectionException

Sets whether the field is mandatory or not.

Parameters:

mandatory—true if the field is mandatory, false otherwise

Throws:

AuthorizationException—if the current user does not have permission to perform this operation

ConnectionException—if there is a problem interacting with the CMS; this will only be thrown if the driver implementation choses to use deferred data loading (for performance reason).

1.1.20.16 getFieldType

public int getFieldType ( )

throws AuthorizationException, ConnectionException

Returns the type of this Field. The returned value should be one of the defined Field.TYPE_XYZ constants.

Returns:

an integer representing the type of field (see the Field. TYPE_XYZ constants for the accepted values)

Throws:

AuthorizationException—if the current user does not have permission to perform this operation

ConnectionException—if there is a problem interacting with the CMS; this will only be thrown if the driver implementation choses to use deferred data loading (for performance reason).

1.1.20.17 setFieldType

public void setFieldType(int newType)

throws AuthorizationException, ConnectionException

Stes the type of this Field. The specified value should be one of the defined Field.TYPE_XYZ constants.

Parameters:

newType—integer representing the type of field(see the Field. TYPE_XYZ constants for the accepted values)

Throws:

AuthorizationException—if the current user does not have permission to perform this operation

ConnectionException—if there is a problem interacting with the CMS; this will only be thrown if the driver implementation choses to use deferred data loading (for performance reason).

1.1.20.18 validateValue

public boolean validateValue(java.lang.Object value)

throws AuthorizationException, ConnectionException

This helper method provides a way to validate a value before setting it in an Item. It will check if the specified value respects the constraints set by this Field, such as the Class. the value itself (if it must be within a restricted set of allo.wed values), etc. The set of valid values can be modified using addval idvalue (java. lang .Obj ect) and removevalidvalue (java. lang. Object). If no valid value is defined, then any value would be acceptable, unless this method disagrees for some other reason.

Parameters:

value—the Object that may become the corresponding value in an Item for this Field definition.

Returns:

true if the value respects the constraints defined by this Field definition

Throws:

AuthorizationException—if the user does not have permission to perform this operation

ConnectionException—if there is a problem interacting with the CMS; this will only be thrown if the driver implementation choses to use deferred data loading (for performance reason).

1.1.20.19 addValidValue

public void addvalidValue(java.lang.Object value)

throws java.lang.IllegalArgumentException, AuthorizationException

Adds a new valid value for this Field definition. This means that the validateValue (java.lang.Object) will only return true if the specified value equals one of the valid values defined through this method.

Parameters:

value—the valid value to add to the Set.

Throws:

java.lang.IllegalArgumentException—if the value parameter doesn't even respect the basic constraints of this Field definition (such a the Class) AuthorizationException—if the the user cannot access this information

1.1.20.20 getValidValues

public java.util.Set getValidValues ( )

throws AuthorizationException, ConnectionException

Returns a Set of all valid values defined for this Field. If empty, this means that any value respecting the basic constraints is acceptable.

Returns:

a Set of all valid values defined for this Field. Can be emtpy but never null

Throws:

AuthorizationException—if the the user cannot access this information

ConnectionException—if there is a problem interacting with the CMS; this will only be thrown if the driver implementation choses to use deferred data loading (for performance reason).

1.1.20.21 removeValidValue

public void removeValidValue(java.lang.Object value)

throws AuthorizationException

Removes a valid value for this Field definition. If the value was the last one, then any value respecting the basic constraints Will bcacceptale.

Parameters:

value—the valid value to remove from the Set.

Throws:

AuthorizationException—if the the user cannot access this information

1.1.20.22 getDefaultValue

public java.lang.Object getDefaultValue ( )

throws AuthorizationException, ConnectionException

Provides the default value for this Field definition.

Returns:

the default value for the field, possibly null

Throws:

AuthorizationException—if the current user does not have permission to perform this operation

ConnectionException—if there is a problem interacting with the CMS; this will only be thrown if the driver implementation choses to use deferred data loading (for performance reason).

1.1.20.23 setDefaultValue

public void setDefaultvalue(java.lang.Object value)

throws AuthorizationException

Sets the default value for this Field definition.

Parameters:

value—the new default value

Throws:

AuthorizationException—if the current user does not have permission to perform this operation

1.1.20.24 getPage

public int getpage ( )

throws AuthorizationException, ConnectionException

Provides the page number of the field, used for display purposes. If it cannot be determined, a 0 is returned.

Returns:

the page number of the field, 0 if it cannot be determined

Throws:

AuthorizationException—if the current user does not have permission to perform this operation

ConnectionException—if there is a problem interacting with the CMS; this will only be thrown if the driver implementation choses to use deferred data loading (for performance reason).

1.1.20.25 getorder

public int getOrder ( )

throws AuthorizationException, ConnectionException

Provides the order of the field.

Returns:

the order of the field

Throws:

AuthorizationException—if the current user does not have permission to perform this operation

ConnectionException—if there is a problem interacting with the CMS; this will only be thrown if the driver implementation choses to use deferred data loading (for performance reason).

1.1.20.26 getPageDescription

public java.lang.String getPageDescription ( )

throws AuthorizationException, ConnectionException

Provides the name of the page the field is on.

Returns:

the name of the page

Throws:

AuthorizationException—if the current user does not have permission to perform this operation

ConnectionException—if there is a problem interacting with the CMS; this will only be thrown if the driver implementation choses to use deferred data loading (for performance reason).

1.1.20.27 getHelpText

public java.lang.String getHelpText ( )

throws AuthorizationException, ConnectionException

Provides the help text for the field, if available.

Returns:

the help text for the field

Throws:

AuthorizationException—if the current user does not have permission to perform this operation

ConnectionException—if there is a problem interacting with the CMS; this will only be thrown if the driver implementation choses to use deferred data loading (for performance reason).

### 1.1.21 INTERFACE INDEX

All Superinterfaces:

ObjectWithPrimaryKey

public interface Index

extends ObjectWithPrimaryKey

An Index represents a categorization tool used on a branch.

Method Summary

| | |
|---|---|
| java.lang.String | getDefaultValue( ) |
| | Provides the default value of this index. |
| java.lang.String | getName( ) |
| | Provides the name of the index. |
| java.util.Set | getValidValues( ) |
| | Provides the valid values of this index. |
| boolean | isMultiple( ) |
| | Indicates whether the index allows multiple values |
| | to be selected. |

Methods inherited from interface com.conceptis.cms.ObjectWithPrimaryKey

getprimaryKey

### Method Detail

1.1.21.1 getName

public java.lang.String getName ( )

throws ConnectionException, AuthorizationException

Provides the name of the index.

Returns:

the name of the index

Throws:

AuthorizationException—if the current user does not have permission to perform this operation

ConnectionException—if there is a problem interacting with the CMS; this will only be thrown if the driver implementation choses to use deferred data loading (for performance reason).

1.1.21.2 getValidValues

public java.util.Set getValidValues ( )

throws ConnectionException, AuthorizationException

Provides the valid values of this index.

Returns:

the valid values of this index (a set containing Qtrnns)

Throws:

AuthorizationException—if the current user does not have permission to perform this operation

ConnectionException—if there is a problem interacting with the CMS; this will only be thrown if the driver implementation choses to use deferred data loading (for performance reason).

1.1.21.3 getDefaultValue

public java.lang.String getDefaultValue ( )

throws ConnectionException, AuthorizationException

Provides the default value of this index.

Returns:

the default value of this index

Throws:

AuthorizationException—if the current user does not have permission to perform this operation

ConnectionException—if there is a problem interacting with the CMS; this will only be thrown if the driver implementation choses to use deferred data loading (for performance reason).

1.1.21.4 isMultiple

public boolean isMultiple ( )

throws ConnectionException, AuthorizationException

Indicates whether the index allows multiple values to be selected.

Returns:

true if multiple values are allowed, false otherwise

Throws:

AuthorizationException—if the current user does not have permission to perform this operation

ConnectionException—if there is a problem interacting with the CMS; this will only be thrown if the driver implementation choses to use deferred data loading (for performance reason).

### 1.1.22 INTERFACE INDEXFACTORY

public interface IndexFactory

Interacts with the CMS to provide access indices of the CMS.

Method Summary

| | |
|---|---|
| Index | getIndex(com.conceptis.util.PrimaryKey key) |
| | Provides the index for the specified key. |
| java.util.Set | getIndices(Item item) |
| | Provides the indices available for a branch. |

### Method Detail

1.1.22.1 getIndex

public Index getIndex(com.conceptis.util.PrimaryKey key)

throws ConnectionException, AuthorizationException, MissingResourceException

Provides the index for the specified key.

Parameters:

key—the primary key of the index

Returns:

the index with the primary key

Throws:

ConnectionException—if there is a problem interacting with the CMS

AuthorizationException—if the current user does not have permission to perform this operation

MissingResourceException—if the user specified by the key does not exist

1.1.22.2 getIndices

public java.util.Set getIndices(Item item)

throws ConnectionException, AuthorizationException, MissingResourceException

Provides the indices available for a branch.

Parameters:

item—the branch to find the indices for

Returns:

the indices available for a branch (a set of Index objects); may be empty but not null

Throws:

ConnectionException—if there is a problem interacting with the CMS

AuthorizationException—if the current user does not have permission to perform this operation

MissingResourceException—if the user specified by the key does not exist

### 1.1.23 INTERFACE ITEM

All Superinterfaces:

ObjectWithPrimaryKey

public interface Item

extends ObjectWithPrimaryKey

An Item is the most basic piece of data found in the Content Management System (CMS).

Method Summary

| | |
|---|---|
| boolean | addIndexValue(Index index, java.lang.String value) |
| | Adds an index value. |
| void | addRelatedItem(RelationType relationType, |
| | Item relatedItem, java.util.Map parameters) |
| | Links an Item to this one, using the given RelationType |
| | to define the link itself. |
| void | addSupportedLocale(java.util.Locale locale) |
| | Mark the specified Locale as supported for this item. |
| void | addThesaurusTerm(int level, java.lang.String term) |
| | Indexes the item in a thesaurus. |
| BinaryContent | getBinaryContent( ) |
| | Provides the binary content stored in the Item. |
| Collection | getCollection( ) |
| | Returns the Collection to which this Item belongs. |
| java.lang.String | getComment( ) |
| | Returns the comment associated with this Item. |
| java.util.Locale | getDefaultLocale( ) |
| | Provides the item's default Locale. |
| java.lang.Object | getFieldValue(Field field) |
| | Returns the value of the Field. |
| java.lang.Object | getFieldValue(java.lang.String name) |
| | Returns the value of the Field identified by the given |
| | name. |
| java.util.Set | getIndexValues(Index index) |
| | Provides the index values set on the item. |
| java.util.Set | getIndices( ) |
| | Provides the indices available for this item. |
| ItemType | getItemType( ) |
| | Returns the <CODEITEMTYPE< code>of this Item. |
| java.util.Date | getLastModifiedDate( ) |
| | Provides the last modified date. |
| java.lang.String | getLocalizedValue(java.util.Locale locale) |
| | Returns the value for the specified Locale. |
| java.lang.String | getName( ) |
| | Returns the name of this Item. |
| PublicationStatus | getPublicationStatus( ) |
| | Returns the PublicationStatus of this Item. |
| java.util.Set | getRelatedItems(ItemType itemType) |
| | Returns a Set of ItemS related to this Item and that all |
| | share the same ItemType. |
| java.util.Set | getRelatedItems(RelationType relationType) |
| | Returns a Set of ItemS related to this Item by the given |
| | RelationType. |
| java.util.Set | getRelatedItems(RelationType relationType, |
| | ItemType itemType) |
| | Returns a Set of ItemS related to this Item by the given |
| | RelationType and that all share the same ItemType. |
| java.util.Set | getRelationType(Item relatedItem) |
| | Returns the Set of RelationTypes that exist between this |
| | Item and the specified Item. |
| java.util.Set | getRelationTypes( ) |
| | Provides the RelationTypes that this object is |
| | participating in. |
| java.lang.String | getShortName( ) |
| | Returns the short name associated with this Item. |
| java.util.Date | getSignOffDate( ) |
| | Returns the DateItem to which this PublicationStatus |
| | was assigned can be signed off automatically. |
| java.util.List | getSupportedLocales( ) |
| | Provides the LocaleS supported for this item. |
| com.conceptis.util.Tree | getThesaurusTerms( ) |
| | Get the thesaurus terms associated to the item. |
| java.util.List | getVersions( ) |
| | Returns the List of VersionS associated to this Item. |
| boolean | isLocked( ) |
| | Returns true if this Item is locked for editing; false |
| | otherwise. |
| void | reject( ) |
| | Rejects the Item to the previous publication status. |
| void | reject(java.lang.String message) |
| | Rejects the Item to the previous publication status, with a |
| | message. |
| void | removeAllThesaurusTerms( ) |
| | Removes all thesaurus terms from the indexation of the |
| | item |
| boolean | removeIndexValue(Index index, |
| | java.lang.String value) |
| | Removes and index value. |
| void | removeRelatedItem(RelationType relationType, |
| | Item relatedItem) |
| | Removes the link between the given Item and this one, |
| | the link being defined by the given RelationType. |
| void | removeSupportedLocale(java.util.Locale locale) |
| | Unmark the Locale as being supported for this item. |
| void | removeThesaurusTerm(java.lang.String term) |
| | Removes a thesaurus term from the indexation of the item |
| void | setBinaryContent(java.lang.String mimeType, |
| | java.io.InputStream inputStream, byte[] termination) |
| | Sets the binary content stored in the Item. |
| void | setBinaryContent(java.lang.String mimeType, |
| | java.io.InputStream inputStream, long length) |
| | Sets the binary content stored in the Item. |
| void | setCollection(Collection collection) |
| | Sets the Collection to which this Item belongs. |
| void | setComment(java.lang.String comment) |
| | Sets the comment associated with this Item. |
| void | setDefaultLocale(java.util.Locale locale) |
| | Set the item's default Locale. |
| void | setFieldValue(Field field, java.lang.Object value) |
| | Sets the value of a Field to the given Object. |
| void | setFieldValue(java.lang.String name, |
| | java.lang.Object value) |
| | Sets the value of a field, identified by its name, to the |
| | given Object. |
| void | setLocalizedValue(java.util.Locale locale, |
| | java.lang.String value) |
| | Set the localized value for the specified Locale. |
| void | setName(java.lang.String name) |
| | Sets the name of this Item. |
| void | setShortName(java.lang.String shortName) |
| | Sets the short name associated with this Item. |
| void | setSignOffDate(java.util.Date date) |
| | Sets the DateItem to which this PublicationStatus was |
| | assigned can be signed off automatically. |
| void | signoff( ) |
| | Signs off the Item to the next publication status. |
| void | signoff(java.lang.String message) |
| | Signs off the Item to the next publication status, with a |
| | message. |

Methods inherited from interface com.conceptis.cms.ObjectWithPrimaryKey

getPrimaryKey

### Method Detail

1.1.23.1 getItemType

public ItemTypegetItemType ( )

throws AuthorizationExceptionConnectionException, MissingResourceException

Returns the <CODEITEMTYPE<code>of this Item.

Returns:

the ItemType of this Item

Throws:

AuthorizationException—if the current user does not have permission to perform this operation

ConnectionException—if there is a problem interacting with the CMS; this will only be thrown if the driver implementation choses to use deferred data loading (for performance reason).

MissingResourceException—if the type does not exist

1.1.23.2 setName

public void setName(java.lang.String name)

throws AuthorizationException, ConnectionException, java.lang.IllegalStateException

Sets the name of this Item.

Parameters:

name—the name of this Item

Throws:

AuthorizationException—if the current user does not have permission to perform this operation

ConnectionException—if there is a problem interacting with the CMS; this will only be thrown if the driver implementation choses to use deferred data loading (for performance reason).

java.lang.IllegalStateException—if this Item was not locked for editing when retrieved.

1.1.23.3 getName

public java.lang.String getName ( )

throws AuthorizationException, ConnectionException

Returns the name of this Item.

Returns:

the name of this Item

Throws:

AuthorizationException—if the current user does not have permission to perform this operation

ConnectionException—if there is a problem interacting with the CMS; this will only be thrown if the driver implementation choses to use deferred data loading (for performance reason).

1.1.23.4 setShortName

public void setShortName(java.lang.String shortname)

throws AuthorizationException, ConnectionException, java.lang.IllegalStateException

Sets the short name associated with this Item.

Parameters:

shortName—the short name associated with this Item

Throws:

AuthorizationException—if the current user does not have permission to perform this operation

ConnectionException—if there is a problem interacting with the CMS; this will only be thrown if the driver implementation choses to use deferred data loading (for performance reason).

java.lang.IllegalStateException—if this Item was not locked for editing when retrieved.

1.1.23.5 getShortName

public java.lang.String getShortName ( )

throws AuthorizationException, ConnectionException

Returns the short name associated with this Item.

Returns:

the short name associated with this Item

Throws:

AuthorizationException—if the current user does not have permission to perform this operation

ConnectionException—if there is a problem interacting with the CMS; this will only be thrown if the driver implementation choses to use deferred data loading (for performance reason).

1.1.23.6 setCollection

public void setCollection(Collection collection)

throws AuthorizationException, ConnectionException, java.lang.IllegalStateException

Sets the Collection to which this Item belongs.

Parameters:

collection—the Collection to which this Item belongs

Throws:

AuthorizationException—if the current user does not have permission to perform this operation

ConnectionException—if there is a problem interacting with the CMS; this will only be thrown if the driver implementation choses to use deferred data loading (for performance reason).

java.lang.IllegalStateException—if this Item was not locked for editing when retrieved.

1.1.23.7 getCollection

public Collection getCollection ( )

throws AuthorizationException, ConnectionException, MissingResourceException

Returns the Collection to which this Item belongs.

Returns:

the Collection to which this Item belongs

Throws:

AuthorizationException—if the current user does not have permission to perform this operation

ConnectionException—if there is a problem interacting with the CMS; this will only be thrown if the driver implementation choses to use deferred data loading (for performance reason).

MissingResourceException—if the collection does not exist

1.1.23.8 setComment

public void setComment(java.lang.String comment)

throws AuthorizationException, ConnectionException, java.lang.IllegalStateException

Sets the comment associated with this Item.

Parameters:

comment—the comment associated with this Item

Throws:

AuthorizationException—if the current user does not have permission to perform this operation

ConnectionException—if there is a problem interacting with the CMS; this will only be thrown if the driver implementation choses to use deferred data loading (for performance reason).

java.lang.IllegalStateException—if this Item was not locked for editing when retrieved.

1.1.23.9 getComment

public java.lang.String getComment ( )

throws AuthorizationException, ConnectionException

Returns the comment associated with this Item.

Returns:

the comment associated with this Item

Throws:

AuthorizationException—if the current user does not have permission to perform this operation

ConnectionException—if there is a problem interacting with the CMS; this will only be thrown if the driver implementation choses to use deferred data loading (for performance reason).

1.1.23.10 setFieldValue

public void setFieldValue(java.lang.String name, java.lang.object value)

throws AuthorizationException, ConnectionException, java.lang.IllegalArgumentException, java.lang.IllegalStateException, MissingResourceException

Sets the value of a field, identified by its name, to the given Object.

Parameters:

name—the name of the field

value—the value of the field, which can be any Object

Throws:

AuthorizationException—if the current user does not have permission to perform this operation

ConnectionException—if there is a problem interacting with the CMS; this will only be thrown if the driver implementation choses to use deferred data loading (for performance reason).

java.lang.IllegalArgumentException—if the value is not acceptable for the corresponding Field

java.lang.IllegalStateException—if this Item was not locked for editing when retrieved.

MissingResourceException—if the item type does not exist

1.1.23.11 getFieldValue

public java.lang.Object getFieldValue(java.lang.String name)

throws AuthorizationException, ConnectionException, java.lang.IllegalArgumentException, MissingResourceException

Returns the value of the Field identified by the given name. If the corresponding Field does not have a value set, this method will return null. If the specified Field cannot be found, this method will throw an IllegalArgumentException.

Parameters:

name—the name of the Field

Returns:

the value of the Field, which can be any object; null if no value has been set

Throws:

AuthorizationException—if the current user does not have permission to perform this operation

ConnectionException—if there is a problem interacting with the CMS; this will only be thrown if the driver implementation choses to use deferred data loading (for performance reason).

java.lang.IllegalArgumentException—if no Field can be found for the specified name

MissingResourceException—if the item type does not exist

1.1.23.12 setFieldValue

public void setFieldValue(Field field, java.lang.Object value)

throws AuthorizationException, ConnectionException, java.lang.IllegalArgumentException, java.lang.IllegalStateException, MissingResourceException

Sets the value of a Field to the given Object.

Parameters:

field—the Field

value—the value of the field, which can be any Object

Throws:

AuthorizationException—if the current user does not have permission to perform this operation

ConnectionException—if there is a problem interacting with the CMS; this will only be thrown if the driver implementation choses to use deferred data loading (for performance reason).

java.lang.IllegalArgumentException—if the value is not acceptable for the corresponding Field

java.lang.IllegalStateException—if this Item was not locked for editing when retrieved.

MissingResourceException—if the item type does not exist

1.1.23.13 getFieldValue

public java.lang.Object getFieldValue(Field field)

throws AuthorizationException, ConnectionException, java.lang.IllegalArgumentException, MissingResourceException

Returns the value of the Field. If the corresponding Field does not have a value set, this method will return null. If the specified Field cannot be found, this method will throw an IllegalArgumentException.

Parameters:

field—the Field

Returns:

the value of the Field, which can be any Object; null if no value has been set

Throws:

AuthorizationException—if the current user does not have permission to perform this operation

ConnectionException—if there is a problem interacting with the CMS; this will only be thrown if the driver implementation choses to use deferred data loading (for performance reason).

java.lang.IllegalArgumentException—if no Field can be found for the specified name

MissingResourceException—if the item type does not exist

1.1.23.14 getPublicationStatus

public PublicationStatusgetPublicationStatus ( )

throws AuthorizationException, MissingResourceException

Returns the PublicationStatus of this Item.

Returns:

the PublicationStatus of this Item

Throws:

AuthorizationException—if the current user does not have permission to perform this operation

ConnectionException—if there is a problem interacting with the CMS; this will only be thrown if the driver implementation choses to use deferred data loading (for performance reason).

MissingResourceException—if the status does not exist

1.1.23.15 getVersions

public java.util.List getVersions ( )

throws AuthorizationException, ConnectionException

Returns the List of versions associated to this Item.

Returns:

the List of Versions associated to this Item

Throws:

AuthorizationException—if the current user does not have permission to perform this operation

ConnectionException—if there is a problem interacting with the CMS; this will only be thrown if the driver implementation choses to use deferred data loading (for performance reason).

1.1.23.16 getBinaryContent

public BinaryContent getBinaryContent ( )

throws AuthorizationException, MissingResourceException, ConnectionException

Provides the binary content stored in the Item. If there is no binary content in this item, it will return null.

Returns:

the binary content in the item, null if there is no binary content

Throws:

AuthorizationException—if the current user does not have permission to perform this operation

MissingResourceException—if the item does not exist

ConnectionException—if there is a problem interacting with the CMS; this will only be thrown if the driver implementation choses to use deferred data loading (for performance reason).

1.1.23.17 setBinaryContent

public void setBinaryContent(java.lang.String mimeType, java.io.InputStream inputStream, long length)

throws AuthorizationException, ConnectionException, MissingResourceException, java.io.IOException, java.lang.IllegalStateException

Sets the binary content stored in the Item. The binary content can be set to null. Note: unlike most set methods, the implementation of this method will immediatly send the data to the repository. Therefore, the Item must be locked for editing before a call to this method is made. After the method returns, the lock on the item is released and must be obtained again.

Parameters:

mimeType—the MIME type of this binary content

inputstream—the InputStream that contains the data of the Item

length—the length of the content

Throws:

AuthorizationException—if the current user does not have permission to perform this operation

ConnectionException—if there is a problem interacting with the CMS; this will only be thrown if the driver implementation choses to use deferred data loading (for performance reason).

java.io.IOException—if an error occurs while accessing the InputStream

java.lang.IllegalStateException—if this Item was not locked for editing when retrieved.

MissingResourceException—if the item does not exist

1.1.23.18 setBinaryContent

public void setBinaryContent(java.lang.String mimeType, java.io.InputStream inputstream, byte[] termination)

throws AuthorizationException, ConnectionException, MissingResourceException, java.io.IOException, java.lang.IllegalStateException

Sets the binary content stored in the Item. The binary content can be set to null. Authorization required: Action.UPDATE on the item Note: unlike most set methods, the implementation of this method will immediatly send the data to the repository. Therefore, the Item must be locked for editing before a call to this method is made. After the method returns, the lock on the item is released.

Parameters:

mimeType—the MIME type of this binary content

inputstream—the Inputstream that contains the data of the Item

termination—the termination pattern

Throws:

AuthorizationException—if the current user does not have permission to perform this operation

ConnectionException—if there is a problem interacting with the CMS; this will only be thrown if the driver implementation choses to use deferred data loading (for performance reason).

java.io.IOException—if an error occurs while accessing the InputStream

java.lang.IllegalStateException—if this Item was not locked for editing when retrieved.

MissingResourceException—if the item does not exist

1.1.23.19 signoff ( )

public void signoff ( )

throws AuthorizationException, ConnectionException, java.lang.IllegalStateException, MissingResourceException

Signs off the Item to the next publication status.

Throws:

AuthorizationException—if the current user does not have permission to perform this operation

ConnectionException—if there is a problem interacting with the CMS; this will only be thrown if the driver implementation choses to use deferred data loading (for performance reason).

java.lang.IllegalStateException—if this Item is in it's final publication status

MissingResourceException—if the status does not exist

1.1.23.20 signoff

public void signoff(java.lang.string message)

throws AuthorizationException, ConnectionException, java.lang.IllegalStateException, MissingResourceException

Signs off the Item to the next publication status, with a message.

Parameters:

message—a note to associate with the signing off

Throws:

AuthorizationException—if the current user does not have permission to perform this operation

ConnectionException—if there is a problem interacting with the CMS; this will only be thrown if the driver implementation choses to use deferred data loading (for performance reason).

java.lang.IllegalStateException—if this Item is in it's final publication status

MissingResourceException—if the status does not exist

1.1.23.21 reject

public void rejects ( )

throws AuthorizationException, ConnectionException, java.lang.IllegalStateException, MissingResourceException

Rejects the Item to the previous publication status.

Throws:

AuthorizationException—if the current user does not have permission to perform this operation

ConnectionException—if there is a problem interacting with the CMS; this will only be thrown if the driver implementation choses to use deferred data loading (for performance reason).

java.lang.IllegalStateException—if this Item is in it's final publication status

MissingResourceException—if the status does not exist

1.1.23.22 reject

public void reject(java.lang.String message)

throws AuthorizationException, ConnectionException, java.lang.IllegalStateException, MissingResourceException

Rejects the Item to the previous publication status, with a message.

Parameters:

message—a note to associate with the signing off

Throws:

AuthorizationException—if the current user does not have permission to perform this operation

ConnectionException—if there is a problem interacting with the CMS; this will only be thrown if the driver implementation choses to use deferred data loading (for performance reason).

java.lang.IllegalStateException—if this Item is in it's final publication status

MissingResourceException—if the status does not exist

1.1.23.23 addRelateditem

public void addRelatedItem(RelationType relationType, Item relateditem, java.util.Map parameters)

throws AuthorizationException, ConnectionException, java.lang.IllegalStateException

Links an Item to this one, using the given RelationType to define the link itself. The relation type works like this: if you want to add a parent Item to this Item, you would callthefollowing: this.addRelatedItem(RelationType.PARENT, parentItem);.

Parameters:

relationType—the RelationType that characterizes the link between this Item and the other.

relateditem—the Item to link to this Item

parameters—any parameters to apply to the relationship

Throws:

AuthorizationException—if the current user does not have permission to perform this operation

ConnectionException—if there is a problem interacting with the CMS; this will only be thrown if the driver implementation choses to use deferred data loading (for performance reason).

java. lang. IllegalStateException—if the specified RelationType already defines

a unique linked Item; or if trying to save an Item that was not locked for editing when retrieved.

1.1.23.24 getRelateditems

public java.util.Set getRelateditems(RelationType relationType)

throws AuthorizationException, ConnectionException

Returns a Set of Items related to this Item by the given RelationType. The Set may be empty, but never null.

Parameters:

relationType—the RelationType that characterizes the link between this Item and the others.

Returns:

Set of Items related to this one by the given RelationType

Throws:

AuthorizationException—if the current user does not have permission to perform this operation

ConnectionException—if there is a problem interacting with the CMS; this will only be thrown if the driver implementation choses to use deferred data loading (for performance reason).

1.1.23.25 getRelateditems

public java.util.Set getRelatedItems(ItemType itemType)

throws AuthorizationException, ConnectionException

Returns a Set of Items related to this Item and that all share the same ItemType. The Set may be empty, but never null.

Parameters:

itemType—the ItemType shared by all the related Items in the returned Set.

Returns:

Set of ItemS related to this one and that al share the given ItemType

Throws:

AuthorizationException—if the current user does not have permission to perform this operation

ConnectionException—if there is a problem interacting with the CMS; this will only be thrown if the driver implementation choses to use deferred data loading (for performance reason).

1.1.23.26 getRelateditems

public java.util.Set getRelatedItems(RelationType relationType, ItemType itemType)

throws AuthorizationException, ConnectionException

Returns a Set of Items related to this Item by the given RelationType and that all share the same ItemType. The Set maybe empty, but never null.

Parameters:

relationType—the RelationType that characterizes the link between this Item and the others.

itemType—the ItemType shared by all the related Items in the returned Set.

Returns:

Set of Items related to this one and that al share the given ItemType

Throws:

AuthorizationException—if the current user does not have permission to perform tnis operation

ConnectionException—if there is a problem interacting with the CMS; this will only be thrown if the driver implementation choses to use deferred data loading (for performance reason).

1.1.23.27 getRelationType

public java.util.Set getRelationType(Item relateditem)

throws AuthorizationException, ConnectionException

Returns the Set of RelationTypes that exist between this Item and the specified Item.

The returned Set may be empty (no relation between the two), but never null.

Parameters:

relateditem—the Item that may be related to this one by one or more RelationTypeS

Returns:

Set of RelationType defined between this Item and the specified Item

Throws:

AuthorizationException—if the current user does not have permission to perform this operation

ConnectionException—if there is a problem interacting with the CMS; this will only be thrown if the driver implementation choses to use deferred data loading (for performance reason).

1.1.23.28 removeRelateditem

public void removeRelatedItem(RelationType relationType, Item relateditem)

throws AuthorizationException, ConnectionException, java.lang.IllegalStateException

Removes the link between the given Item and this one, the link being defined by the given RelationType. The relation type works like this: if you want to remove a child Item from this Item, you would call the following:

this.removeRelatedItem(RelationType.CHILD, childItem);.

Parameters:

relationType—the RelationType that characterizes the link between this Item and the other.

relateditem—the Item to unlink from this Item

Throws:

AuthorizationException—if the current user does not have permission to perform this operation ConnectionException—if there is a problem interacting with the CMS; this will only be thrown if the driver implementation choses to use deferred data loading (for performance reason).

java.lang. IllegalStateException—if this Item was not locked for editing when retrieved.

1.1.23.29 getRelationTypes

public java.util.Set getRelationTypes ( )

throws AuthorizationException, ConnectionException, java.lang.IllegalStateException

Provides the RelationTypeS that this object is participating in.

Returns:

a Set of relation types that this item is in

Throws:

AuthorizationException—if the current user does not have permission to perform this operation

ConnectionException—if there is a problem interacting with the CMS; this will only be thrown if the driver implementation choses to use deferred data loading (for performance reason).

java.lang.IllegalStateException—if this Item was not locked for editing when retrieved.

1.1.23.30 isLocked

public boolean isLocked ( )

throws AuthorizationException, ConnectionException

Returns true if this Item is locked for editing; false otherwise.

Returns:

true if this Item is locked for editing; false otherwise.

Throws:

AuthorizationException—if the current user does not have permission to perform this operation

ConnectionException—if there is a problem interacting with the CMS; this will only be thrown if the driver implementation choses to use deferred data loading (for performance reason).

1.1.23.31 getSignOffDate

public java.util.Date getSignOffDate ( )

throws AuthorizationException, ConnectionException

Returns the DateItem to which this PublicationStatus was assigned can be signed off automatically. This only applies to a PublicationStatus that has been set to #SIGN_OFF_AUTOMATICALLY_AT.

Returns:

the Date to reach before the Item to which this PublicationStatus was assigned can be signed off automatically

Throws:

AuthorizationException—if the current user does not have permission to perform this operation

ConnectionException—if there is a problem interacting with the CMS; this will only be thrown if the driver implementation choses to use deferred data loading (for performance reason).

1.1.23.32 setSignOffDate

public void setsignoftDate(java.util.Date date)

throws AuthorizationException, ConnectionException

Sets the DateItem to which this PublicationStatus was assigned can be signed off automatically. This only applies to a PublicationStatus that has been set to #SIGN_OFF_AUTOMATICALLY-AT.

Parameters:

date—the Date to reach before the Item to which this PublicationStatus was assigned can be signed off automatically

Throws:

AuthorizationException—if the current user does not have permission to perform this operation

ConnectionException—if there is a problem interacting with the CMS; this will only be thrown if the driver implementation choses to use deferred data loading (for performance reason).

1.1.23.33 addThesaurusTerm

public void addThesaurusTerm(int level, java.lang.String term)

throws AuthorizationException, ConnectionException

Indexes the item in a thesaurus.

Parameters:

level—the level, I for primary term, 2 for secondary term, etc.

term—the term The thesaurus term to index the item with. Must be part of the thesaurus

Throws:

AuthorizationException—if the current user does not have permission to perform this operation

ConnectionException—if there is a problem interacting with the CMS; this will only be thrown if the driver implementation choses to use deferred data loading (for performance reason).

1.1.23.34 removeThesaurusTerm

public void removeThesaurusTerm(java.lang.String term)

throws AuthorizationException, ConnectionException

Removes a thesaurus term from the indexation of the item

Parameters:

term—the term The thesaurus term to index the item with. Must be part of the thesaurus

Throws:

AuthorizationException—if the current user does not have permission to perform this operation

ConnectionException—if there is a problem interacting with the CMS; this will only be thrown if the driver implementation choses to use deferred data loading (for performance reason).

1.1.23.35 removeAllThesaurusTerms

public void removeAllThesaurusTerms ( )

throws AuthorizationException, ConnectionException

Removes all thesaurus terms from the indexation of the item

Throws:

AuthorizationException—if the current user does not have permission to perform this operation

ConnectionException—if there is a problem interacting with the CMS; this will only be thrown if the driver implementation choses to use deferred data loading (for performance reason).

1.1.23.36 getThesaurusTerms

public com.conceptis.util.Tree getThesaurusTerms ( )

throws AuthorizationException, ConnectionException

Get the thesaurus terms associated to the item. Item at the first level are primary terms, at the second level are secondary term and so on.

Returns:

com.conceptis.util.Tree the tree of thesaurus term associated with the item

Throws:

AuthorizationException—if the current user does not have permission to perform this operation

ConnectionException—if there is a problem interacting with the CMS; this will only be thrown if the driver implementation choses to use deferred data loading (for performance reason).

1.1.23.37 setDefaultLocale

public void setDefaultLocale(java.util.Locale locale)

throws ConnectionException, AuthorizationException

Set the item's default Locale. An Item cannot be saved unless the localized value for the default Locale is completed. (Other supported Locales pose no such restrictions) This information is persisted in the item using XML.

Parameters:

locale—The Locale that this object *must* support in order to be persisted in the CMS. May be null (in which case no locale is required).

Throws:

ConnectionException—if there is a problem interacting with the CMS

AuthorizationException—if the current user does not have permission to perform this operation

1.1.23.38 getDefaultLocale

public java.util.Locale getDefaultLocale ( )

throws ConnectionException, AuthorizationException

Provides the item's default Locale. An Item cannot be saved unless the localized value for the default Locale is completed. (Other supported Locales pose no such restrictions) This information is persisted in the item using.

Returns:

the default locale

Throws:

ConnectionException—if there is a problem interacting with the CMS

AuthorizationException—if the current user does not have permission to perform this operation

1.1.23.39 getLocalizedValue

public java.lang.String getLocalizedValue(java.util.Locale locale)

throws ConnectionException, AuthorizationException, java.lang.IllegalArgumentException

Returns the value for the specified Locale. If is not part of the item's supported Locales, an IllegalArgumentException is thrown.

Parameters:

locale—The Locale for the accompanying value.

Returns:

The String of the localized value.

Throws:

ConnectionException—if there is a problem interacting with the CMS

AuthorizationException—if the current user does not have permission to perform this operation

java.lang.IllegalArgumentException—if the specified Locale is not supported by this item.

1.1.23.40 setLocalizedValue

public void setLocalizedValue(java.util.Locale locale, java.lang.String value)

throws ConnectionExceptionAuthorizationException, java.lang.IllegalArgumentException

Set the localized value for the specified Locale.

Parameters:

locale—The Locale for the accompanying value.

value—The String of the localized value.

Throws:

ConnectionException—if there is a problem interacting with the CMS

AuthorizationException—if the current user does not have permission to perform this operation

java. lang. IllegalArgumentException—if the specified Locale is not supported by this item.

1.1.23.41 addSupportedLocale public void addSupportedLocale(java.util.Locale locale)

throws ConnectionException, AuthorizationException, java.lang.IllegalStateException

Mark the snerifpid TLoale as supported for this item. (This information is stored in the xmlLocaleString field). Having no values for these locales will *not* prevent the item from being saved to the CMS, however business logic *IS* expected to prevent the items from having their publishing states set anything that may be viewable!!!

Parameters:

locale—The Locale to support.

Throws:

ConnectionException—if there is a problem interacting with the CMS

AuthorizationException—if the current user does not have permission to perform this operation

java. lang. IllegalstateException—if the specified Locale is already listed as being supported. (either as a default *or* supported locale)

1.1.23.42 removeSupportedLocale

public void removesupportedLocale(java.util.Locale locale)

throws ConnectionException, AuthorizationException, java.lang.IllegalStateException

Unmark the Locale as being supported for this item. (This information is stored in the xmlLocaleString field). Localized values already set will not be deleted, however, they will no longer be visible/editable unless the Locale is once again marked as being supported.

Parameters:

locale—The Locale to no longer support.

Throws:

ConnectionException—if there is a problem interacting with the CMS

AuthorizationException—if the current user does not have permission to perform this operation

java. lang. IllegalStateException—if the specified Locale is not listed as being supported. (either as a default *or* supported locale)

1.1.23.43 getSupportedLocales

public java.util.List getSupportedLocales ( )

throws ConnectionException, AuthorizationException, java.lang.IllegalStateException

Provides the Locales supported for this item. (This information is stored in the xmlLocaleString field).

Returns:

a list of Locale objects

Throws:

ConnectionException—if there is a problem interacting with the CMS

AuthorizationException—if the current user does not have permission to perform this operation

java.lang.IllegalStateException—if the specified Locale is not listed as being supported. (either as a default *or* supported locale)

1.1.23.44 getLastModifiedDate

public java.util.Date getLastModifiedDate ( )

throws ConnectionException, AuthorizationExceptionProvides the last modified date.

Returns:

the date the item was last modified.

Throws:

ConnectionException—if there is a problem interacting with the CMS

AuthorizationException—if the current user does not have permission to perform this operation

1.1.23.45 getindexValues

public java.util.Set getIndexValues(Index index)

throws AuthorizationException, ConnectionException

Provides the index values set on the item.

Parameters:

index—the index

Returns:

the values on the index

Throws:

ConnectionException—if there is a problem interacting with the CMS

AuthorizationException—if the current user does not have permission to perform this operation

1.1.23.46 addIndexValue

public boolean addIndexvalue(Indexindex, java.lang.String value)

throws AuthorizationException, ConnectionException

Adds an index value.

Parameters:

index—the index

value—the value of the index

Returns:

true if the set of index values changed as a result of this operation

Throws:

ConnectionException—if there is a problem interacting with the CMS

AuthorizationException—if the current user does not have permission to perform this operation

1.1.23.47 removeIndexValue

public boolean removeIndexValue(Indexindex, java.lang.String value)

throws AuthorizationException, ConnectionException

Removes and index value.

Parameters:

index—the index

value—the value of the index

Returns:

true if the set of index values changed as a result of this operation

Throws:

ConnectionException—if there is a problem interacting with the CMS

AuthorizationException—if the current user does not have permnission to perform this operation

1.1.23.48 getIndices

public java.util.Set getIndices ( )

throws ConnectionException, AuthorizationException, MissingResourceException

Provides the indices available for this item.

Returns:

the indices available for a branch (a set of Index objects); may be empty but not null

Throws:

ConnectionException—if there is a problem interacting with the CMS

AuthorizationException—if the current user does not have permission to perform this operation

MissingResourceException—if the user specified by the key does not exist

### 1.1.24 INTERFACE ITEMFACTORY

public interface ItemFactory

Interacts with the CMS to provide access to items of the CMS.

Method Summary

| | |
|---|---|
| void | addRootItem(Item root) |
| | Sets the root Item of the site. |
| Item | createNewItem(ItemType itemType) |
| | Creates a new Item instance, uninitialized, not |
| | stored in the CMS. |
| void | deleteItem(Item item) |
| | Deletes this Item. |
| Item | getItem(com.conceptis.util.PrimaryKey key, |
| | boolean lockForEditing) |
| | Provides the Item with the specified key. |
| Item | getItem(java.lang.String identifier, |
| | boolean lockForEditing) |
| | Provides the Item with the specified identifier. |
| Item | getItem(java.net.URL identifier, |
| | boolean lockForEditing) |
| | Provides the Item with the specified URL. |
| java.util.Set | getItems( ) |
| | Provides the set of all ItemS. |
| java.util.Set | getItems(ItemType itemType) |
| | Returns a Set of Item that all share the same |
| | ItemType. |
| java.util.Set | getItems(ItemType itemType, Item top) |
| | Returns a set of Item that all share the same |
| | ItemType and are under the same Item. |
| java.util.Set | getRootItems( ) |
| | Provides the root ItemS of the site. |
| void | lockItem(Item item) |
| | Unlocks the specified Item without saving any |
| | changes, therefore making it available for editing to |
| | someone else. |
| void | removeRootItem(Item root) |
| | Sets the root Item of the site. |
| void | saveItem(Item item) |
| | Saves the specified Item. |
| com.conceptis.util.PagedList | search(ItemSearchConstraints constraints) |
| | Searches for ItemS matching the constraints. |
| java.util.Set | searchForItem(ItemSearchConstraints constraints) |
| | Deprecated. use |
| | search(com.conceptis.cms.ItemSearchConstraints), |
| | which returns a paged list |
| void | unlockItem(Item item) |
| | Unlocks the specified Item without saving any |
| | changes, therefore making it available for editing to |
| | someone else. |

### Method Detail

1.1.24.1 getItems

public java.util.Set getitems ( )

throws ConnectionException, AuthorizationException

Provides the set of all ItemS.

Returns:

the set of all ItemS (may be empty but never null)

Throws:

ConnectionException—if there is a problem interacting with the CMS

AuthorizationException—if the current user does not have permission to perform this operation

1.1.24.2 getItem

public ItemgetItem(com.conceptis.util.PrimaryKey key, boolean lockForEditing)

throws ConnectionException, AuthorizationException, java.lang.IllegalStateException, MissingResourceException

Provides the Item with the specified key.

Parameters:

key—the primary key of the Item

lockForEditing—set to true to retrieve this Item in edition mode, allowing the changes made to it to be saved; set to false to get this Item in a read-only mode.

Returns:

the Item with the specified key

Throws:

ConnectionException—if there is a problem interacting with the CMS

AuthorizationException—if the current user does not have permission to perform this operation

java.lang.IllegalStateException—if the Item is already locked for editing by another party

MissingResourceException—if the Item specified by the key does not exist

1.1.24.3 getItems

public java.util.Set getItems(ItemType itemType, Item top)

throws ConnectionException, AuthorizationException

Returns a Set of Item that all share the same ItemType and are under the same Item.

Parameters:

itemType—the ItemType shared by all returned Items

top—the Item that represents the branch to search under.

Returns:

a Set of Item that all share the same ItemType.

Throws:

ConnectionException—if there is a problem interacting with the CMS

AuthorizationException—if the current user does not have permission to perform this operation

1.1.24.4 getItem

public Item getItem(java.lang.String identifier, boolean lockForEditing)

throws ConnectionException, AuthorizationException, java.lang.IllegalStateException, MissingResourceException

Provides the Item with the specified identifier.

Parameters:

identifier—a string that uniquely identifies the desired resource

lockForEditing—set to true to retrieve this Item in edition mode, allowing the changes made to it to be saved; set to false to get this Item in a read-only mode.

Returns:

the Item with the specified identifier

Throws:

ConnectionException—if there is a problem interacting with the CMS

AuthorizationException—if the current user does not have permission to perform this operation

java.lang.IllegalStateException—if the Item is already locked for editing by another party

MissingResourceException—if the Item specified by the key does not exist

1.1.24.5 getItem

public Item getItem(java.net.URL identifier, boolean lockForEditing)

throws ConnectionException, AuthorizationException, java.lang.IllegalStateException, MissingResourceException

Provides the Item with the specified URL.

Parameters:

identifier—a string that uniquely identifies the desired resource lockForEditing—set to true to retrieve this Item in edition mode, allowing the changes made to it to be saved; set to false to get this Item in a read-only mode.

Returns:

the Item with the specified identifier

Throws:

ConnectionException—if there is a problem interacting with the CMS AuthorizationException—if the current user does not have permission to performn this operation

java.lang.IllegalStateException- if the Item is already locked for editing by another party

MissingResourceException—if the Item specified by the key does not exist

1.1.24.6 getRootItems

public java.util.Set getRootItems ( )

throws ConnectionException, AuthorizationException, MissingResourceException

Provides the root ItemS of the site.

Returns:

the root Items of the site

Throws:

ConnectionException—if there is a problem interacting with the CMS

AuthorizationException—if the current user does not have permission to perform this operation

MissingResourceException—if the Items do not exist

1.1.24.7 addRootitem

public void addRootitem(Item root)

throws ConnectionException, AuthorizationException, MissingResourceException

Sets the root Item of the site.

Parameters:

root—the root Item of the site

Throws:

ConnectionException—if there is a problem interacting with the CMS

AuthorizationException—if the current user does not have permission to perform this operation

MissingResourceException—if the Item specified by the key does not exist

1.1.24.8 removeRootitem

public void removeRootItem(Item root)

throws ConnectionException, AuthorizationException, MissingResourceException

Sets the root Item of the site.

Parameters:

root—the root Item of the site

Throws:

ConnectionException—if there is a problem interacting with the CMS

AuthorizationException—if the current user does not have permission to perform this operation

MissingResourceException—if the Item specified by the key does not exist

1.1.24.9 getItems

public java.util.Set getItems(ItemType itemType)

throws ConnectionException, AuthorizationException

Returns a Set of Item that all share the same ItemType.

Parameters:

itemType—the ItemType shared by all returned ItemS

Returns:

a Set of Item that all share the same ItemType.

Throws:

ConnectionException—if there is a problem interacting with the CMS

AuthorizationException—if the current user does not have permission to perform this operation

1.1.24.10 createNewitem

public Item createNewItem(ItemType itemType)

Creates a new Item instance, uninitialized, not stored in the CMS. Once correctly initialized, this instance may then be inserted in the CMS using the saveItem(com.conceptis.cms.Item) method.

Parameters:

itemType—the ItemType of the newly created Item

Returns:

an unitialized Item of the specified ItemType

1.1.24.11 saveItem

public void saveItem(Item item)

throws ConnectionException, AuthorizationException, MissingResourceException, java.lang.IllegalStateException

Saves the specified Item. This will change the Item's entry in the CMS to reflect the state of the item parameter. If the given Item did not exist before, it will be inserted, otherwise it will simply be updated. If the Item was locked for editing, it will be unlocked.

Parameters:

item—the Item to insert/update

Throws:

ConnectionException—if there is a problem interacting with the CMS

AuthorizationException—if the current user does not have permission to perform this operation

MissingResourceException—if a previously existing Item does not exist any longer java.lang.IllegalStateException—if trying to save an Item that was not locked for editing when retrieved.

1.1.24.12 unlockItem

public void unlockItem(Item item)

throws ConnectionException, AuthorizationException, MissingResourceException

Unlocks the specified Item without saving any changes, therefore making it available for editing to someone else. If the Item was not locked, this method will simply do nothing.

Parameters:

item—the Item to unlock

Throws:

ConnectionException—if there is a problem interacting with the CMS

AuthorizationException—if the current user does not have permission to perform this operation

MissingResourceException—if a previously existing Item does not exist any longer

11.1.24.13 lockItem

public void lockItem(Item item)

throws ConnectionException, AuthorizationException, MissingResourceException

Unlocks the specified Item without saving any changes, therefore making it available for editing to someone else. If the Item was not locked, this method will simply do nothing. Authorization required: none

Parameters:

item—the Item to unlock

Throws:

ConnectionException—if there is a problem interacting with the CMS

AuthorizationException—if the current user does not have permission to perform this operation

MissingResourceException—if a previously existing Item does not exist any longer

1.1.24.14 deleteItem

public void deleteItem(Item item)

throws ConnectionException, AuthorizationException, MissingResourceException

Deletes this Item. This may have unintended consequences. Note that some implementations may throw an UnsupportedoperationException if the deletion of Items is not possible.

Parameters:

item—the Item to delete

Throws:

ConnectionException—if there is a problem interacting with the CMS

AuthorizationException—if the current user does not have permission to perform this operation

MissingResourceException—if the Item does not exist any longer

1.1.24.15 searchForItem

public java.util.Set searchForitem(ItemSearchConstraints constraints)

throws ConnectionException, AuthorizationException

Deprecated. use search(com.conceptis.cms.ItemSearchConstraints), which returns a paged list

Searches for Items matching the constraints.

Parameters:

constraints—the constraints of the search

Returns:

a set of items matching the constraints

Throws:

ConnectionException—if there is a problem interacting with the CMS

AuthorizationException—if the current user does not have permission to perform this operation

1.1.24.16 search

public com.conceptis.util.PagedList search(ItemSearchConstraints constraints)

throws ConnectionException, AuthorizationException, MissingResourceException

Searches for Items matching the constraints.

Parameters:

constraints—the constraints of the search

Returns:

a set of items matching the constraints

Throws:

ConnectionException—if there is a problem interacting with the CMS

AuthorizationException—if the current user does not have permission to perform this operation

MissingResourceException—if the search could not be performed

### 1.1.25 INTERFACE ITEMTYPE

All Superinterfaces:

ObjectWithPrimaryKey

public interface ItemType

extends ObjectWithPrimaryKey

An ItemType defines a family of Items that all share the same constraints, Fields, PublishingFlow, etc.

Method Summary

| | |
|---|---|
| void | addField(Field field) |
| | Adds a Field in this ItemType. |
| void | addField(int index, Field field) |
| | Adds a Field in this ItemType. |
| void | addRelatedItemType(RelationType relationType, |
| | ItemType itemType) |
| | Links an ItemType to this one, using the given RelationType to |
| | define the link itself. |
| java.util.Set | getChildren( ) |
| | Provides the children types of this type. |
| Collection | getCollection( ) |
| | Provides the Collection that this ItemType belongs to. |
| Field | getField(int index) |
| | Returns the Field identified by the provided index. |
| Field | getField(java.lang.String name) |
| | Returns the Field identified by the given name. |
| java.util.List | getFields( ) |
| | Returns a List of Fields defined in this ItemType. |
| java.util.Set | getItems( ) |
| | Returns all the Items that share this ItemType. |
| int | getMaximumVersions( ) |
| | Provides the number of versions that should be maintained for this |
| | ItemType. |
| java.lang.String | getName( ) |
| | Returns the name of this ItemType. |
| ItemType | getParent( ) |
| | Provides the parent type of this type. |
| PublishingFlow | getPublishingFlow( ) |
| | Returns the PublishingFlow assigned to this ItemType. |
| java.util.Set | getRelatedItemTypes(RelationType relationType) |
| | Returns a Set of ItemTypeS related to this ItemType by the given |
| | RelationType. |
| boolean | isBinary( ) |
| | Indicates whether this resource type contains binary content. |
| void | removeField(int index) |
| | Removes the Field at the specified index. |
| void | removeField(java.lang.String name) |
| | Removes the Field at the specified index. |
| void | removeRelatedItemType(RelationType relationType, Item item) |
| | Removes the link between the given ItemType and this one, the |
| | link being defined by the given RelationType. |
| void | setCollection (Collection collection) |
| | Sets the Collection that this type is defined in. |
| void | setName(java.lang.String name) |
| | Sets the name of this ItemType. |
| void | setPublishingFlow(PublishingFlow publishingFlow) |
| | Sets the PublishingFlow of this ItemType. |
| boolean | supportsExtendedRelationships( ) |
| | Indicates whether this type supports extended relationships. |
| boolean | supportsLocalizedString( ) |
| | Indicates whether this type supports a localized string. |

Methods in herited from interface com.conceptis.cms.0bjectWithPrimaryKey

getPrimaryKey

### Method Detail

1.1.25.1 setName

public void setName(java.lang.String name)

throws AuthorizationException, ConnectionException

Sets the name of this ItemType.

Parameters:

name—the name of this ItemType

Throws:

AuthorizationException—if the current user does not have permission to perform this operation ConnectionException—if there is a problem interacting with the CMS; this will only be thrown,; if the driver ilpcmcnttion choses to use ueferred data loading (for performance reason).

1.1.25.2 getName

public java.lang.String getName ( )

throws AuthorizationException, ConnectionException

Returns the name of this ItemType.

Returns:

the name of this ItemType

Throws:

AuthorizationException—if the current user does not have permission to perform this operation

ConnectionException—if there is a problem interacting with the CMS; this will only be thrown if the driver implementation choses to use deferred data loading (for performance reason).

1.1.25.3 addField

public void addField(Field field)

throws AuthorizationException, ConnectionException

Adds a Field in this ItemType. The field is placed at the end of the list.

Parameters:

field—the Field to set

Throws:

AuthorizationException—if the current user does not have permission to perform this operation

ConnectionException—if there is a problem interacting with the CMS; this will only be thrown if the driver implementation choses to use deferred data loading (for performance reason).

1.1.25.4 addField

public void addField(int index, Field field)

throws AuthorizationException, ConnectionException, java.lang.IndexoutOfBoundsException

Adds a Field in this ItemType. The index can be specified.

Parameters:

index—the index of the Field field—the Field to set

Throws:

AuthorizationException—if the current user does not have permission to perform this operation

ConnectionException—if there is a problem interacting with the CMS; this will only be thrown if the driver implementation choses to use deferred data loading (for performance reason).

java.lang.IndexOutOfBoundsException—if the index is negative or larger then the current field count

1.1.25.5 getField

public Field getField(java.lang.string name)

throws AuthorizationException, ConnectionException

Returns the Field identified by the given name.

Parameters:

name—the name of the field

Returns:

the Field that fits the specified name, null if it is not a field of this type

Throws:

AuthorizationException—if the current user does not have permission to perform this operation

ConnectionException—if there is a problem interacting with the CMS; this will only be thrown if the driver implementation choses to use deferred data loading (for performance reason).

1.1.25.6 getField

public Field getfield(int index)

throws AuthorizationException, ConnectionException, java.lang.IndexoutofBoundsException

Returns the Field identified by the provided index.

Parameters:

index—the index of the field

Returns:

the Field that fits the specified name

Throws:

AuthorizationException—if the current user does not have permission to perform this operation

ConnectionException—if there is a problem interacting with the CMS; this will only be thrown if the driver implementation choses to use deferred data loading (for performance reason).

java.lang.IndexOutOfBoundsException—if the index is invalid

1.1.25.7 removeField

public void removeField(java.lang.String name)

throws AuthorizationException, ConnectionException

Removes the Field at the specified index.

Parameters:

name—the name of the field

Throws:

AuthorizationException—if the current user does not have permission to perform this operation

ConnectionException—if there is a problem interacting with the CMS; this will only be thrown if the driver implementation choses to use deferred data loading (for performance reason).

1.1.25.8 removeField

public void removefield(int index)

throws AuthorizationException, ConnectionException, java.lang.IndexoutofBoundsException

Removes the Field at the specified index.

Parameters:

index—the index of the field

Throws:

AuthorizationException—if the current user does not have permission to perform this operation

ConnectionException—if there is a problem interacting with the CMS; this will only be thrown if the driver implementation choses to use deferred data loading (for performance reason).

java.lang.IndexoutofBoundsException—if the index is invalid

1.1.25.9 getFields

public java.util.List getFields ( )

throws AuthorizationException, ConnectionException

Returns a List of Fields defined in this ItemType.

Returns:

a List of Fields defined in this ItemType, in no particular order

Throws:

AuthorizationException—if the current user does not have permission to perform this operation

ConnectionException—if there is a problem interacting with the CMS; this will only be thrown if the driver implementation choses to use deferred data loading (for performance reason).

1.1.25.10 setPublishingFlow

public void setPublishingFlow(PublishingFlow publishingFlow)

throws AuthorizationException, ConnectionException

Sets the PublishingFlow of this ItemType.

Parameters:

publishingFlow—PublishingFlow to assign to this ItemType

Throws:

AuthorizationException—if the current user does not have permission to perform this operation

ConnectionException—if there is a problem interacting with the CMS; this will only be thrown if the driver implementation choses to use deferred data loading (for performance reason).

1.1.25.11 getPublishingFlow

public PublishingFlow getPublishingFlow ( )

throws AuthorizationException, ConnectionException, MissingResourceException

Returns the PublishingFlow assigned to this ItemType.

Returns:

the PublishingFlow assigned to this ItemType

Throws:

AuthorizationException—if the current user does not have permission to perform this operation

ConnectionException—if there is a problem interacting with the CMS; this will only be thrown if the driver implementation choses to use deferred data loading (for performance reason).

MissingResourceException—if the flow does not exist

1.1.25.12 getcollection

public Collection getCollection ( )

throws AuthorizationException, ConnectionException, MissingResourceException

Provides the Collection that this ItemType belongs to. It is possible that this value is null, since a type is not required to be in a collection.

Returns:

the collection the type is in, or null if it is not in a collection

Throws:

AuthorizationException—if the current user does not have permission to perform this operation

ConnectionException—if there is a problem interacting with the CMS; this will only be thrown if the driver implementation choses to use deferred data loading (for performance reason).

MissingResourceException—if the collection does not exist

1.1.25.13 setCollecbon

public void setCollection(Collection collection)

throws AuthorizationException, ConnectionException

Sets the Collection that this type is defined in. It is acceptable to pass null into this method, since a type is not required to be in a collection.

Parameters:

collection—the collection that the type is in, pass null to remove the type

Throws:

AuthorizationException—if the current user does not have permission to perform this operation

ConnectionException—if there is a problem interacting with the CMS; this will only be thrown if the driver implementation choses to use deferred data loading (for performance reason).

1.1.25.14 getparent

public ItemType getparent ( )

throws AuthorizationException, ConnectionException, MissingResourceException

Provides the parent type of this type.

Returns:

the parent type of this type

Throws:

AuthorizationException—if the current user does not have permission to perform this operation

ConnectionException—if there is a problem interacting with the CMS; this will only be thrown if the driver implementation choses to use deferred data loading (for performance reason).

MissingResourceException—if the parent does not exist

1.1.25.15 getchildren

public java.util.Set getChildren ( )

throws AuthorizationException, ConnectionException, MissingResourceException

Provides the children types of this type.

Returns:

the children types of this type

Throws:

AuthorizationException—if the current user does not have permission to perform this operation

ConnectionException—if there is a problem interacting with the CMS; this will only be thrown if the driver implementation choses to use deferred data loading (for performance reason).

MissingResourceException—if the parent does not exist

1.1.25.16 getMaximumVersions

public int getMaximumVersions ( )

throws AuthorizationException, ConnectionException

Provides the number of versions that should be maintained for this ItemType.

Returns:

the number of versions to maintained for this type

Throws:

AuthorizationException—if the current user does not have permission to perform this operation

ConnectionException—if there is a problem interacting with the CMS; this will only be thrown if the driver implementation choses to use deferred data loading (for performance reason).

1.1.25.17 isBinary

public boolean isBinary ( )

throws AuthorizationException, ConnectionException

Indicates whether this resource type contains binary content.

Returns:

true if the Item contains binary content, false otherwise

Throws:

AuthorizationException—if the current user does not have permission to perform this operation

ConnectionException—if there is a problem interacting with the CMS; this will only be thrown if the driver implementation choses to use deferred data loading (for performance reason).

1.1.25.18 getItems

public java.util.Set getItems ( )

throws AuthorizationException, ConnectionException, MissingResourceException

Returns all the Items that share this ItemType.

Returns:

a Set of Items that all share this ItemType

Throws:

AuthorizationException—if the current user does not have permission to perform this operation

ConnectionException—if there is a problem interacting with the CMS

MissingResourceException—if an item is missing

1.1.25.19 addRelatedItemType

public void addRelatedItemType(RelationType relationType, ItemTypeitemType)

throws AuthorizationException, ConnectionException, java.lang.IllegalStateException

Links an ItemType to this one, using the given RelationType to define the link itself The relation type works like this: if you want to define an image type for a news type, you would call something similar to the following line of code:

this.addRelatedItemType(“news.image”, imageType);.

Parameters:

relationType—the RelationType that characterizes the link between this ItemType and the other. itemType—the ItemType to link to this ItemType

Throws:

AuthorizationException—if the current user does not have permission to perform this operation

ConnectionException—if there is a problem interacting with the CMS; this will only be thrown if the driver implementation choses to use deferred data loading (for performance reason).

java.lang.IllegalStateException—if the specified RelationType already defines a unique linked ItemType

1.1.25.20 getRelateditemTypes

public java.util.Set getRelatedItemTypes(RelationType relationType)

throws AuthorizationException, ConnectionException

Returns a Set of ItemTypes related to this ItemType by the given RelationType. The Set may be empty, but never null.

Parameters:

relationType—the RelationType that characterizes the link between this ItemType and the others.

Returns:

Set of ItemTypes related to this one by the given RelationType

Throws:

AuthorizationException—if the current user does not have permission to perform this operation

ConnectionException—if there is a problem interacting with the CMS; this will only be thrown if the driver implementation choses to use deferred data loading (for performance reason).

1.1.25.21 removeRelatedItemType

public void removeRelatedItemType(RelationType relationType, Item item)

throws AuthorizationException, ConnectionException

Removes the link between the given ItemType and this one, the link being defined by the given RelationType. The relation type works like this: if you want to remove an image ItemType from a news ItemType, you would call something similar to the following line of code: this.removeRelatedItem(“news.image”, imageType);.

Parameters:

relationType—the RelationType that characterizes the link between this ItemType and the other.

item—the ItemType to unlink from this ItemType

Throws:

AuthorizationException—if the current user does not have permission to perform this operation

ConnectionException—if there is a problem interacting with the CMS; this will only be thrown if the driver implementation choses to use deferred data loading (for performance reason).

1.1.25.22 supportsExtendedRelationships

public boolean supportsExtendedRelationships ( )

throws AuthorizationException, ConnectionException

Indicates whether this type supports extended relationships.

Returns:

true if the item supports extended relationships, false othe,vise

Throws:

AuthorizationException—if the current user does not have permission to perform this operation

ConnectionException—if there is a problem interacting with the CMS; this will only be thrown if the driver implementation choses to use deferred data loading (for performance reason).

1.1.25.23 supportsLocalizedString

public boolean supportsLocalizedString ( )

throws AuthorizationException, ConnectionException

Indicates whether this type supports a localized string.

Returns:

true if the item supports elocalized string, false otherwise

Throws:

AuthorizationException—if the current user does not have permission to perform this operation

ConnectionException—if there is a problem interacting with the CMS; this will only be thrown if the driver implementation choses to use deferred data loading (for performance reason).

### 1.1.26 INTERFACE ITEMTYPEFACTORY

public interface ItemTypeFactory

Interacts with the CMS to provide access to item types of the CMS.

Method Summary

| | |
|---|---|
| ItemType | createNewItemType( ) |
| | Creates a new ItemType instance, uninitialized, |
| | not stored in the CMS. |
| void | deleteItemType(ItemType itemType) |
| | Deletes this ItemType. |
| ItemType | getItemType(com.conceptis.util.PrimaryKey key) |
| | Provides the ItemType with the specified key. |
| ItemType | getItemType(java.lang.String name) |
| | Provides the ItemType with the specified name. |
| java.util.Set | getItemTypes( ) |
| | Provides the set of all ItemTypeS. |
| void | saveItemType(ItemType itemType) |
| | Saves the specified ItemType. |

### Method Detail

1.1.26.1 getItemTypes

public java.util.Set getItemTypes ( )

throws ConnectionException, AuthorizationException

Provides the set of all ItemTypeS.

Returns:

the set of all ItemTypees (may be empty but never null)

Throws:

ConnectionException—if there is a problem interacting with the CMS

AuthorizationException—if the current user does not have permission to perform this operation

1.1.26.2 getItemType

public ItemType getItemType(com.conceptis.util.PrimaryKey key)

throws ConnectionException, AuthorizationException, MissingResourceException

Provides the ItemType with the specified key.

Parameters:

key—the primary key of the ItemType

Returns:

the Itemtype with the specified key

Throws:

ConnectionException—if there is a problem interacting with the CMS

AuthorizationException—if the current user does not have permission to perform this operation

MissingResourceException—if the ItemType specified by the key does not exist

1.1.26.3 getItemType

public ItemType getItemType(java.lang.String name)

throws ConnectionException, AuthorizationException, MissingResourceException

Provides the Itemtype with the specified name.

Parameters:

name—the name of the ItemType

Returns:

the ItemType with the specified key

Throws:

ConnectionException—if there is a problem interacting with the CMS

AuthorizationException—if the current user does not have permission to perform this operation

MissingResourceException—if the ItemType specified by the key does not exist

1.1.26.4 createNewItemType

public ItemType createNewItemType ( )

Creates a new ItemType instance, uninitialized, not stored in the CMS. Once correctly initialized, this instance may then be inserted in the CMS using the saveItemType (com.conceptis.cms.ItemType) method.

Returns:

the newly created ItemType

1.1.26.5 saveItemType

public void saveItemType(ItemType itemType)

throws ConnectionException, AuthorizationException, MissingResourceException

Saves the specified ItemType. This will change the item type's entry in the CMS to reflect the state of the itemType parameter.

Parameters:

itemType—the ItemType to insert/update

Throws:

ConnectionException—if there is a problem interacting with the CMS

AuthorizationException—if the current user does not have permission to perform this operation

MissingResourceException—if a previously existing ItemType does not exist any longer

1.1.26.6 deleteItemType

public void deleteItemType(ItemType itemType)

throws ConnectionException, AuthorizationException, MissingResourceException

Deletes this ItemType. This may have unintended consequences. Note that some implementations may throw an UnsupportedoperationException if the deletion of

ItemTypes is not possible.

Parameters:

itemType—the ItemType to delete

Throws:

ConnectionException—if there is a problem interacting with the CMS

AuthorizationException—if the current user does not have permission to perform this operation

MissingResourceException—if the ItemType does not exist any longer

### 1.1.27 INTERFACE ITEMTYPEFACTORY

public interface ItemTypeFactory

Interacts with the CMS to provide access to item types of the CMS.

Method Summary

| | |
|---|---|
| ItemType | createNewItemType( ) |
| | Creates a new ItemType instance, uninitialized, |
| | not stored in the CMS. |
| void | deleteItemType(ItemType itemType) |
| | Deletes this ItemType. |
| ItemType | getItemType(com.conceptis.util.PrimaryKey key) |
| | Provides the ItemType with the specified key. |
| ItemType | getItemType(java.lang.String name) |
| | Provides the ItemType with the specified name. |
| java.util.Set | getItemTypes( ) |
| | Provides the set of all ItemTypeS. |
| void | saveItemType(ItemType itemType) |
| | Saves the specified ItemType. |

### Method Detail

1.1.27.1 getItemTypes

public java.util.Set getItemTypes ( )

throws ConnectionException, AuthorizationException

Provides the set of all ItemTypeS.

Returns:

the set of all ItemTypees (may be empty but never null)

Throws:

ConnectionException—if there is a problem interacting with the CMS

AuthorizationException—if the current user does not have permission to perform this operation

1.1.27.2 getItemType

public ItemType getItemType(com.conceptis.util.PrimaryKey key)

throws ConnectionException, AuthorizationException, MissingResourceException

Provides the ItemType with the specified key.

Parameters:

key—the primary key of the ItemType

Returns:

the ItemType with the specified key

Throws:

ConnectionException—if there is a problem interacting with the CMS

AuthorizationException—if the current user does not have permission to perform this operation

MissingResourceException—if the ItemType specified by the key does not exist

1.1.27.3 getitemType

public ItemType getItemType(java.lang.String name)

throws ConnectionException, AuthorizationException, MissingResourceException

Provides the ItemType with the specified name.

Parameters:

name—the name of the ItemType

Returns:

the ItemType with the specified key

Throws:

ConnectionException—if there is a problem interacting with the CMS

AuthorizationException—if the current user does not have permission to perform this operation

MissingResourceException—if the ItemType specified by the key does not exist

1.1.27.4 createNewItemType

public ItemType createNewItemType ( )

Creates a new ItemType instance, uninitialized, not stored in the CMS. Once correctly initialized, this instance may then be inserted in the CMS using the saveItemType (com.conceptis.cms.ItemType) method.

Returns:

the newly created ItemType

1.1.27.5 saveItemType

public void saveItemType(ItemType itemType)

throws ConnectionException, AuthorizationException, MissingResourceException

Saves the specified ItemType. This will change the item type's entry in the CMS to reflect the state of the itemType parameter.

Parameters:

itemType—the ItemType to insert/update

Throws:

ConnectionException—if there is a problem interacting with the CMS

AuthorizationException—if the current user does not have permission to perform this operation

MissingResourceException—if a previously existing ItemType does not exist any longer

1.1.27.6 deleteItemType

public void deleteItemType(ItemType itemType)

throws ConnectionException, AuthorizationException, MissingResourceException

Deletes this ItemType. This may have unintended consequences. Note that some implementations may throw an UnsupportedoperationException if the deletion of ItemTypes is not possible.

Parameters:

itemType—the ItemType to delete

Throws:

ConnectionException—if there is a problem interacting with the CMS

AuthorizationException—if the current user does not have permission to perform this operation

MissingResourceException—if the ItemType does not exist any longer

### 1.1.28 INTERFACE OBJECTWITHPRIMARYKEY

All Known Subinterfaces:

CmsUser, CmsUserGroup, Collection, Field, Index, Item, ItemType, PublicationStatus, PublishineFlow

public interface ObjectWithPrimaryKey

Method Summary

| | |
|---|---|
| com.conceptis.util.PrimaryKey | getPrimaryKey( ) |
| | Provides the object's primary key. |

### Method Detail

1.1.28.1 getPrimaryKey

public com.conceptis.util.PrimaryKey getPrimaryKey ( )

throws AuthorizationException

Provides the object's primary key.

Returns:

the primary key identifying the object

Throws:

AuthorizationException—if the user does not have permission to perform this operation

### 1.1.29 INTERFACE PUBLICATIONSTATUS

All Superinterfaces:

ObjectWithPrimaryKey

public interface PublicationStatus

extends ObjectWithPrimaryKey

A PublicationStatus is the smallest component in a PublishingFlow.

Field Summary

| | |
|---|---|
| static java.lang.String | SIGN OFF AUTOMATICALLY AFTER |
| | Defines a PublicationStatus that is signed off |
| | automatically after a given amount of time, set by |
| | setSignOffDelay(long). |
| static java.lang.String | SIGN OFF AUTOMATICALLY AT |
| | Defines a PublicationStatus that is signed off |
| | automatically at a specific moment, set by |
| | setSignOffDate(java.util.Date). |
| static java.lang.String | SIGN OFF MANUALLY |
| | Defines a PublicationStatus that requires a manual sign |
| | off. |

Method Summary

| | |
|---|---|
| void | addGroupToNotify(CmsUserGroup group) |
| | Adds a CmsUserGroup to the list of groups that are notified when |
| | an item reaches this status. |
| boolean | getEmailNotification( ) |
| | Returns the email notification status that will be used when the |
| | associated Item reaches this PublicationStatus. |
| java.util.Set | getGroupsToNotify( ) |
| | Provides the set of all the CmsUserGroups that are sent notification |
| | when an item reaches this status. |
| java.lang.String | getName( ) |
| | Returns the name of this PublicationStatus. |
| java.util.Date | getSignOffDate( ) |
| | Deprecated. this should not be here, it is set by item |
| long | getSignOffDelay( ) |
| | Returns the delay (in milliseconds) to wait before the Item to |
| | which this PublicationStatus was assigned can be signed off |
| | automatically. |
| java.lang.String | getSignOffMethod( ) |
| | Returns the sign-off method of this PublicationStatus. |
| boolean | getSignoffToNewVersion( ) |
| | Return true if the associated Item will be assigned a new version |
| | when it leaves this PublicationStatus. |
| boolean | isViewable( ) |
| | Returns the visibility status of the associated Item when it reaches |
| | this PublicationStatus. |
| void | removeGroupToNotify(CmsUserGroup group) |
| | Removes a CmsUserGroup from the list of groups that are notified |
| | when an item reaches this status. |
| void | setEmailNotification(boolean emailNotification) |
| | When set to true, an email will be sent when the associated Item |
| | reaches this PublicationStatus. |
| void | setName(java.lang.String name) |
| | Sets the name of this PublicationStatus. |
| void | setSignOffDate(java.util.Date date) |
| | Deprecated. this should not be here, it is set by item |
| void | setSignOffDelay(long delay) |
| | Sets the delay (in milliseconds) to wait before the Item to which |
| | this PublicationStatus was assigned can be signed off automatically. |
| void | setSignOffMethod(java.lang.String signOffMethod) |
| | Sets the sign-off method of this PublicationStatus. |
| void | setSignOffToNewVersion(boolean signOffToNewVersion) |
| | When set to true, the associated Item will be assigned a new |
| | version when it leaves this PublicationStatus. |
| void | setViewable(boolean viewable) |
| | When set to true, the associated Item will be viewable when it |
| | reaches this PublicationStatus. |

Methods inherited from interface com.conceptis.cms.ObjectWithPrimaryKey

getPrimaryKey

### Field Detail

1.1.29.1 SIGN_OFF_MANUALLY

public static final java.lang.String SIGN_OFF_MANUALLY

Defines a PublicationStatus that requires a manual sign off.

See Also:

Constant Field Values

1.1.29.2 SIGN_OFF_AUTOMATICALLY_AFTER

public static final java.lang.String SIGN_OFF_AUTOMATICALLY_AFTER

Defines a PublicationStatus that is signed off automatically after a given amount of time, set by setSignoffDelay(long). The

See Also:

Constant Field Values

1.1.29.3 SIGN_OFF_AUTOMATICALLY_AT

public static final java.lang.String SIGN_OFF_AUTOMATICALLY_AT

Defines a PublicationStatus that is signed off automatically at a specific moment, set by setSignOffDate(java.util.Date).

See Also:

Constant Field Values

### Method Detail

1.1.29.4 setName

public void setName(java.lang.String name)

throws AuthorizationException, ConnectionException

Sets the name of this PublicationStatus.

Parameters:

name—the name of this PublicationStatus

Throws:

AuthorizationException—if the current user does not have permission to perform this operation

ConnectionException—if there is a problem interacting with the CMS; this will only be thrown if the driver implementation choses to use deferred data loading (for performance reason).

1.1.29.5 getName

public java.lang.String getName ( )

throws AuthorizationException, ConnectionException

Returns the name of this PublicationStatus.

Returns:

the name of this PublicationStatus

Throws:

AuthorizationException—if the current user does not have permission to perform this operation

ConnectionException—if there is a problem interacting with the CMS; this will only be thrown if the driver implementation choses to use deferred data loading (for performance reason). p0 1.1.29.6 setSignOffMethod

public void setSignOffMethod(java.lang.String signOffMethod)

throws AuthorizationException, ConnectionException

Sets the sign-off method of this PublicationStatus. Acceptable values are defined as constants in this interface and are called SIGN_OFF_XYZ. Some of them may require an additional call to method in order to be valid.

Parameters:

signoffMethod—one of the SIGN_OFF_XYZ constants

Throws:

AuthorizationException—if the current user does not have permission to perform tnis operation

ConnectionException—if there is a problem interacting with the CMS; this will only be thrown if the driver implementation choses to use deferred data loading (for performance reason).

1.1.29.7 getSignOffMethod

public java.lang.String getSignOffMethod ( )

throws AuthorizationException, ConnectionException

Returns the sign-off method of this PublicationStatus.

Returns:

one of the SIGN_OFF_XYZ constants

Throws:

AuthorizationException—if the current user does not have permission to perform this operation

ConnectionException—if there is a problem interacting with the CMS; this will only be thrown if the driver implementation choses to use deferred data loading (for performance reason).

1.1.29.8 setSignOffDelay

public void setSignOffDelay(long delay)

throws AuthorizationException, ConnectionException, java.lang.IllegalStateException

Sets the delay (in milliseconds) to wait before the Item to which this PublicationStatus was assigned can be signed off automatically. This only applies to a PublicationStatus that has been set to SIGN OFF AUTOMATICALLY AFTER.

Parameters:

delay—the number of milliseconds to wait before the Item to which this PublicationStatus was assigned can be signed off automatically

Throws:

java. lang. IllegalStateException—if the sign-off method doesn't support such a setting

AuthorizationException—if the current user does not have permission to perform this operation

ConnectionException—if there is a problem interacting with the CMS; this will only be thrown if the driver implementation choses to use deferred data loading (for performance reason).

1.1.29.9 getSignOffDelay

public long getSignOffDelay ( )

throws AuthorizationException, ConnectionException

Returns the delay (in milliseconds) to wait before the Item to which this PublicationStatus was assigned can be signed off automatically. This only applies to a PublicationStatus that has been set to SIGN OFF AUTOMATICALLY AFTER.

Returns:

the number of milliseconds to wait before the Item to which this PublicationStatus was assigned can be signed off automaticaiiy

Throws:

AuthorizationException—if the current user does not have permission to perform this operation

ConnectionException—if there is a problem interacting with the CMS; this will only be thrown if the driver implementation choses to use deferred data loading (for performance reason).

1.1.29.10 setSignOffDate

public void setSignOffDate(java.util.Date date)

throws AuthorizationException, ConnectionException, java.lang.IllegalStateException

Deprecated. this should not be here, it is set by item

Sets the DateItem to which this PublicationStatus was assigned can be signed off automatically. This only applies to a PublicationStatus that has been set to SIGN OFF AUTOMATICALLY AT.

Parameters:

date—the Date to reach before the Item to which this PublicationStatus was assigned can be signed off automatically

Throws:

java.lang.IllegalStateException—if the sign-off method doesn't support such a setting

AuthorizationException—if the current user does not have permission to perform this operation

ConnectionException—if there is a problem interacting with the CMS; this will only be thrown if the driver implementation choses to use deferred data loading (for performance reason).

1.1.29.11 getSignOffDate ( )

public java.util.Date getSignOffDate ( )

throws AuthorizationException, ConnectionException

Deprecated. this should not be here, it is set by item

Returns the DateItem to which this PublicationStatus was assigned can be signed off automatically. This only applies to a PublicationStatus that has been set to SIGN OFF AUTOMATICALLY AT.

Returns:

the Date to reach before the Item to which this PublicationStatus was assigned can be signed off automatically

Throws:

AuthorizationException—if the current user does not have permission to perform this operation

Connectiongxception—if there is a problem interacting with the CMS; this will only be thrown if the driver implementation choses to use deferred data loading (for performance reason).

1.1.29.12 setViewable

public void setViewable(boolean viewable)

throws AuthorizationException, ConnectionException

When set to true, the associated Item will be viewable when it reaches this PublicationStatus.

Parameters:

viewable—set to true to make the associated Item visible; set to false to keep it invisible

Throws:

AuthorizationException—if the current user does not have permission to perform this operation

ConnectionException—if there is a problem interacting with the CMS; this will only be thrown if the driver implementation choses to use deferred data loading (for performance reason).

1.1.29.13 isViewable

public boolean isViewable ( )

throws AuthorizationException, ConnectionException

Returns the visibility status of the associated Item when it reaches this PublicationStatus.

Returns:

true if the associated Item is visible; false otherwise

Throws:

AuthorizationException—if the current user does not have permission to perform this operation

ConnectionException—if there is a problem interacting with the CMS; this will only be thrown if the driver implementation choses to use deferred data loading (for performance reason).

1.1.29.14 setEmailNotification

public void setEmailNotification(boolean emailNotification)

throws AuthorizationException, ConnectionException

When set to true, an email will be sent when the associated Item reaches this PublicationStatus.

Parameters:

emailNotification—set to true to send an email notification when the associated Item reaches this PublicationStatus; set to false to disable email notification

Throws:

AuthorizationException—if the current user does not have permission to perform this operation

ConnectionException—if there is a problem interacting with the CMS; this will only be thrown if the driver implementation choses to use deferred data loading (for performance reason).

1.1.29.15 getEmailNotification

public boolean getEmailNotification ( )

throws AuthorizationException, ConnectionException

Returns the email notification status that will be used when the associated Item reaches this PublicationStatus.

Returns:

true if email notification is activated; false otherwise

Throws:

AuthorizationException—if the current user does not have permission to perform this operation

ConnectionException—if there is a problem interacting with the CMS; this will only be thrown if the driver implementation choses to use deferred data loading (for performance reason).

1.1.29.16 setSignOffToNewVersion

public void setSignOffToNewVersion(boolean signOffToNewVersion)

throws AuthorizationException, ConnectionException

When set to true, the associated Item will be assigned a new version when it leaves this PublicationStatus.

Parameters:

signoffToNewversion—set to true to assign a new version to the associated Item when it leaves this PublicationStatus; set to false to keep the same version at signoff

Throws:

AuthorizationException—if the current user does not have permission to perform this operation

ConnectionException—if there is a problem interacting with the CMS; this will only be thrown if the driver implementation choses to use deferred data loading (for performance reason).

1.1.29.17 getSignOffToNewVersion

public boolean getSignOffToNewVersion ( )

throws AuthorizationException, ConnectionException

Return true if the associated Item will be assigned a new version when it leaves this PublicationStatus.

Returns:

true if new version is going to be assigned to the associated Item when it leaves this PublicationStatus; false if the Item will keep the same version at signoff

Throws:

AuthorizationException—if the current user does not have permission to perform this operation

ConnectionException—if there is a problem interacting with the CMS; this will only be thrown if the driver implementation choses to use deferred data loading (for performance reason).

1.1.29.18 addGroupToNotify

public void addGroupToNotify(CmsUserGroup group)

throws AuthorizationException, ConnectionException

Adds a CmsUserGroup to the list of groups that are notified when an item reaches this status. If the group is already being notified, this method does nothing but will not complain.

Parameters:

group—the group to be notified when an item reaches this status

Throws:

AuthorizationException—if the current user does not have permission to perform this operation

ConnectionException—if there is a problem interacting with the CMS; this will only be thrown if the driver implementation choses to use deferred data loading (for performance reason).

1.1.29.19 removeGroupToNotify

public void removeGroupToNotify(CmsUserGroup group)

throws AuthorizationException, ConnectionException

Removes a CmsUserGroup from the list of groups that are notified when an item reaches this status.

Parameters:

group—the group to no longer be notified when an item reaches this status

Throws:

AuthorizationException—if the current user does not have permission to perform this operation

ConnectionException—if there is a problem interacting with the CMS; this will only be thrown if the driver implementation choses to use deferred data loading (for performance reason).

1.1.29.20 getGroupsToNotify

public java.util.Set getGroupsToNotify ( )

throws AuthorizationException, ConnectionException

Provides the set of all the CmsUserGroupS that are sent notification when an item reaches this status.

Returns:

the set of groups that are notified when an item reaches this status

Throws:

AuthorizationException—if the current user does not have permission to perform this operation

ConnectionException—if there is a problem interacting with the CMS; this will only be thrown if the driver implementation choses to use deferred data loading (for performance reason).

### 1.1.30 INTERFACE PUBLICATIONSTATUSFACTORY

public interface PublicationStatusFactory

Interacts with the CMS to provide access to publication statii of the CMS.

Method Summary

| | |
|---|---|
| PublicationStatus | createNewPublicationStatus( ) |
| | Creates a new PublicationStatus instance, |
| | uninitialized, not stored in the CMS. |
| void | deletePublicationStatus(PublicationStatus |
| | publicationStatus) Deletes this PublicationStatus. |
| java.util.Set | getPublicationStatii( ) |
| | Provides the set of all PublicationStatuses. |
| java.util.List | getPublicationStatii(ItemType type) |
| | Provides the List of all PublicationStatus for the |
| | specified type. |
| PublicationStatus | getPublicationStatus |
| | (com.conceptis.util.PrimaryKey key) |
| | Provides the PublicationStatus with the specified key. |
| void | savePublicationStatus(PublicationStatus |
| | publicationStatus) Saves the specified |
| | PublicationStatus. |

### Method Detail

1.1.30.1 getPublicabonStatii

public java.util.Set getPublicationStatii ( )

throws ConnectionException, AuthorizationException

Provides the set of all PublicationStatuses.

Returns:

the set of all PublicationStatuses

Throws:

ConnectionException—if there is a problem interacting with the CMS

AuthorizationException—if the current user does not have permission to perform this operation

1.1.30.2 getPublicationStatii

public java.util.List getPublicationStatii(ItemType type)

throws ConnectionException, AuthorizationException

Provides the List of all PublicationStatus for the specified type. Authorization required: Action.READ on the supplied ItemType

Parameters:

type—the type to provide the statii for

Returns:

the List of status objects associated with the provided type

Throws:

Connection Exception—if there is a problem interacting with the CMS

AuthorizationException—if the user does not have permission to perform this operation

1.1.30.3 getPublicationStatus

public PublicationStatus

getPublicationStatus(com.conceptis.util.PrimaryKey key)

throws ConnectionException, AuthorizationException, MissingResourceException

Provides the PublicationStatus with the specified key.

Parameters:

key—the primary key of the PublicationStatus

Returns:

the PublicationStatus with the specified key

Throws:

ConnectionException—if there is a problem interacting with the CMS

AuthorizationException—if the current user does not have permission to perform this operation

MissingResourceException—if the PublicationStatus specified by the key does not exist

1.1.30.4 createNewPublicationStatus

public PublicationStatus createNewPublicationStatus ( )

Creates a new PublicationStatus instance, uninitialized, not stored in the CMS. Once correctly initialized, this instance may then be inserted in the CMS using the savePublicationStatus(com.conceptis.cms.PublicationStatus) method.

Returns:

the newly created PublicationStatus

1.1.30.5 savePublicationStatus

public void savePublicationStatus(PublicationStatus publicationStatus)

throws ConnectionException, AuthorizationException, MissingResourceException

Saves the specified PublicationStatus. This will change the PublicationStatus' entry in the CMS to reflect the state of the publicationstatus parameter.

Parameters:

publicationstatus—the PublicationStatus to insert/update

Throws:

ConnectionException—if there is a problem interacting with the CMS

AuthorizationException—if the current user does not have permission to perform this operation

MissingResourceException—if a previously existing PublicationStatus does not exist any longer

1.1.30.6 deletePublicationStatus

public void deletePublicationStatus (PublicationStatus publicationStatus)

throws ConnectionException, AuthorizationException, MissingResourceException

Deletes this PublicationStatus. This may have unintended consequences. Note that some implementations may throw an UnsupportedoperationException if the deletion of Publicationstatuses is not possible.

Parameters:

publicationstatus—the PublicationStatus to delete

Throws:

ConnectionException—if there is a problem interacting with the CMS

AuthorizationException—if the current user does not have permission to perform this operation

MissingResourceException—if the PublicationStatus does not exist any longer

### 1.1.31 INTERFACE PUBLISHINGFLOW

All Superinterfaces:

ObjectWithPrimaraKey

public interface PublishingFlow

extends ObjectWithPrimaryKey

A PublishingFlow describes a sequence, order and relations, of any number of PublicationStatus. Such a flow can be assigned to an ItemType to constrain its publishing flow.

Method Summary

| | |
|---|---|
| void | addPublicationStatus(int index, |
| | PublicationStatus publicationStatus) |
| | Adds a PublicationStatus to this PublishingFlow at the |
| | specified index. |
| java.lang.String | getName( ) |
| | Returns the name of this PublishingFlow. |
| java.util.List | getPublicationStatii( ) |
| | Provides the PublicStatus objects that make up this |
| | flow. |
| PublicationStatus | getPublicationStatus(int index) |
| | Returns the PublicationStatus found at the specified |
| | index in this PublishingFlow. |
| boolean | isCircular( ) |
| | Returns true if this PublicationFlow is circular; |
| | false otherwise. |
| PublicationStatus | removePublicationStatus(PublicationStatus |
| | publicationStatus) |
| | Removes the PublicationStatus found at the specified |
| | index in this PublishingFlow. |
| void | setCircular(boolean circular) |
| | If set to true, this PublishingFlow will be circular, |
| | which means that once the last PublicationStatus |
| | is reached and the Item is being signed off, it will |
| | start over at the first PublicationStatus. |
| void | setName(java.lang.String name) |
| | Sets the name of this PublishingFlow. |

Methods inherited from interface com.conceptis.cms.ObjectWithPrimaryKey

get PrimaryKey

### Method Detail

1.1.31.1 setName

public void setName(java.lang.String name)

throws AuthorizationException, ConnectionException

Sets the name of this PublishingFlow.

Parameters:

name—the name of this PublishingFlow

Throws:

AuthorizationException—if the current user does not have permission to perform this operation

ConnectionException—if there is a problem interacting with the CMS; this will only be thrown if the driver implementation choses to use deferred data loading (for performance reason).

1.1.31.2 getName

public java.lang.String getName ( )

throws AuthorizationException, ConnectionException

Returns the name of this PublishingFlow.

Returns:

the name of this PublishingFlow

Throws:

AuthorizationException—if the current user does not have permission to perform this operation

ConnectionException—if there is a problem interacting with the CMS; this will only be thrown if the driver implementation choses to use deferred data loading (for performance reason).

1.1.31.3 addPublicaflonStatus

public void addPublicationStatus(int index, PublicationStatus publicationStatus)

throws AuthorizationException, ConnectionException, java.lang.IndexOutPfBoundsException

Adds a PublicationStatus to this PublishingFlow at the specified index.

Parameters:

index—index at which the PublicationStatus is to be inserted publicationstatus—PublicationStatus to insert in the PublishingFlow

Throws:

AuthorizationException—if the current user does not have permission to perform this operation

ConnectionException—if there is a problem interacting with the CMS; this will only be thrown if the driver implementation choses to use deferred data loading (for performance reason).

java.lang.IndexOutOfBoundsException—if the index is negative or larger then the current field count

1.1.31.4 getPublicabonStatus

public PublicationStatus getPublicationStatus(int index)

throws AuthorizationException, ConnectionException, java.lang.IndexOutOfBoundsException

Returns the PublicationStatus found at the specified index in this PublishingFlow.

Parameters:

index—index at which the PublicationStatus is stored

Returns:

the PublicationStatus found at the specified index

Throws:

AuthorizationException—if the current user does not have permission to perform this operation

ConnectionException—if there is a problem interacting with the CMS; this will only be thrown if the driver implementation choses to use deferred data loading (for performance reason).

java. lang. IndexOutOfBoundsException—if the index is negative or larger then the current field count

1.1.31.5 removePublicationStatus

public PublicationStatus

removePublicationStatus(PublicationStatus publicationStatus)

throws AuthorizationException, ConnectionException

Removes the PublicationStatus found at the specified index in this PublishingFlow.

Parameters:

publicationStatus—the PublicationStatus to remove

Returns:

the removed PublicationStatus

Throws:

AuthorizationException—if the current user does not have permission to perform this operation

ConnectionException—if there is a problem interacting with the CMS; this will only be thrown if the driver implementation choses to use deferred data loading (for performance reason).

1.1.31.6 getPublicationStatii

public java.util.List getPublicationStatii ( )

throws AuthorizationException, ConnectionException

ProvidesthePublicstatus objects that make up this flow. These objects are returned in a List in the order of the publication flow. There may be duplicate elements.

Returns:

the publication statii, in order of flow

Throws:

AuthorizationException—if the current user does not have permission to perform this operation

ConnectionException—if there is a problem interacting with the CMS;

this will only be thrown if the driver implementation choses to use deferred data loading (for performance reason).

1.1.31.7 setCircular

public void setCircular(boolean circular)

throws AuthorizationException, ConnectionException

If set to true, this PublishingFlow will be circular, which means that once the last PublicationStatus is reached and the Item is being signed off, it will start over at the first PublicationStatus.

Parameters:

circular—set to true for a circular behavior; set to false for simple linear behavior

Throws:

AuthorizationException—if the current user does not have permission to perform this operation

ConnectionException—if there is a problem interacting with the CMS;

this will only be thrown if the driver implementation choses to use deferred data loading (for performance reason).

1.1.31.8 isCircular

public boolean isCircular ( )

throws AuthorizationException, ConnectionException

Returns true if this PublicationFlow is circular; false otherwise.

Returns:

true if this PublicationFlow is circular; false otherwise

Throws:

AuthorizationException—if the current user does not have permission to perform this operation

ConnectionException—if there is a problem interacting with the CMS;

this will only be thrown if the driver implementation choses to use deferred data loading (for performance reason).

### 1.1.32 INTERFACE PUBLISHINGFLOWFACTORY

public interface PublishingFlowFactory

Interacts with the CMS to provide access to publication flows of the CMS.

Method Summary

| | |
|---|---|
| PublishingFlow | createNewPublishingFlow( ) |
| | Creates a new PublishingFlow instance, uninitialized, |
| | not stored in the CMS. |
| void | deletePublicationStatus(PublishingFlow publishingFlow) |
| | Deletes this PublishingFlow. |
| PublishingFlow | getPublishingFlow(com.conceptis.util.PrimaryKey key) |
| | Provides the PublishingFlow with the specified key. |
| java.util.Set | getPublishingFlows( ) |
| | Provides the set of all PublishingFlows. |
| void | savePublishingFlow(PublishingFlow publishingFlow) |
| | Saves the specified PublishingFlow. |

### Method Detail

1.1.32.1 getPublishingFlows

public java.util.Set getPublishingFlows ( )

throws ConnectionException, AuthorizationException

Provides the set of all PublishingFlows.

Returns:

the set of all PublishingFlows

Throws:

ConnectionException—if there is a problem interacting with the CMS

AuthorizationException—if the current user does not have permission to perform this operation

1.1.32.2 getPublishingFIow

public PublishingFlowgetPublishingFlow(com.conceptis.util.PrimaryKey key)

throws ConnectionException, AuthorizationException, MissingResourceException

Provides the PublishingFlow with the specified key.

Parameters:

key—the primary key of the PublishingFlow

Returns:

the PublishingFlow with the specified key

Throws:

ConnectionException—if there is a problem interacting with the CMS

AuthorizationException—if the current user does not have permission to perform this operation

MissingResourceException—if the PublishingFlow specified by the key does not exist

1.1.32.3 createNewPublishingFlow

public PublishingFlow createNewPublishingFlow ( )

Creates a new PublishingFlow instance, uninitialized, not stored in the CMS. Once correctly initialized, this instance may then be inserted in the CMS using the savePublishingFlow(com.conceptis.cms.PublishingFlow) method.

Returns:

the newly created PublishingFlow

1.1.32.4 savePublishingFlow

public void savePublishingFlow(PublishingFlow publishingFlow)

throws ConnectionException, AuthorizationException, MissingResourceException

Saves the specified PublishingFlow. This will change the PublishingFlow's entry in the CMS to reflect the state of the publishingFlow parameter.

Parameters:

publishingFlow—the PublishingFlow to insert/update

Throws:

ConnectionException—if there is a problem interacting with the CMS

AuthorizationException—if the current user does not have permission to perform this operation

MissingResourceException—if a previously existing PublishingFlow does not exist any longer

1.1.32.5 deletePublicationStatus

public void deletePublicationStatus(PublishingFlow publishingFlow)

throws ConnectionException, AuthorizationException, MissingResourceException

Deletes this PublishingFlow. This may have unintended consequences. Note that some implementations may throw an UnsupportedoperationException if the deletion of PublishingFlowS is not possible.

Parameters:

publishingFlow—the PublishingFlow to delete

Throws:

ConnectionException—if there is a problem interacting with the CMS

AuthorizationException—if the current user does not have permission to perform this operation

MissingResourceException—if the PublishingFlow does not exist any longer

### 1.1.33 INTERFACE RELATIONSHIP

public interface Relationship

Links an Item relationship with a List of parameters.

Method Summary

| | |
|---|---|
| java.util.Iterator | getParameterNames() |
| | Provides names of the paramneters in this relationship. |
| java.util.List | getParameterValues(java.lang.String name) |
| | Provides the values of the parameter specified (a list of |
| | strings). |
| Item | getRaltion() |
| | Provides the related item. |

### Method Detail

1.1.33.1 getRelation

public Item getRelation ( )

throws ConnectionException, AuthorizationException, MissingResourceException

Provides the related item.

Returns:

the item that is in the relationship

Throws:

AuthorizationException—if the current user does not have permission to perform this operation

ConnectionException—if there is a problem interacting with the CMS; this will only be thrown if the driver implementation choses to use deferred data loading (for performance reason).

MissingResourceException—is the item in the relationship does not exist

1.1.33.2 getParameterNames

public java.util.Iterator getParameterNames ( )

Provides names of the parameters in this relationship.

Returns:

the names of the parameters

1.1.33.3 getParameterValues

public java.util.List getParametervalues(java.lang.String name)

Provides the values of the parameter specified (a list of strings).

Parameters:

name—tne name of tne parameter

Returns:

the values of the specified parameter (a list of strings)

### 1.1.34 INTERFACE RELATIONTYPE

public interface RelationType

A RelationType defines any kind of relation that may exist between two Items: parent/child, article/author, text/image, etc. Relations may or may not be bilateral, meaning that a relation may be called differently depending on the point of origin (ex: parent/child). Relations may also be of the following types: 1-to-1, 1-to-many or many-to-many.

Field Summary

| | |
|---|---|
| static java.lang.String | CHILD |
| | Defines a RelationType that can be used to link |
| | non-unique child ItemS to another Item. |
| static java.lang.String | DESCENDANT |
| | Defines a RelationType that can be used to link |
| | non-unique child ItemS to another Item. |
| static java.lang.String | PARENT |
| | Defines a RelationType that can be used to link |
| | non-unique parent ItemS to another Item. |
| static java.lang.String | PRIMARY PARENT |
| | Defines a RelationType that can be used to link a |
| | unique parent Item to another Item. |
| static java.lang.String | SECONDARY PARENT |
| | Defines a RelationType that can be used to link a |
| | parent Item to another Item. |

Method Summary

| | |
|---|---|
| java.lang.String | getName( ) |
| | Returns the name of this RelationType. |
| boolean | isMandatory( ) |
| | Indicates whether the RelationType must be set. |
| boolean | isUnique( ) |
| | Returns true if the Item can only have one unique |
| | Item linked to it using this RelationType; returns |
| | false if an Item may have one or more other |
| | ItemS linked to it using this RelationType. |

### Field Detail

1.1.34.1 PRIMARY_PARENT

public static final java.lang.String PRIXARY_PARENT

Defines a RelationType that can be used to link a unique parent Item to another Item.

This is the reciprocal of CHILD.

See Also:

Constant Field Values

1.1.34.2 PARENT

public static final java.lang.String PARENT

Defines a RelationType that can be used to link non-unique parent Items to another

Item. This is the reciprocal of CHILD.

See Also:

Constant Field Values

1.1.34.3 SECONDARY_PARENT

public static final java.lang.String SECONDARY_PARENT

Defines a RelationType that can be used to link a parent Item to another Item. This is the reciprocal of CHILD.

See Also:

Constant Field Values

1.1.34.4 CHILD

public static final java.lang.String CHILD

Defines a RelationType that can be used to link non-unique child Items to another Item. This is the reciprocal of PRIMARY PARENT and PARENT.

See Also:

Constant Field Values

1.1.34.5 DESCENDANT

public static final java.lang.String DESCENDANT

Defines a RelationType that can be used to link non-unique child Items to another Item.

See Also:

Constant Field Values

### Method Detail

1.1.34.6 getName

public java.lang.String getName ( )

Returns the name of this RelationType.

Returns:

the name of this RelationType

1.1.34.7 isUnique

public boolean isUnique ( )

Returns true if the Item can only have one unique Item linked to it using this RelationType; returns false if an Item may have one or more other Items linked to it using this RelationType.

Returns:

true for unique linked Item; false for multiple linked Items

1.1.34.8 isMandatory

public boolean isMandatory ( )

Indicates whether the RelationType must be set.

Returns:

true if the relation is mandatory, false otherwise

### 1.1.35 INTERFACE RELATIONTYPEFACTORY

public interface RelationTypeFactory

Interacts with the CMS to provide access to the relation types of the CMS.

Method Summary

| | |
|---|---|
| RelationType | getRelationType(ItemType type, java.lang.String name) |
| | Provides the RelationType with the specified name and |
| | uniqueness. |
| RelationType | getRelationType(java.lang.String type, java.lang. |
| | String name) Provides the RelationType with the |
| | specified name and uniqueness. |
| java.util.Set | getRelationTypes(ItemType type) |
| | Provides the set of all RelationTypeS. |
| boolean | relationshipPermitted(java.lang.String itemType1, |
| | java.lang.String itemType2, java.lang.String name) |
| | Indicates whether two items are linkable. |

### Method Detail

1.1.35.1 getRelationTypes

public java.util.Set getRelationTypes(ItemType type)

throws ConnectionException, AuthorizationException

Provides the set of all RelationTypes.

Parameters:

type—the ItemType of the item seeking a list of possible relationship types

Returns:

the set of all RelationTypes (may be empty but never null)

Throws:

ConnectionException—if there is a problem interacting with the CMS

AuthorizationException—if the current user does not have permission to perform this operation

1.1.35.2 getRelationType

public RelationType getRelationType(ItemType type, java.lang.String name)

throws ConnectionException, AuthorizationException, MissingResourceException

Provides the RelationType with the specified name and uniqueness.

Parameters:

type—the ItemType of the item seeking a relationship

name—the name of the relation

Returns:

the RelationType matching the specified parameters

Throws:

ConnectionException—if there is a problem interacting with the CMS

AuthorizationException—if the current user does not have permission to perform this operation

MissingResourceException—if the RelationType specified by the parameters does not exist

1.1.35.3 getRelationType

public RelationType getRelationType(java.lang.String type, java.lang.String name)

throws ConnectionException, AuthorizationException, MissingResourceException

Provides the RelationType with the specified name and uniqueness.

Parameters:

type—the name of ItemType of the item seeking a relationship

name—the name of the relation

Returns:

the RelationType matching the specified parameters

Throws:

ConnectionException—if there is a problem interacting with the CMS

AuthorizationException—if the current user does not have permission to perform this operation

MissingResourceException—if the RelationType specified by the parameters does not exist, or the ItemType does not exist

1.1.35.4 relationshipPermitted

public boolean relationshipPermitted(java.lang.string itemType1, java.lang.String itemType2, java.lang.String name)

throws ConnectionException, AuthorizationException, MissingResourceException

Indicates whether two items are linkable.

Parameters:

itemType1—the first item type

itemType2—the second item type

name—the name of the relationship

Returns:

true if the items are linkable, false otherwise

Throws:

ConnectionException—if there is a problem interacting with the CMS

AuthorizationException—if the current user does not have permission to perform this operation

MissingResourceException—if the RelationType specified by the parameters does not exist, or the ItemType does not exist

### 1.1.36 INTERFACE SECURITYMANAGER

public interface SecurityManager

The SecurityManager centralizes all the business logic of your driver related to access restrictions. Indeed, most of the actions that can be performed by a CmsUser when using the CMS Driver may need to be approved before being executed.

This Interface must be implemented by your application in order to define your own business logic, and you must then tell the driver that you will use your own implementation using the driver configuration file.

Method Summary

| | |
|---|---|
| boolean | isAllowed(CmsUser cmsUser, Action action, Item item, |
| | Field field) This feature is not supported in this version of |
| | the CMS API, and will always throw an |
| | UnsupportedOperationException. |
| boolean | isAllowed(CmsUser cmsUser, Action action, java.lang. |
| | Object resource) Checks if the CmsUser can perform the |
| | Action on the given SecureResource. |

### Method Detail

1.1.36.1 isAllowed

public boolean isAllowed(CmsUser cmsUser, Action action, java.lang.object resource)

Checks if the CmsUser can perform the Action on the given SecureResource.

Parameters:

CmsUser—the CmsUser that wants to execute the specified Action on the given resource.

action—the Action that will be performed by the CmsUser on the given resource, if authorized.

resource—the Object on which the specified Action will be performed if authorization is granted.

Returns:

true if the given CmsUser has enough credentials to perform the action on the resource.

1.1.36.2 isAllowed

public boolean isAllowed(CmsUser cmsUser, Action action, Item item, Field field)

This feature is not supported in this version of the CMS API, and will always throw an UnsupportedOperationException.

Checks if the CmsUser can perform the Action on the Field of the given Item.

Parameters:

cmsUser—the CmsUser that wants to execute the specified action on the given Item.

action—the Action that will be performed by the CmsUser on the given Item, if authorized.

item—the Item on which the specified Action will be performed if authorization is granted.

field—the Field of the Item that will be accessed when performing the specified action.

Returns:

true if the given CmsUser has enough credentials to perform the Action on the Field of the Item.

### 1.1.37 INTERFACE VERSION

public interface Version

A Version represents a modification applied to an Item.

Method Summary

| | |
|---|---|
| CmsUser | getAuthor( ) |
| | Returns the Author of this Version. |
| java.util.Date | getDate( ) |
| | Returns the Date of this Version. |
| java.lang.String | getNote( ) |
| | Return the text note associated with this Version. |
| PublicationStatus | getPublicationStatus( ) |
| | Returns the PublicationStatus of this Version. |
| long | getVersion( ) |
| | Returns the current version number of this Version. |

### Method Detail

1.1.37.1 getVersion

public long getVersion ( )

throws AuthorizationException

Returns the current version number of this Version.

Returns:

the current version number of this Version

Throws:

AuthorizationException—if the user does not have permission to perform this operation

1.1.37.2 getNote

public java.lang.String getNote ( )

throws AuthorizationException

Return the text note associated with this Version.

Returns:

the text note associated with this Version

Throws:

AuthorizationException—if the user does not have permission to perform this operation

1.1.37.3 getPublicabonStatus

public PublicationStatus getPublicationStatus ( )

throws AuthorizationException

Returns the PublicationStatus of this Version.

Returns:

the PublicationStatus of this Version

Throws:

AuthorizationException—if the user does not have permission to perform this operation

1.1.37.4 getAuthor

public CmsUser getAuthor ( )

throws AuthorizationException

Returns the Author of this Version.

Returns:

the Author of this Version

Throws:

AuthorizationException—if the user does not have permission to perform this operation

1.1.37.5 getDate

public java.util.Date getDate ( )

throws AuthorizationException

Returns the Date of this Version.

Returns:

the Date of this Version

Throws:

AuthorizationException—if the user does not have permission to perform this operation

### 1.2 PACKAGE COM.CONCEPTIS.CMS.FILTER

### 1.2.1 CLASS CMSUSERUSERNAMECOMPARATOR

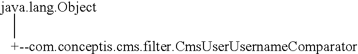

All Implemented Interfaces:

java.util.Comparator

public class CmsUserUsernameComparator

extends java.lang.Object

implements java.util.Comparator

Comparator that utilizes a User's username to sort a collection of users.

Field Summary

| | |
|---|---|
| private boolean | ascending |
| | Whether to sort ascending or descending. |
| private | log |
| static org.apache.log4j.Logger | For logging purposes. |

### Constructor Summary

CmsUserUsernameComparator ( )

Method Summary

| | |
|---|---|
| int | compare(java.lang.Object o1, java.lang.Object o2) |
| | Compares its two arguments for order. |
| boolean | isAscending( ) |
| | Indicates whether the comparator is sorting in an ascending or |
| | descending manner. |
| void | setAscending(boolean ascending) |
| | Sets whether the comparator is sorting in an ascending or |
| | descending manner. |

Methods inherited from class java.lang.Object

clone, equals, finalize, getclass, hashCode, notify, notifyAll, toString, wait, wait, wait

Methods inherited from interface java.util.Comparator

equals

### Field Detail

1.2.1.1 log

private static org.apache.log4j.Logger log

For logging purposes.

1.2.1.2 ascending

private boolean ascending

Whether to sort ascending or descending.

### Constructor Detail

1.2.1.3 CmsUserUsernameComparator

public CmsUserUsernameComparator ( )

### Method Detail

1.2.1.4 isAscending

public boolean isAscending ( )

Indicates whether the comparator is sorting in an ascending or descending manner.

Returns:

true if the comparator is ascending, false if descending

1.2.1.5 setAscending

public void setAscending(boolean ascending)

Sets whether the comparator is sorting in an ascending or descending manner.

Parameters:

ascending—true if the comparator is ascending, false otherwise

1.2.1.6 compare

public int compare(java.lang.object o1, java.lang.object o2)

throws java.lang.ClassCastException

Compares its two arguments for order. Returns a negative integer, zero, or a positive integer as the first argument is less than, equal to, or greater than the second.

Specified by:

compare in interface java.util. Comparator

Parameters:

o1—the first object to be compared

o2—the second object to be compared

Returns:

a negative integer, zero, or a positive integer as the first argument is less than, equal to, or greater than the second

Throws:

java.lang.ClassCastException—if the arguments' types prevent them from being compared by this Comparator

### 1.2.2 CLASS DATEAWAREITEMNAMECOMPARATOR

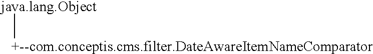

All Implemented Interfaces:

java.util.Comparator

public class DateAwareItemNameComparator

extends java.lang.Object

implements java.util.Comparator

Comparator that is able to compare an Item's names. If there is a date in the name, this is used to sort, but in reverse order (so, alphabetically ascending, but numerically descending, or the opposite).

Field Summary

| | |
|---|---|
| private boolean | dateAscending |
| | The order to sort the date. |
| private boolean | nameAscending |
| | The order to sort the name. |
| private | pattern |
| static java.util.regex.Pattern | The compiled pattern. |
| static java.lang.String | YEAR PATTERN |
| | The pattern to recognize years. |

### Constructor Summary

DateAwareItemNameComparator ( )

Creates a comparator that sorts the name ascending, date descending.

DateAwareItemNameComparator(boolean nameAscending, boolean dateAscending)

Creates a comparator.

Method Summary

| | |
|---|---|
| int | compare(java.lang.Obiect o1, java.lang.Object o2) |
| | Compares two objects, which may be ItemS or DateS. |

Methods inherited from class java.lang.Object

clone, equals, finalize, getClass, hashCode, notify, notifyAll, toString, wait, wait, wait

Methods inherited from interface java.util.Comparator

equals

### Field Detail

1.2.2.1 nameAscending

private boolean nameAscending

The order to sort the name.

1.2.2.2 dateAscending

private boolean dateAscending

The order to sort the date.

1.2.2.3 YEAR_PATTERN

public static final java.lang.String YEAR_PATTERN

The pattern to recognize years.

See Also:

Constant Field Values

1.2.2.4 pattern

private static java.util.regex.Pattern pattern

The compiled pattern.

### Constructor Detail

1.2.2.5 DateAwareItemNameComparator

public DateAwareItemNameComparator ( )

Creates a comparator that sorts the name ascending, date descending.

1.2.2.6 DateAwareItemNameComparator

public DateAwareItemNameComparator(boolean nameAscending, boolean dateAscending)

Creates a comparator.

Parameters:

nameAscending—true to sort the name ascending, false descending

dateAscending—true to sort the date ascending, false descending

### Method Detail

1.2.2.7 compare

public int compare(java.lang.Object o1, java.lang.Object o2)

throws java.lang.ClassCastException

Compares two objects, which may be Items or Dates.

Specified by:

compare in interface java.util.Comparator

Parameters:

o1—the first object to compare

o2—the second object to compare

Returns:

a negative integer, zero, or a positive integer as the first argument is less than, equal to, or greater than the second

Throws:

java.lang.ClassCastException—if the arguments' types prevent them from being compared by this Comparator

### 1.2.3 CLASS ITEMDATERANGEFILTER

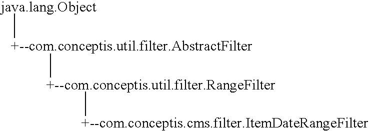

All Implemented Interfaces:

com.conceptis.util.filter.Filter

Direct Known Subclasses:

ItemFieldDateRangeFilter, ItemLastModificationDateFilter

public class ItemDateRangeFilter

extends com.conceptis.util.filter.RangeFilter

Filters a Collection of Items using a date range.

Field Summary

| | |
|---|---|
| static java.lang.String | DEFAULT PATTERN |
| | The default (SimpleDateFormat pattern for |
| | interpreting dates: |
| | dd MM yyyy HH:mm:ss. |
| private | format |
| java.text.SimpleDateFormat | The SimpleDateFormat used to interpret |
| | dates. |
| private java.util.Locale | locale |
| | The locale used to interpret dates. |
| private | localeRegex |
| static java.util.regex.Pattern | The regular expression to parse the Locale |
| | string. |
| private | log |
| static org.apache.log4j.Logger | For logging purposes. |
| private java.lang.String | pattern |
| | The pattern used to interpret dates. |

Fields inherited from class com.conceptis.util.filter.RangeFilter

### Constructor Summary

ItemDateRangeFilter ( )

Method Summary

| | |
|---|---|
| java.lang.String | getEndDate( ) |
| | Provides the ending date range. |
| java.lang.String | getLocale( ) |
| | Provide the locale used to interpret dates. |
| java.lang.String | getPattern( ) |
| | Provides the pattern used to interpret dates. |
| java.lang.String | getStartDate( ) |
| | Provides the starting date range. |
| java.util.Locale | parseLocale(java.lang.String locale) |
| | Generates a locale from a string provided be a locale's |
| | toString method. |
| void | setEndDate(java.lang.String end) |
| | Sets the ending date range. |
| void | setLocale(java.lang.String locale) |
| | Sets the locale used to interpret dates. |
| void | setPattern(java.lang.String pattern) |
| | Sets the pattern used to interpret dates. |
| void | setStartDate(java.lang.String start) |
| | Sets the starting date range. |

Methods inherited from class com.conceptis.util.filter.RangeFilter

filter, getComparator, getEnd, getStart, isInclusive, isInside, setComparator, setEnd, setInclusive, setInside, setStart

Methods inherited from class com.conceptis.util.filter.AbstractFilter

filter

Methods inherited from class java.lang.Object

clone, equals, finalize, getClass, hashCode, notify, notifyAll, toString, wait, wait, wait

### Field Detail

1.2.3.1 DEFAULT_PATTERN

public static final java.lang.String DEFAULT_PATTERN

The default (SimpleDateFormat pattern for interpreting dates: dd MM yyyy HH:mm:ss.

See Also:

Constant Field Values

1.2.3.2 localeRegex

private static java.util.regex.Pattern localeRegex

The regular expression to parse the Locale string.

1.2.3.3 log

private static org.apache.log4j.Logger log

For logging purposes.

1.2.3.4 locale

private java.util.Locale locale

The locale used to interpret dates.

1.2.3.5 pattern

private java.lang.String pattern

The pattern used to interpret dates.

1.2.3.6 format

private java.text.SimpleDateFormat format

The SimpleDateFormat used to interpret dates.

### Constructor Detail

1.2.3.7 ItemDateRangeFilter

public ItemDateRangeFilter ( )

### Method Detail

1.2.3.8 getLocale

public java.lang.String getLocale ( )

Provide the locale used to interpret dates.

Returns:

the locale used to interpret dates

1.2.3.9 setLocale

public void setLocale(java.lang.String locale)

Sets the locale used to interpret dates.

Parameters:

locale—the locale used to interpret dates

1.2.3.10 parseLocale

public java.util.Locale parseLocale(java.lang.String locale)

Generates a locale from a string provided be a locale's toString method.

Parameters:

locale—a string representing a locale

Returns:

a locale as specified by the string

1.2.3.11 getPattern

public java.lang.String getPattern ( )

Provides the pattern used to interpret dates.

Returns:

the pattern used to interpret dates

1.2.3.12 setPattern

public void setPattern(java.lang.String pattern)

Sets the pattern used to interpret dates.

Parameters:

pattern—the pattern to use

1.2.3.13 getStartDate

public java.lang.String getStartDate ( )

Provides the starting date range.

Returns:

the starting date range

1.2.3.14 setStartDate

public void setStartDate(java.lang.String start)

throws java.text.ParseException

Sets the starting date range.

Parameters:

start—the starting date range

Throws:

java.text.ParseException—if the date cannot be parsed

1.2.3.15 getEndDate

public java.lang.String getEndDate ( )

Provides the ending date range.

Returns:

the ending date range

1.2.3.16 setEndDate

public void setEndDate(java.lang.String end)

throws java.text.ParseException

Sets the ending date range.

Parameters:

end—the ending date range

Throws:

java.text.ParseException—if the date cannot be parsed

### 1.2.4 CLASS ITEMFIELDDATECOMPARATOR

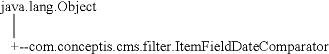

All Implemented Interfaces:

java.util.Comparator

public class ItemFieldDateComparator

extends java.lang.Object

implements java.util.Comparator

Comparator that is able to compare an Item's field value to a Date.

Field Summary

| | |
|---|---|
| private java.lang.String | fieldName |
| | The field name to compare to. |
| private | log |
| static org.apache.log4j.Logger | For logging purposes. |

### Constructor Summary

ItemFieldDateComparator ( )

Method Summary

| | |
|---|---|
| int | compare(java.lang.Object o1, java.lang.Object o2) |
| | Compares two objects, which may be ItemS or DateS. |
| java.lang.String | getFieldName( ) |
| | Provides the field name to use in the comparison. |
| void | setFieldName(java.lang.String fieldName) |
| | Sets the field name to use in the comparison. |

Methods inherited from class java.lang.Object

clone, equals, finalize, getClass, hashCode, notify, notifyAll, toString, wait, wait, wait

Methods inherited from interface java.util.Comparator

equals

### Field Detail

1.2.4.1 log

private static org.apache.log4j.Logger log

For logging purposes.

1.2.4.2 fieldName

private java.lang.String fieldName

The field name to compare to.

### Constructor Detail

1.2.4.3 ItemFieldDateComparator

public ItemFieldDateComparator ( )

### Method Detail

1.2.4.4 getFieldName

public java.lang.String getFieldName ( )

Provides the field name to use in the comparison.

Returns:

the field name to use in the comparison

1.2.4.5 setFieldName

public void setFieldName(java.lang.String fieldName)

Sets the field name to use in the comparison.

Parameters:

fieldName—the fieldName to use in the comparison

1.2.4.6 compare

public int compare(java.lang.Object o1, java.lang.Object o2)

throws java.lang.ClassCastException

Compares two objects, which may be Items or Dates.

Specified by:

compare in interface java.util. Comparator

Parameters:

o1—the first object to compare

o2—the second object to compare

Returns:

a negative integer, zero, or a positive integer as the first argument is less than, equal to, or greater than the second

Throws:

java. lang. ClasscastException—if the arguments' types prevent them from being compared by this Comparator

### 1.2.5 CLASS ITEMFIELDDATERANGEFILTER

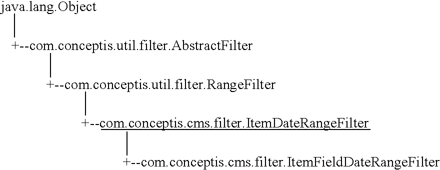

All Implemented Interfaces:

com.conceptis.util.filter.Filter

public class ItemFieldDateRangeFilter

extends ItemDateRangeFilter

Filters a Collection of Items using a date field and a range of dates.

### Field Summary

Fields inherited from class com.conceptis.cms.filter.ItemDateRangeFilter

DEFAULT PATTERN

### Constructor Summary

ItemFieldDateRang Filter ( )

Method Summary

| | |
|---|---|
| java.lang.String | getFieldName( ) |
| | Provides the fieldName being used to filter the results. |
| void | setFieldName(java.lang.String fieldName) |
| | Sets the fieldName to use. |

Methods inherited, from class com.conceptis.cms.filter.ItemDateRangeFilter

getEndDate, getLocale, getpattern, getStartDate, parseLocale, setEndDate, setLocale, setPattern, setStartDate

Methods inherited from class com.conceptis.util.filter.RangeFilter

filter, getComparator, getEnd, getStart, isInclusive, isInside, setComparator, setEnd, setInclusive, setInside, setStart

Methods inherited from class com.conceptis.util.filter.AbstractFilter

filter

Methods inherited from class java.lang.Object

clone, equals, finalize, getClass, hashCode, notify, notifyAll, toString, wait, wait, wait

### Constructor Detail

1.2.5.1 ItemFieldDateRangeFilter

public ItemFieldDateRangeFilter ( )

### Method Detail

1.2.5.2 getFieldName

public java.lang.String getFieldName ( )

Provides the fieldName being used to filter the results.

Returns:

the fieldName being used to filter the results

1.2.5.3 setFieldName

public void setFieldName(java.lang.String fieldName)

Sets the fieldName to use.

Parameters:

fieldName—the fieldName to use

### 1.2.6 CLASS ITEMFIELDREGEXFILTER

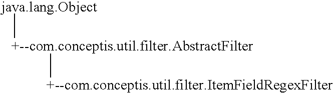

All Implemented Interfaces:

com.conceptis.util.filter.Filter

public class ItemFieldRegexFilter

extends com.conceptis.util.filter.AbstractFilter

Filters a Collection of Items using a field of the item, and matching it with a regular expression.

Field Summary

| | |
|---|---|
| private java.lang.String | fieldName |
| | The field name used for filtering. |
| private | log |
| static org.apache.log4j.Logger | For logging purposes. |
| private | pattern |
| java.util.regex.Pattern | The Pattern used for filtering. |
| private java.lang.String | regexp |
| | The regular expression used for filtering. |

### Constructor Summary

ItemFieldRegexFilter ( )

Method Summary

| | |
|---|---|
| boolean | filter(java.lang.Object obj) |
| | Indicates whether an Object passes this filter. |
| java.lang.String | getFieldName( ) |
| | Provides the name of the field being filtered on. |
| java.lang.String | getRegexp( ) |
| | Provides the regular expression used for filtering. |
| void | setFieldName(java.lang.String fieldName) |
| | Sets the name of the field being filtered on. |
| void | setRegexp(java.lang.String regexp) |
| | Sets the regular expression used for filtering. |

Methods inherited from class com.conceptis.util.filter.AbstractFilter

filter

Methods inherited from class java.lang.Object

clone, equals, finalize, getClass, hashCode, notify, notifyAll, toString, wait, wait, wait

### Field Detail

1.2.6.1 log

private static org.apache.log4j.Logger log

For logging purposes.

1.2.6.2 fieldName

private java.lang.String fieldName

The field name used for filtering.

1.2.6.3 regexp

private java.lang.String regexp

The regular expression used for filtering.

1.2.6.4 pattern

private java.util.regex.Pattern pattern

The Pattern used for filtering.

### Constructor Detail

### 1.2.7 ITEMFIELDREGEXFILTER

public ItemFieldRegexFilter ( )

### Method Detail

1.2.7.1 filter

public boolean filter(java.lang.object obj)

Indicates whether an Object passes this filter.

Parameters:

obj—the object to pass through the filter.

Returns:

true if the object passes, false otherwise

1.2.7.2 getFieldName

public java.lang.String getFieldName ( )

Provides the name of the field being filtered on.

Returns:

the name of the field being filtered on

1.2.7.3 setFieldName

public void setFieldName(java.lang.String fieldName)

Sets the name of the field being filtered on.

Parameters:

fieldName—the name of the field to filter on

1.2.7.4 getRegexp

public java.lang.String getRegexp ( )

Provides the regular expression used for filtering.

Returns:

the regular expression used for filtering

1.2.7.5 setRegexp

public void setRegexp(java.lang.String regexp)

throws java.util.regex.PatternSyntaxException

Sets the regular expression used for filtering.

Parameters:

regexp—the regular expression used for filtering

Throws:

java.util. regex. PatternSyntaxException—if the regular expression could not be compiled

### 1.2.8 CLASS ITEMITEMTYPEFILTER

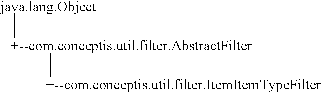

All Implemented Interfaces:

com.conceptis.util.filter.Filter

public class ItemItemTypeFilter

extends com.conceptis.util.filter.AbstractFilter

Filters a Collection of Items using the ItemType.

Field Summary

| | |
|---|---|
| private boolean | included |
| | Whether to include or exclude |
| | items of the type. |
| private | log |
| static org.apache.log4j.Logger | For logging purposes. |
| private java.lang.String | type |
| | The name of the ItemType to filter on. |

### Constructor Summary

ItemItemTypeFilter ( )

Method Summary

| | |
|---|---|
| boolean | filter(java.lang.Object obj) |
| | indicates whether an Object passes this filter. |
| java.lang.String | getItemType( ) |
| | Provides the ItemType that is being used by the filter. |
| boolean | isIncluded( ) |
| | Indicates whether the filter will include or exclude |
| | items of the specified type. |
| void | setIncluded(boolean included) |
| | Sets whether the filter will include or exclude items of |
| | the specified type. |
| void | setItemType(java.lang.String type) |
| | Sets the ItemType to be used by the filter. |

Methods inherited from class com.conceptis.util.filter.AbstractFilter

filter

Methods inherited from class java.lang.Object

clone, equals, finalize, getClass, hashCode, notify, notifyAll, toString, wait, wait, wait

### Field Detail

1.2.8.1 log

private static org.apache.log4j.Logger log

For logging purposes.

1.2.8.2 type

private java.lang.String type

The name of the ItemType to filter on.

1.2.8.3 included

private boolean included

Whether to include or exclude items of the type.

### Constructor Detail

1.2.8.4 ItemItemTypeFilter

public ItemItemTypeFilter ( )

### Method Detail

1.2.8.5 getItemType

public java.lang.String getItemType ( )

Provides the ItemType that is being used by the filter.

Returns:

the item type being used by the filter

1.2.8.6 setItemType

public void setItemType(java.lang.String type)

Sets the ItemType to be used by the filter.

Parameters:

type—the item type to be used by the filter

1.2.8.7 isIncluded

public boolean isIncluded ( )

Indicates whether the filter will include or exclude items of thle specified type.

Returns:

true if items will be included, false otherwise

1.2.8.8 setIncluded

public void setIncluded(boolean included)

Sets whether the filter will include or exclude items of the specified type. Defaults to true.

Parameters:

included—true if the items will be included, false otherwise

1.2.8.9 filter

public boolean filter(java.lang.Object obj)

Indicates whether an Object passes this filter.

Parameters:

obj—the object to pass through the filter.

Returns:

true if the object passes, false otherwise

### 1.2.9 CLASS ITEMLASTMODIFICATIONDATECOMPARATOR

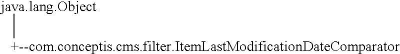

All Implemented Interfaces:

java.util.Comparator

public class ItemLastModificationDateComparator

extends java.lang.Object

implements java.util.Comparator

Comparator that is able to compare an Item's last modification date to a Date.

Field Summary

| | |
|---|---|
| private | log |
| static org.apache.log4j.Logger | For logging purposes. |

### Constructor Summary

ItemLastModificationDateComparator ( )

Method Summary

| | |
|---|---|
| int | compare(java.lang.Object o1, java.lang.Object o2) |
| | Compares two objects, which may be ItemS or DateS. |

Methods inherited from class java.lang.Object

clone, equals, finalize, getClass, hashCode, notify, notifyAll, toString, wait, wait, wait

Methods inherited from interface java.util.Comparator

equals

### Field Detail

1.2.9.1 log

private static org.apache.log4j.Logger log

For logging purposes.

### Constructor Detail

1.2.9.2 ItemLastModificationDateComparator

public ItemLastModificationDateComparator ( )

### Method Detail

1.2.9.3 compare

public int compare(java.lang.Object o1, java.lang.Object o2)

throws java.lang.ClassCastException

Compares two objects, which may be Items or Dates.

Specified by:

compare in interface j ava.util Comparator

Parameters:

o1—the first object to compare

o2—the second object to compare

Returns:

a negative integer, zero, or a positive integer as the first argument is less than, equal to, or greater than the second

Throws:

java. lang. ClasscastException—if the arguments' types prevent them from being compared by this Comparator

### 1.2.10 CLASS ITEMLASTMODIFICATIONDATEFILTER

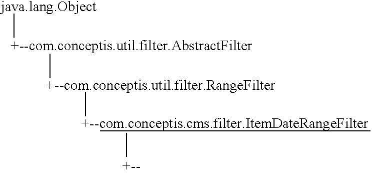

All Implemented Interfaces:

com.conceptis.util.filter.Filter

public class ItemLastModificationDateFilter

extends ItemDateRangeFilter

Filters a Collection of Items using the last modified date and a range of dates.

Field Summary

| | |
|---|---|
| private | comparator |
| static java.util.Comparator | The comparator to use. |

Fields inherited from class com.conceptis.cms.filter.ItemDateRangeFilter

DEFAULT PATTERN

Field inherited from class com.conceptis.util.filter.RangeFilter

### Constructor Summary

ItemLastModificationDateFilter ( )

Creates a new filter.

Methods inherited from class com.conceptis.cms.filter.ItemDateRangeFilter

getEndDate, getLocale, getPattern, getStartDate, parseLocale, setEndDate, setLocale, setPattern, setStartDate

Methods inherited from class com.conceptis.util.filter.RangeFilter

Filter, getComparator, getEnd, getStart, isInclusive, isInside, setComparator, setEnd, setInclusive, setInside, setStart

Methods inherited from class com.conceptis.util.filter.AbstractFilter

filter

Methods inherited from class java.lang.Object

clone, equals, finalize, getClass, hashCode, notify, notifyAll, toString, wait, wait, wait

### Field Detail

1.2.10.1 comparator

private static java.util.Comparator comparator

The comparator to use.

### Constructor Detail

1.2.10.2 ItemLastModificationDateFilter

public ItemLastModificationDateFilter ( )

Creates a new filter.

### 1.2.11 CLASS ITEMLASTMODIFICATIONUSERFILTER

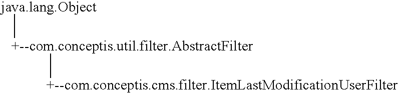

All Implemented Interfaces:

com.conceptis.util.filter.Filter

public class ItemLastModificationUserFilter

extends com.conceptis.util.filter.AbstractFilter

Filters a Collection of Items using the last user to modify (username).

Field Summary

| | |
|---|---|
| private boolean | included |
| | Whether to include or exclude |
| | items of the type. |
| private | log |
| static org.apache.log4j.Logger | For logging purposes. |
| private java.lang.String | username |
| | The username of the user to filter on. |

### Constructor Summary

ItemLastModificationUserFilter ( )

Method Summary

| | |
|---|---|
| boolean | filter(java.lang.Object obj) |
| | Indicates whether an Object passes this filter. |
| java.lang.String | getUsername( ) |
| | Provides the username that is being used by the filter. |
| boolean | isIncluded( ) |
| | Indicates whether the filter will include or exclude |
| | items of the specified type. |
| void | setIncluded(boolean included) |
| | Sets whether the filter will include or exclude items |
| | of the specified type. |
| void | setUsername(java.lang.String username) |
| | Sets the username to be used by the filter. |

Methods inherited from class com.conceptis.util.filter.AbstractFilter

filter

Methods inherited from class java.lang.Object

clone, equals, finalize, getClass, hashCode, notify, notifyAll, toString, wait, wait, wait

### Field Detail

1.2.11.1 log

private static org.apache.log4j.Logger log

For logging purposes.

1.2.11.2 username

private java.lang.String username

The username of the user to filter on.

1.2.11.3 included

private boolean included

Whether to include or exclude items of the type.

### Constructor Detail

1.2.11.4 ItemLastModificationUserFilter

public ItemLastModificationUserFilter ( )

1.2.11.5 getUsername

public java.lang.String getUsername ( )

Provides the Username that is being used by the filter.

Returns:

the username being used by the filter

1.2.11.6 setUsername

public void setUsername(java.lang.String username)

Sets the username to be used by the filter.

Parameters:

Username—the Username to be used by the filter

1.2.11.7 isIncluded

public boolean isIncluded ( )

Indicates whether the filter will include or exclude items of the specified type.

Returns:

true if items will be included, false otherwise

1.2.11.8 setIncluded

public void setInclud d(boolean included)

Sets whether the filter will include or exclude items of the specified type.

Parameters:

included—true if the items will be included, false otherwise

1.2.11.9 filter

public boolean filter(java.lang.object obj)

Indicates whether an Object passes this filter.

Parameters:

obj—the object to pass through the filter.

Returns:

true if the object passes, false otherwise

### 1.2.12 CLASS ITEMNAMECOMPARATOR

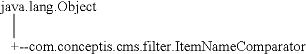

All Implemented Interfaces:

java.util.Comparator

public class ItemNameComparator

extends java.lang.Object

implements java.util.Comparator

Comparator that is able to compare an Item's names.

Field Summary

| | |
|---|---|
| private | log |
| static org.apache.log4j.Logger | For logging purposes. |
| private boolean | reverse |
| | Reverses the order. |

### Constructor Summary

ItemNameComparator ( )

Creates a comparator.

ItemNameComparator(boolean reverse)

Creates a comparator.

Method Summary

| | |
|---|---|
| int | compare(java.lang.Object o1, java.lang.Object o2) |
| | Compares two objects, which may be Items or Dates. |

Methods inherited from class java.lang.Object

clone, equals, finalize, getClass, hashCode, notify, notifyAll, toString, wait, wait, wait

Methods inherited from interface java.util.Comparator

equals

### Field Detail

1.2.12.1 log

private static org.apache.log4j.Logger log

For logging purposes.

1.2.12.2 reverse

private boolean reverse

Reverses the order.

### Constructor Detail

1.2.12.3 ItemNameComparator

public ItemNameComparator ( )

Creates a comparator.

1.2.12.4 ItemNameComparator

public ItemNameComparator(boolean reverse)

Creates a comparator.

Parameters:

reverse—true if the order is to be reversed

### Method Detail

1.2.12.5 compare

public int compare(java.lang.Object o1, java.lang.Object o2)

throws java.lang.ClassCastException

Compares two objects, which may be Items or Dates.

Specified by:

compare in interface java.util.Comparator

Parameters:

o1—the first object to compare

o2—the second object to compare

Returns:

a negative integer, zero, or a positive integer as the first argument is less than, equal to, or greater than the second

Throws:

java.lang.ClassCastException—if the arguments'types prevent them from being compared by thius Comparator

### 1.2.13 CLASS ITEMPUBLICATIONSTATUSFILTER

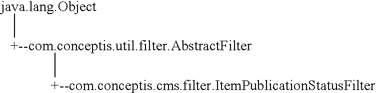

All Implemented Interfaces:

com.conceptis.util.filter.Filter

public class ItemPublicationStatusFilter

extends com.conceptis.util.filter.AbstractFilter

Filters a Collection of Items using the PublicationStatus.

Field Summary

| | |
|---|---|
| private boolean | included |
| | Whether to include or exclude |
| | items of the type. |
| private | log |
| static org.apache.log4j.Logger | For logging purposes. |
| private java.lang.String | status |
| | The name of the PublicationStatus |
| | to filter on. |

### Constructor Summary

ItemPublicationStatusFilter ( )

Method Summary

| | |
|---|---|
| boolean | filter(java.lang.Object obj) |
| | Indicates whether an Object passes this filter. |
| java.lang.String | getPublicationStatus( ) |
| | Provides the PublicationStatus that is being |
| | used by the filter. |
| boolean | isIncluded( ) |
| | Indicates whether the filter will include or |
| | exclude items of the |
| | specified type. |
| void | setIncluded(boolean included) |
| | Sets whether the filter will include or exclude |
| | items of the specified type. |
| void | setPublicationStatus (java.lang.String status) |
| | Sets the PublicationStatus to be used by the filter. |

Methods inherited from class com.conceptis.util.filter.AbstractFilter

filter

Methods inherited from class java.lang.Object

clone, equals, finalize, getClass, hashCode, notify, notifyAll, toString, wait, wait, wait

### Field Detail

1.2.13.1 log

private static org.apache.log4j.Logger log

For logging purposes.

1.2.13.2 status

private java.lang.String status

The name of the PublicationStatus to filter on.

1.2.13.3 included

private boolean included

Whether to include or exclude items of the type.

Constructor Detail

1.2.13.4 ItemPublicationStatusFilter

public ItemPublicationStatusFilter ( )

### Method Detail

1.2.13.5 getPublicabonStatus

public java.lang.String getPublicationStatus ( )

Provides the PublicationStatus that is being used by the filter.

Returns:

the status being used by the filter

1.2.13.6 setPublicationStatus public void setPublicationStatus(java.lang.String status)

Sets the PublicationStatus to be used by the filter.

Parameters:

status—the item status to be used by the filter

1.2.13.7 isIncluded

public boolean isIncluded ( )

Indicates whether the filter will include or exclude items of the specified type.

Returns:

true if items will be included, false otherwise

1.2.13.8 setIncluded

public void setIncluded(boolean included)

Sets whether the filter will include or exclude items of the specified type.

Parameters:

included—true if the items will be included, false otherwise

1.2.13.9 filter

public boolean filter(java.lang.object obj)

Indicates whether an Object passes this filter.

Parameters:

obj—the object to pass through the filter.

Returns:

true if the object passes, false otherwise

### 1.2.14 CLASS OBJECTWITHPRIMARYKEYCOMPARATOR

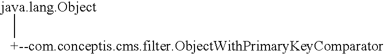

All Implemented Interfaces:

java.util.Comparator

public class ObjectWithPrimaryKeyComparator

extends java.lang.Object

implements java.util.Comparator

Comparator that utilizes an object's PrimaryKey to sort a collection.

Field Summary

| | |
|---|---|
| private boolean | ascending |
| | Whether to sort ascending or descending. |
| private | log |
| static org.apache.log4j.Logger | For logging purposes. |

### Constructor Summary

ObjectWithPrimaryKeyComparator ( )

Method Summary

| | |
|---|---|
| int | compare(java.lang.Object o1, java.lang.Object o2) |
| | Compares its two arguments for order. |
| boolean | isAscending( ) |
| | Indicates whether the comparator is sorting in |
| | an ascending or descending manner. |
| void | setAscending (boolean ascending) |
| | Sets whether the comparator is sorting in an |
| | ascending or descending manner. |

Methods inherited from class java.lang.Object

clone, equals, finalize, getClass, hashCode, notify, notifyAll, toString, wait, wait, wait

Methods inherited from interface java.util.Comparator

equals

### Field Detail

1.2.14.1 log

private static org.apache.log4j.Logger log

For logging purposes.

1.2.14.2 ascending

private boolean ascending

Whether to sort ascending or descending.

### Constructor Detail

1.2.14.3 ObjectWithPrimaryKeyCompartor

public ObjectwithPrimaryKeyComparator ( )

### Method Detail

1.2.14.4 isAscending

public boolean isAscending ( )

Indicates whether the comparator is sorting in an ascending or descending manner.

Returns:

true if the comparator is ascending, false if descending

1.2.14.5 setAscending

public void setAscending(boolean ascending)

Sets whether the comparator is sorting in an ascending or descending manner.

Parameters:

ascending—true if the comparator is ascending, false otherwise

1.2.14.6 compare

public int compare(java.lang.Object o1, java.lang.Object o2)

throws java.lang.ClassCastException

Compares its two arguments for order. Returns a negative integer, zero, or a positive integer as the first argument is less than, equal to, or greater than the second.

Specified by:

compare in interface java.util.Comparator

Parameters:

o1—the first object to be compared

o2—the second object to be compared

Returns:

a negative integer, zero, or a positive integer as the first argument is less than, equal to, or greater than the second

Throws:

java.lang.ClassCastException—if the arguments' types prevent them from being compared by this Comparator cl 1.3 PACKAGE COM.CONCEPTIS.CMS.UTIL

### 1.3.1 CLASS CMSMANAGERFACTORY

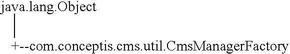

public class CmsManagerFactory

extends java.lang.Object

This class is used to get a CmsManager

See Also:

CmsServer

### Constructor Summary

CmsManagerFactory ( )

Method Summary

| | |
|---|---|
| CmsManager | getCmsManager( ) |
| | get a CmsManager |

Methods inherited from class java.lang.Object

clone, equals, finalize, getClass, hashCode, notify, notifyAll, toString, wait, wait, wait

### Constructor Detail

1.3.1.1 CmsManagerFactory

public CmsManagerFactory ( )

### Method Detail

1.3.1.2 getCmsManager

public CmsManager getCmsManager ( )

get a CmsManager

Returns:

CmsManager

### 1.3.2 CLASS CMSSERVER

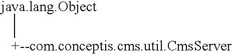

Direct Known Subclasses:

PoolingCmsServer, PseudoPoolingCmsServer

public class CmsServer

extends java.lang.Object

A CmsServer represents a CMS server and provides a useful single point of entry to get and return Connections.

Field Summary

| | |
|---|---|
| private Driver | driver |
| | The Driver to use for this CmsServer. |
| private java.lang.String | id |
| | The unique ID of this CmsServer |
| private | log |
| static org.apache.log4j.Logger | the log |
| private java.util.Properties | properties |
| | Configuration options for the ConnectionS |
| private java.util.HashMap | roleMapping |
| | A HashMap of roles (String key) |
| | associated with a username/ |
| | password pair (value stored |
| | in another HashMap, |
| | with ‘username’ and |
| | ‘password’ keys). |
| private java.lang.String | url |
| | The URL that will be used to get a |
| | Connection to |
| | the CmsServer. |

### Constructor Summary

CmsServer(java.lang.String id, java.lang.String driverClassName, java.lang.String url, java.util.HashMap roleMapping, java.util.Properties properties)

Creates a new CmsServer that will create Connections using the given URL and properties.

Method Summary

| | |
|---|---|
| (package private) | getConnection(java.lang.String role) |
| Connection | Returns a Connection to this CmsServer, using the |
| | specified driver, url and properties. |
| Driver | getDriver( ) |
| | Returns the Driver used by this CmsServer to |
| | establish Connection to the CMS. |
| java.lang.String | getId( ) |
| | Returns the unique ID associated to this CmsServer. |
| java.util.Properties | getProperties( ) |
| | Return the Properties used by this CmsServer to |
| | establish ConnectionS to the CMS. |
| java.util.Properties | getProperties(java.lang.String role) |
| | Return the Properties used by this CmsServer to |
| | establish ConnectionS to the CMS and using the |
| | specified role. |
| java.util.HashMap | getRoleMapping( ) |
| | Returns the HashMap of roles (String key) |
| | associated with a username/password pair |
| | (value stored in a Properties class, with |
| | ‘username’ and ‘password’ keys). |
| java.lang.String | getUrl( ) |
| | Returns the URL used by this CmsServer to |
| | establish Connection to the CMS. |
| (package private) | returnConnection(Connection connection) |
| void | Returns the given Connection to this CmsServer, |
| | that will dispose of it. |
| java.lang.String | toString( ) |
| | Returns a String representation of this CmsServer. |

Methods inherited from class java.lang.Object

clone, equals, finalize, getClass, hashCode, notify, notifyAll, wait, wait, wait

### Field Detail

1.3.2.1 log

private static org.apache.log4j.Logger log

the log

1.3.2.2 id

private java.lang.String id

The unique ID of this CmsServer

1.3.2.3 driver

private Driver driver

The Driver to use for this CmsServer.

1.3.2.4 url

private java.lang.String url

The URL that will be used to get a Connection to the CmsServer.

1.3.2.5 roleMapping

private java.util.HashMap role Mapping

A HashMap of roles (String key) associated with a username/password pair (value stored in another HashMap, with ‘username’ and ‘password’ keys).

1.3.2.6 properties

private java.util.Properties properties

Configuration options for the Connections

### Constructor Detail

1.3.2.7 CmsServer

public CmsServer(java.lang.String id, java.lang.String driverClassName, java.lang.String url, java.util.HashMap roleMapping, java.util.Properties properties)

throws java.lang.IllegalArgumentException

Creates a new CmsServer that will create Connections using the given URL and properties.

Parameters:

id—the unique ID of this CmsServer

driverClassName—the fully qualifed name of the Driver

url—the url to open a connection to

roleMapping—a HashMap of roles (String key) associated with a username/password

pair (value stored in a Properties class)

properties—configuration options for the desired connection

Throws:

java. lang. IllegalArgumentException—if one of the parameters is not valid

### Method Detail

1.3.2.8 getConnection

Connection getConnection(java.lang.String role)

throws ConnectionException, AuthenticationException, AuthorizationException

Returns a Connection to this CmsServer, using the specified driver, url and properties.

Parameters:

role—the user role to create the Connection for

Returns:

a Connection to this CmsServer.

Throws:

ConnectionException—thrown if there is a problem

AuthenticationException—thrown if the username/password combination is invalid

AuthorizationException—if the site is inaccessible

1.3.2.9 returnConnection

void returnConnection(Connection connection)

Returns the given Connection to this CmsServer, that will dispose of it. The default implementation juste closes the Connection, logging any Exception that may occur during this operation.

Parameters:

connection—the Connection to return to this CmsServer

1.3.2.10 getld

public java.lang.String getId ( )

Returns the unique ID associated to this CmsServer.

Returns:

the unique ID associated to this CmsServer

1.3.2.11 getDriver

public Driver getDriver ( )

Returns the Driver used by this CmsServer to establish Connection to the CMS.

Returns:

the Driver used by this CmsServer

1.3.2.12 getUrl

public java.lang.String getUrl ( )

Returns the URL used by this CmsServer to establish Connection to the CMS.

Returns:

the URL used by this CmsServer

1.3.2.13 getRoleMapping

public java.util.HashMap getRoleMapping ( )

Returns the HashMap of roles (String key) associated with a username/password pair (value stored in a Properties class, with ‘username’ and ‘password’ keys).

Returns:

the HashMap of roles

1.3.2.14 getProperties

public java.util.Properties getproperties ( )

Return the Properties used by this CmsServer to establish Connections to the CMS.

Returns:

the Properties used by this CmsServer

1.3.2.15 getProperties

public java.util.Properties getProperties(java.lang.String role)

throws java.lang.IllegalArgumentException

Return the Properties used by this CmsServer to establish Connections to the CMS and using the specified role.

Parameters:

role—the role for which the returned Properties are designed for

Returns:

the Properties used by this CmsServer and using the specified role

Throws:

java. lang. IllegalArgumentException—if the specified role is not supported

1.3.2.16 toString

public java.lang.String toString ( )

Returns a String representation of this CmsServer.

Overrides:

toS.string in class java. lang.Object

Returns:

a String representation of this CmsServer

### 1.3.3 CLASS CONNECTIONPOOL

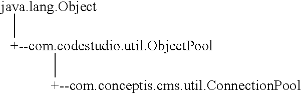

All Implemented Interfaces:

com.codestudio.util.Pool,java.io.Serializable

public class ConnectionPool

extends com.codestudio.ufil.ObjectPool

A ConnectionPool is used by a PoolingcmsServer to pool Connections to a CMS.

See Also:

Serialized Form

Field Summary

| | |
|---|---|
| private Driver | driver |
| | The Driver to use to establish a |
| private | Connection log |
| static org.apache.log4j.Logger | the log |
| private java.util.Properties | properties |
| | the Properties to use to establish a |
| private java.lang.String | Connection url |
| | the url to use to establish a Connection |

Fields inherited from class com.codestudio.util.ObjectPool

count, lifeguard, locked, logger, metadata, skimmer, unlocked

### Constructor Summary

ConnectionPool (Driver driver, java.lang.String url, java.util.Properties properties, com.codestudio.util.PoolMetaData poolMetaData)

Creates a new CmsServer that will create Connections using the given URL and properties.

Method Summary

| | |
|---|---|
| protected | create( ) |
| java.lang.Object | Creates a new Connection instance |
| protected void | expire(java.lang.Object obj) |
| | Closes the Connection. |
| private void | setDriver(Driver driver) |
| | Sets the Driver to use to establish a Connection |
| private void | setProperties(java.util.Properties properties) |
| | Sets the Properties to use to establish a Connection |
| private void | setUrl(java.lang.String url) |
| | Sets the url to use to establish a Connection |
| java.lang.String | toString( ) |
| | Returns a string representation of this ConnectionPool, |
| | which is mainly useful for debugging. |
| protected | validate(java.lang.Object obj) |
| boolean | Validates a Connection. |

Methods inherited from class com.codestudio.util.ObjectPool

checkIn, checkOut, checkTimeout, cleanUp, closeAllResources, debug, debug, debugMetrics, finalize, getPoolname, init, log, log, numCheckedInObjects, numCheckedOutobjects, numTotalobjects, requestobject, returnobject

Methods inherited from class java.lang.Object

clone, equals, getClass, hashCode, notify, notifyAll, wait, wait, wait

### Field Detail

1.3.3.1 log

private static org.apache.log4j.Logger log

1.3.3.2 driver

private Driver driver

The Driver to use to establish a Connection

1.3.3.3 url

private java.lang.String url

the url to use to establish a Connection

1.3.3.4 properties

private java.util.Properties properties

the Properties to use to establish a Connection

### Constructor Detail

1.3.3.5 ConnectionPool

public ConnectionPool(Driver driver, java.lang.String url, java.util.Properties properties, com.codestudio.util.PoolMetaData poolMetaData)

throws java.lang.Exception

Creates a new CmsServer that will create Connections using the given URL and properties.

Parameters:

driver—the Driver to use to establich a Connection

url—the url to open a connection to

properties—configuration options for the desired connection

poolMetaData—specific pooling configuration, encapsulated in a PoolMetaData object

Throws:

java.lang.Exception—if an error occurs while initalizong this pool

### Method Detail

1.3.3.6 create

protected java.lang.Object create ( )

throws java.lang.Exception

Creates a new Connection instance

Specified by:

create in class com.codestudio.util.ObjectPool

Returns:

a new Connection

Throws:

java.lang.Exception—if the Connection creation encounters a problem

1.3.3.7 expire

protected void expire(java.lang.object obj)

Closes the Connection.

Overrides:

expire in class com. codestudio.util.ObjectPool

Parameters:

obj—the pooled object to kill

1.3.3.8 validate

protected boolean validate(java.lang.Object obj)

Validates a Connection.

Specified by:

validate in class com.codestudio.util.ObjectPool

Parameters:

obj—the Connection to validate

Returns:

true if the Connection is valid; false otherwise

1.3.3.9 setDriver

private void setDriver(Driver driver)

Sets the Driver to use to establish a Connection

Parameters:

driver—the Driver to use to establish a Connection

1.3.3.10 setUrl

private void setUrl(java.lang.String url)

Sets the url to use to establish a Connection

Parameters:

url—the url to use to establish a Connection

1.3.3.11 setProperties

private void setProperties(java.util.Properties properties)

Sets the Properties to use to establish a Connection

Parameters:

properties—the Properties to use to establish a Connection

1.3.3.12 toString

public java.lang.String toString ( )

Returns a string representation of this ConnectionPool, which is mainly useful for debugging.

Overrides:

toString in class java.lang.Object

Returns:

a string representation of this ConnectionPool

### 1.3.4 CLASS DEFAULTCMSMANAGERIMPL

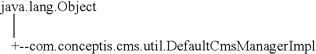

All Implemented Interfaces:

CmsManager

public class DefaultCmsManagerImpl

extends java.lang.Object

implements CmsManager

This class is a default CmsManager implementation. TODO:DESCRIBE ROUTING LOGIC HERE (WHEN IT'S IMPLEMENTED)

Field Summary

| | |
|---|---|
| private java.util.HashMap | cmsServers |
| | This HashMap contains all the CMS |
| | servers defined in the |
| | configuration file. |
| private java.util.HashMap | connections |
| | A HashMap of ConnectionS and |
| | CmsServerS, used to link a returned |
| | Connection to its originating |
| | CmsServer. |
| private CmsServer | defaultCmsServer |
| | The default CmsServer |
| private java.util.HashMap | itemTypeHandlers |
| | The associations between ItemTypeS and |
| | a specific CmsServer: the key is the |
| | ItemType name, and the value is the |
| | CmsServer that will handle it. |
| private | log |
| static org.apache.log4j.Logger | the log |

### Constructor Summary

DefaultCmsManagerImpl ( )

Method Summary

| | |
|---|---|
| void | addCmsServer(CmsServer cmsServer) |
| | Adds a CmsServer to the list of available servers. |
| private | addItemTypeHandler(java.lang.String itemTypeName, |
| void | CmsServer cmsServer) |
| | Adds a ItemType to the routing logic, associated with |
| | the specified CmsServer. |
| void | addRoutingProperty(CmsServer cmsServer, |
| | java.lang.String propertyName, java.lang.String |
| | propertyValue) |
| | Adds a routing property to this CmsManager for the |
| | specified CmsServer. |
| CmsServer | getCmsServer(java.lang.String id) |
| | Returns the CmsServer that has the specified ID. |
| private | getConnection(CmsServer cmsServer, java.lang.String role) |
| Connection | get a connection with role |
| Connection | getConnection(java.lang.String role) |
| | get a Connection with role |
| Connection | getConnection(java.lang.String role, |
| | java.lang.String itemTypeName) |
| | get a Connection with role and typeName |
| void | releaseConnection(Connection conn) |
| | release the Connection to the Connection Pool. |
| private | setDefaultCmsServer(CmsServer defaultCmsServer) |
| void | Sets the default CmsServer bor this CmsManager. |

Methods inherited from class java.lang.Object

clone, equals, finalize, getClass, hashCode, notify, notifyAll, toString, wait, wait, wait

### Field Detail

1.3.4.1 log

private static org.apache.log4j.Logger log

the log

1.3.5 CMSSERVERS

private java.util.HashMap cmsServers

This HashMap contains all the CMS servers defined in the configuration file. The key is the unique ID associated to the CmsServer.

1.3.5.1 defaultCmsServer

private CmsServer defaultCmsServer

The default CmsServer

1.3.5.2 connections

private java.util.HashMap connections

A HashMap of connections and CmsServers, used to link a returned Connection to its originating CmsServer.

1.3.5.3 itemTypeHandlers

private java.util.HashMap itemTypeHandlers

The associations between ItemTypes and a specific CmsServer: the key is the ItemType name, and the value is the CmsServer that will handle it.

### Constructor Detail

1.3.5.4 DefaultCmsManagerImpl

public DefaultCmsManagerImpl ( )

### Method Detail

1.3.5.5 addCmsServer

public void addCmsserver(CmsServer cmsServer)

Adds a CmsServer to the list of available servers.

Specified by:

addCmsServer in interface CmsManager

Parameters:

cmsServer—the CmsServer to add to the list of available CmsServers for this CmsManager

1.3.5.6 addRoutingProperty

public void addRoutingProperty(CmsServer cmsServer, java.lang.String propertyName, java.lang.String propertyvalue)

Adds a routing property to this CmsManager for the specified CmsServer.

Specified by:

addRoutingProperty in interface CmsManager

Parameters:

cmsServer—the CmsServer concerned by this routing rule

propertyName—the name of the property

propertyValue—the value of the property

1.3.5.7 setDefaultCmsServer

private void setDefaultCmsServer(CmsServer defaultCmsServer)

Sets the default CmsServer bor this cmsManager.

Parameters:

defaultCmsServer—the default CmsServer for this cmsManager

1.3.5.8 addItemTypeHandler

private void addItemTypeHandler(java.lang.String itemTypeName, CmsServer cmsServer)

Adds a ItemType to the routing logic, associated with the specified CmsServer.

Parameters:

itemTypeName—the name the will be used to identify the ItemType

cmsServer—the CmsServer that will handle the specified ItemType identified by the itemTypeName parameter

1.3.5.9 getCmsServer

public CmsServer getCmsServer(java.lang.String id)

Returns the CmsServer that has the specified ID.

Specified by:

getCmsServer in interface CmsManager

Parameters:

id—ths unique ID of the CmsServer

Returns:

the cmsserver that has the specified ID; null if it doesn't exist

1.3.5.10 getConnection

private Connection getConnection(CmsServer cmsServer, java.lang.String role)

throws CmsException

get a Connection with role

Parameters:

cmsServer—the CmsServer to use

role—the user role

Returns:

a Connection

Throws:

CmsException—in case of errors

1.3.5.11 getConnection

public Connection getConnection(java.lang.String role)

throws CmsException

get a Connection with role

Specified by:

getconnection in interface CmsManager

Parameters:

role—the user role

Returns:

a Connection

Throws:

CmsException—in case of errors

1.3.5.12 getConnection

public Connection getConnection(java.lang.String role, java.lang.String itemTypeName)

throws CmsException

get a Connection with role and typeName

Specified by:

getConnection in interface CmsManager

Parameters:

role—the user role

itemTypeName—the name of the item type

Returns:

a Connection

Throws:

CmsException—in case of errors

1.3.5.13 releaseConnection

public void releaseconnection(Connection conn)

throws CmsException

release the Connection to the Connection Pool.

Specified by:

releaseConnection in interface CmsManager

Parameters:

conn—the Connection to release

Throws:

CmsException—in case of errors

### 1.3.6 CLASS NODEDATA

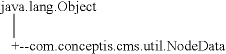

All Implemented Interfaces:

java.io.Serializable

public class NodeData

extends java.lang.Object

implements java.io.Serializable

This class represents an item in the CMS as a serializable object. It is made to be extended, containing only the primary key of the node.

See Also:

Serialized Form

Field Summary

| | |
|---|---|
| private | id |
| java.lang.String | The primary key of the node. |

### Constructor Summary

NodeData ( )

Method Summary

| | |
|---|---|
| java.lang.String | getId( ) |
| | Provides the id of the node. |
| void | setId(java.lang.String id) |
| | Sets the id of the node. |
| java.lang.String | toString( ) |
| | Provides a string representation of the object. |

Methods inherited from class java.lang.Object

clone, equals, finalize, getClass, hashCode, notify, notifyAll, wait, wait, wait

### Field Detail

1.3.6.1 id

private java.lang.String id

The primary key of the node.

### Constructor Detail

1.3.6.2 NodeData

public NodeData ( )

### Method Detail

1.3.6.3 getld

10 public java.lang.String getId ( )

Provides the id of the node.

Returns:

the id of the node

1.3.6.4 setId

public void setId(java.lang.string id)

Sets the id of the node.

Parameters:

id—the id of the node

1.3.6.5 toString

public java.lang.String toString ( )

Provides a string representation of the object.

Overrides:

toString in class java.lang.Object

Returns:

a string representation of the object

### 1.3.7 CLASS NODELOADER

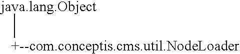

public abstract class NodeLoader

extends java.lang.Object

Generates a serializable representation of a node in the CMS.

Field Summary

| | |
|---|---|
| private org.apache.log4j.Logger | log |
| | Used to log. |
| private | root |
| javax.swing.tree.DefaultMutableTreeNode | The root node where we |
| | append children. |

### Constructor Summary

NodeLoader(javax.swing.tree.DefaultMutableTreeNode root)

Constructs a new NodeLoader.

Method Summary

| | |
|---|---|
| void | appendChildNode(javax.swing.tree.Default |
| | MutableTreeNode root) |
| | Append the child node to the parent |
| | (root). |
| abstract NodeData | generateNodeData(Item item, |
| | Connection conn) |
| | Generates a NodeData object using |
| | the values of the specified item. |
| abstract java.util.Set | getChildren(Item item, |
| | Connection conn) |
| | Provides the Set of children for the |
| | node. |
| javax.swing.tree.DefaultMutableTreeNode | getRoot( ) |
| | Provides the root where we append |
| | children. |
| abstract boolean | isExpandable(Item parent, |
| | Item child, Connection conn) |
| | Indicates whether a given node is |
| | expandable. |
| abstract boolean | isInsertable(Item parent, |
| | Item child, Connection conn) |
| | Indicates whether a given node is |
| | insertable into the tree. |
| void | loadNode( ) |
| | load the node |
| private void | recurseChild(Item item, |
| | javax.swing.tree.DefaultMutableTreeNode |
| | parent, Connection conn) |
| | recurse over child item and create a |
| | new node. |

Methods inherited from class java.lang.Object

clone, equals, finalize, getClass, hashCode, notify, notifyAll, toString, wait, wait, wait

### Field Detail

1.3.7.1 log

private org.apache.log4j.Logger log

Used to log.

1.3.7.2 root

private javax.swing.tree.DefaultMutableTreeNode root

The root node where we append children.

### Constructor Detail

1.3.7.3 NodeLoader

public NodeLoader(javax.swing.tree.DefaultMutableTreeNode root)

Constructs a new NodeLoader.

Parameters:

root—the root node to append to

### Method Detail

1.3.7.4 getRoot

public javax.swing.tree.DefaultMutableTreeNode getRoot ( )

Provides the root where we append children.

Returns:

the root where we append children

1.3.7.5 generateNodeData

public abstract NodeData generateNodeData(Itemitem, Connection conn)

Generates a NodeData object using the values of the specified item.

Parameters:

item—the item to generate a data object for

conn—the connection, to interact with the CMS

Returns:

a data object for the specified item

1.3.7.6 isExpandable

public abstract boolean isExpandable(Item parent, Item child, Connection conn)

Indicates whether a given node is expandable.

Parameters:

parent—the parent item to determine whether it's node is insertable

child—the child item to determine whether it's node is insertable

conn—the connection, to interact with the CMS

Returns:

true if the node is expandable, false otherwise

1.3.7.7 isinsertable

public abstract boolean isInsertable(Item parent, Item child, Connection conn)

Indicates whether a given node is insertable into the tree.

Parameters:

parent—the parent item to determine whether it's node is insertable

child—the child item to determine whether it's node is insertable

conn—the connection, to interact with the CMS

Returns:

true if the node is insertable, false otherwise

1.3.7.8 getchildren

public abstract java.util.Set getChildren(Itemitem, Connection conn)

Provides the Set of children for the node.

Parameters:

item—the parent item

conn—the connection, to interact with the CMS

Returns:

the set of children

1.3.7.9 loadNode

public void loadnode ( )

load the node

1.3.7.10 appendChildNode

public void appendChildNode(javax.swing.tree.DefaultMutableTreeNode root)

Append the child node to the parent (root).

Parameters:

root—the node parent

1.3.7.11 recurseChild

private void recurseChild(Item item, javax.swing.tree.DefaultMutableTreeNode parent, Connection conn)

throws CmsException

recurse over child item and create a new node.

Parameters:

item—the item to get child

parent—the Node parent to append to

conn—the Connection used to get the RelationTypeFactory

Throws:

CmsException—in case of errors

### 1.3.8 CLASS POOLINGCMSSERVER

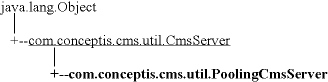

public class PoolingCmsServer

extends CmsServer

A CmsServer represents a CMS server and provides a useful single point of entry to get and return Connections.

Field Summary

| | |
|---|---|
| private java.util.HashMap | connectionPools |
| | A HashMap of ConnectionPoolS, |
| | one for each role. |
| private java.util.HashMap | connections |
| | A HashMap of ConnectionPool, |
| | associated with a Connection |
| private | log |
| static org.apache.log4j.Logger | the log |
| private | poolMetaData |
| com.codestudio.util.PoolMetaData | The PoolMetaData that will be used |
| | to create the ConnectionPoolS |
| | for each role. |

Fields inherited from class com.conceptis.cms.util.CmsServer

### Constructor Summary

PoolingCmsServer(java.lang.String id, java.lang.String driverClassName, java.lang.String url, java.util.HashMap roleMapping, java.util.Properties properties, com.codestudio.util.PoolMetaData poolMetaData)

Creates a new CmsServer that will create Connections using the given URL and properties.

Method Summary

| | |
|---|---|
| Connection | getConnection(java.lang.String role) |
| | Returns a Connection to this CmsServer, using the specified |
| | driver, url and properties. |
| void | returnConnection(Connection connection) |
| | Returns the given Connection to this CmsServer, that will |
| | dispose of it. |
| private | getPoolMetaData(com.codestudio.util.PoolMetaData |
| void | pool MetaData) Sets the PoolMetaData used by this |
| | PoolingCmsServer. |

Methods inherited from class com.conceptis.cms.util.CmsServer

getDriver, getId, getProperties, getProperties, getRoleMapping, getUrl, toString

Methods inherited from class java.lang.Object

clone, equals, finalize, getClass, hashCode, notify, notifyAll, wait, wait, wait

### Field Detail

1.3.8.1 log

private static org.apache.log4j.Logger log

the log

1.3.8.2 connectionPools

private java.util.HashMap connectionPools

A HashMap of Connectionpools, one for each role.

1.3.8.3 connections

private java.util.HashMap connections

A HashMap of ConnectionPool, associated with a Connection

1.3.8.4 poolMetaData

private com.codestudio.util.PoolMetaData poolMetaData

The PoolMetaData that will be used to create the ConnectionPools for each role.

### Constructor Detail

1.3.8.5 PoolingCmsServer

public PoolingCmsServer(java.lang.String id, java.lang.String driverClassName, java.lang.String url, java.util.HashMap roleMapping, java.util.Properties properties, com.codestudio.util.PoolMetaData poolMetaData)

throws java.lang.IllegalArgumentException

Creates a new CmsServer that will create Connections using the given URL and properties.

Parameters:

id—the unique ID of this CmsServer

driverClassName—the fully qualifed name of the Driver

url—the url to open a connection to

roleMapping—a HashMap of roles (String key) associated with a Username/password

pair (value stored in a Properties class)

properties—configuration options for the desired connection

poolMetaData—the PoolMetaData that will be used to create the internal

ConnectionPool

Throws:

java.lang.IllegalArgumentException—if one of the parameters is not valid

### Method Detail

1.3.8.6 getconnection

public Connection getConnection(java.lang.String role)

throws ConnectionException, AuthenticationException, AuthorizationException

Returns a Connection to this CmsServer, using the specified driver, url and properties.

Overrides:

getConnection in class CmsServer

Parameters:

role—the user role to create the Connection for

Returns:

a Connection to this CmsServer.

Throws:

ConnectionException—thrown if there is a problem

AuthenticationException—thrown if the username/password combination is invalid

AuthorizationException—if the site is inaccessible

1.3.8.7 returnConnection

public void returnConnection(Connection connection)

Returns the given Connection to this CmsServer, that will dispose of it. The default implementation juste closes the Connection, logging any Exception that may occur during this operation.

Overrides:

returnConnection in class CmsServer

Parameters:

connection—the Connection to return to this CmsServer

1.3.8.8 setPoolMetaData

private void setPoolMetaData(com.codestudio.util.PoolMetaData poolMetaData)

Sets the PoolMetaData used by this PoolingCmsServer.

Parameters:

poolMetaData—the PoolMetaData used by this PoolingCmsServer

### 1.3.9 CLASS PSEUDOPOOLINGCMSSERVER

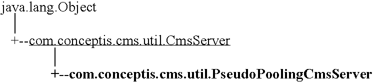

public class PseudoPoolingCmsServer

extends CmsServer

A PseudoPoolingCmsServer represents a CMS server that creates and return only a single Connection for each username/password combination, and returns the same one to multiple processes at the same time.

Field Summary

| | |
|---|---|
| private java.util.HashMap | connections |
| | A HashMap of ConnectionS, |
| | one for each role. |
| private | log |
| static org.apache.log4j.Logger | the log |

Fields inherited from class com.concepti.cms.util.CmsServer

### Constructor Summary

PseudoPoolingCmsServer(java.lang.String id, java.lang.String driverClassName, java.lang.String url, java.util.HashMap roleMapping, java.util.Properties properties)

Creates a new CmsServer that will create Connections using the given URL and properties.

Method Summary

| | |
|---|---|
| Connection | getConnection(java.lang.String role) |
| | Returns a Connection to this CmsServer, |
| | using the specified driver, url |
| | and properties. |
| void | returnConnection(Connection connection) |
| | Returns the given Connection to this |
| | CmsServer, that will dispose of it. |

Methods inherited from class com.conceptis.cms.util.CmsServer

getDriver, getId, getproperties, getProperties, getRoleMapping, getUrl, toString

Methods inherited from class java.lang.Object

clone, equals, finalize. qetClass, hashCode, notify, notifyAll, wait, wait, wait

### Field Detail

1.3.9.1 log

private static org.apache.log4j.Logger log

the log

1.3.9.2 connections

private java.util.HashMap connections

A HashMap of Connections, one for each role.

### Constructor Detail

1.3.9.3 PseudoPoolingCmsServer

public PseudoPoolingCmsServer(java.lang.String id, java.lang.String driverClassName, java.lang.String url, java.util.HashMap roleMapping, java.util.Properties properties)

throws java.lang.IllegalArgumentException

Creates a new CmsServer that will create Connections using the given URL and properties.

Parameters:

id—the unique ID of this CmsServer

driverClassName—the fully qualifed name of the Driver

url—the url to open a connection to

roleMapping—a HashMap of roles (String key) associated with a Username/password

pair (value stored in a Properties class)

properties—configuration options for the desired connection

Throws:

java.lang.IllegalArgumentException—if one of the parameters is not valid

### Method Detail

1.3.9.4 getConnection

public ConnectiongetConnection(java.lang.String role)

throws ConnectionException, AuthenticationException, AuthorizationException

Returns a Connection to this CmsServer, using the specified driver, url and properties.

Overrides:

getconnection in class CmsServer

Parameters:

role—the user role to create the Connection for

Returns:

a Connection to this CmsServer,

Throws:

ConnectionException—thrown if there is a problem

AuthenticationException—thrown if the username/password combination is invalid

AuthorizationException—if the site is inaccessible

1.3.9.5 returnConnection

public void returnConnection(Connection connection)

Returns the given Connection to this CmsServer, that will dispose of it. The default implementation juste closes the Connection, logging any Exception that may occur during this operation.

Overrides:

returnConnection in class CmsServer

Parameters:

connection—the Connection to return to this CmsServer

### 1.3.10 INTERFACE CMSMANAGER

All Known Implementing Classes:

DefaultCmsManagerImpl

public interface CmsManager

This interface is used to get a Connection to the cms.

See Also:

Connection

Method Summary

| | |
|---|---|
| void | addCmsServer(CmsServer cmsServer) |
| | Adds a CmsServer to the list of available servers. |
| void | addRoutingProperty(CmsServer cmsServer, |
| | java.lang.String propertyName, |
| | java.lang.String propertyValue) |
| | Adds a routing property to this |
| | CmsManager for the specified CmsServer. |
| CmsServer | getcmsServer(java.lang.String id) |
| | Returns the CmsServer that has the specified ID. |
| Connection | getConnection(java.lang.String role) |
| | get a Connection with role |
| Connection | getConnection(java.lang.String role, |
| | java.lang.String itemtypeName) |
| | get a Connection with role and typeName |
| void | releaseConnection (Connection conn) |
| | release the Connection to the Connection Pool. |

### Method Detail

1.3.10.1 addCmsServer

public void addCmsserver(CmsServer cmsServer)

Adds a CmsServer to the list of available servers.

Parameters:

cmsServer—the CmsServer to add to the list of available cmsservers for this

CmsManager

1.3.10.2 getCmsServer

public CmsServer getCmsServer(java.lang.String id)

Returns the CmsServer that has the specified ID.

Parameters:

id—ths unique ID of the CmsServer

Returns:

the CmsServer that has the specified ID; null if it doesn't exist

1.3.10.3 addRoutingProperty

public void addRoutingProperty(CmsServer cmsServer, java.lang.String propertyName, java.lang.String propertyValue)

Adds a routing property to this CmsManager for the specified CmsServer.

Parameters:

cmsserver—the CmsServer concerned by this routing rule

propertyName—the name of the property

propertyValue—the value of the property

1.3.10.4 getconnection

public Connection getConnection(java.lang.String role)

throws CmsException

get a Connection with role

Parameters:

role—the user role

Returns:

a Connection

Throws:

CmsException—in case of errors

1.3.10.5 getconnection

public Connection getConnection(java.lang.String role, java.lang.String itemtypeName)

throws CmsException

get a Connection with role and typeName

Parameters:

role—the user role

itemtypeName—the name of the item type

Returns:

a Connection

Throws:

CmsException—in case of errors

1.3.10.6 releaseConnection

public void releaseConnection(Connection conn)

throws CmsException

release the Connection to the Connection Pool.

Parameters:

conn—the Connection to release

Throws:

CmsException—in case of errors

The following example illustrates how the ItemFactory, Item, ItemType objects interact together in the context of a web application.

For example, a business process requires access to news articles published on a given date. The business process makes a content request for Items of ItemType “News” from the CMS. The business process is interested in the fields: “Author”, “Data published”, “Title”, and “Body” in order to create a list of available news articles. The “getNews” business process resides as a Java class running as part of a Java based Web server. The application server (or web server) is first initialized and the CMS Manager object (com.conceptis.cms.util. DefaultCmsManagerlmpl) is instantiated. Each driver is assigned to the CMS Server object and is registered with the CMS Manager. For example, the business process “getNews” is invoked by the web server to retrieve a piece of content. The business process first makes a request to the CMS Manager object to get a connection to a CMS. Once the business process has a Connection object, the business process asks the Connection object for an ItemFactory object by invoking Connection.getItemFactory. The business process can now instruct the ItemFactory to retrieve a piece of content, either by specifying the “Primary key” of the Item or other search criteria. The business process “getNews” creates an ItemSearchConstraints object and set the ItemType to “News” by invoking, constraints.addItemType (Connection.getItemTypeFactory ( ). getitemType(“News”)) and the Date constraints to the desired dates. The m ethod ItemFactory.searcho is invoked by passing the search constraints object returning a List of Items that match the search. The business process “getNews” can now iterate through the returned list extracting the Items FieId data as desired, e.g. to retrieve a given Items “Title” field, “getNews” would first get the Field object for the given ItemType using ItemType.getField(“Title”). Then, “getNews” could invoke Item.getFieldValue(Field) and be able to use the field data according to its field type (i.e. String, Date, integer, etc . . . )

The web-server, where one or more business processes (BP's) or services reside, is responsible for instantiating the CMS Manager object, which will manage any connections that the BP may require with the external CMS. The web-server then, for each previously identified CMS, creates a CMS Server object that gets registered with the CMS Manager. The web-server must be aware, typically using a configuration file, of the actual implementation class names for each CMS Server 2. The CMS Server 2, on creation, loads the actual CMS Driver Interface 4 according to a parameter. The CMS Server 2 is then responsible for relaying connection requests between the implementation class and any BP.

In other words the Connection object is the applications main entry point into the CMS. The Connection class implementation is responsible for implementing the methods that will provide access to the content Items themselves. The methods that the Connection implements include the following:

getItem Factory

getItemTypeFactory

getIndexFactory

getCmsUserFactory

The application gets the Connection object reference by calling DriverManager.getConnection method, which is able to locate the method implementation since the driver must have registered itself with the CMS Manager class as part of the driver's initialization.

The application is now able to access content Items by referencing the virtual or abstract instances of the Item class and its Fields. The application can query the Items to get information a-s to what fields the Item contains, e.g. using Item.getItemType.getFields. The application can access the Field contents by then iterating through the returned list of Fields using Item.getFieldValue(Field).

The application can also interrogate the Item to determine whether the Item is associated with other Items, in the case where the Item might be an article with one or more associated images. The application queries the Item by invoking its getRelateditems(RelationType) method. To get a list of the Items children the application invokes: Item.getRelatedItems(RelationType.CHILD). The application can further query the returned Items.

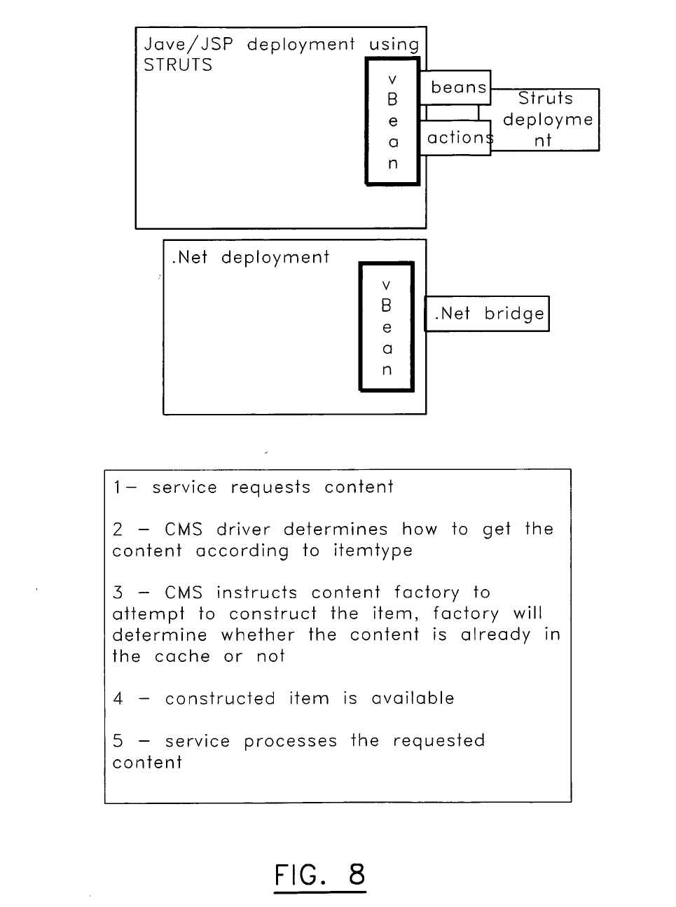

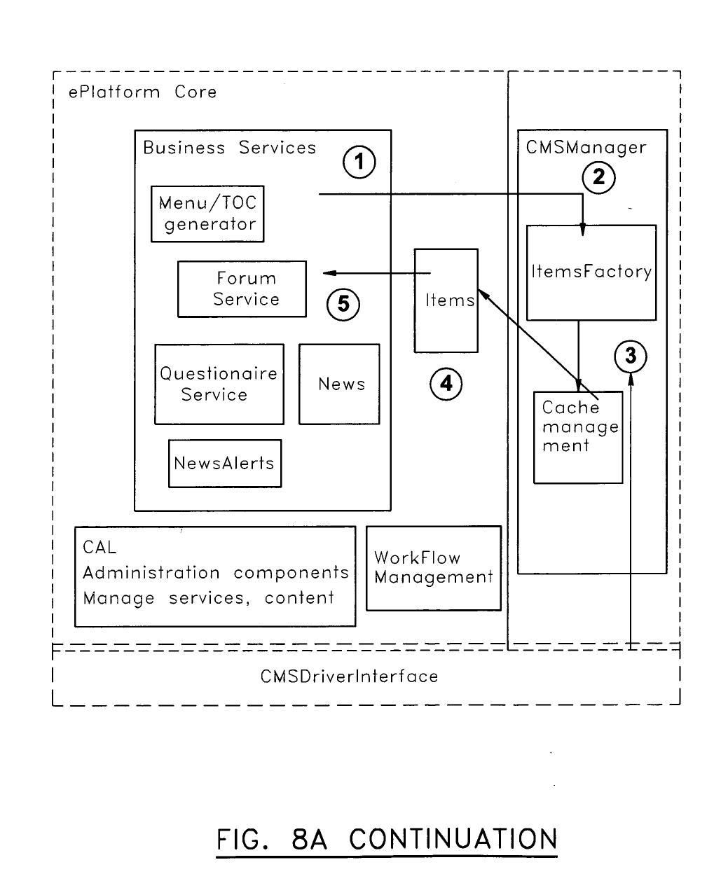

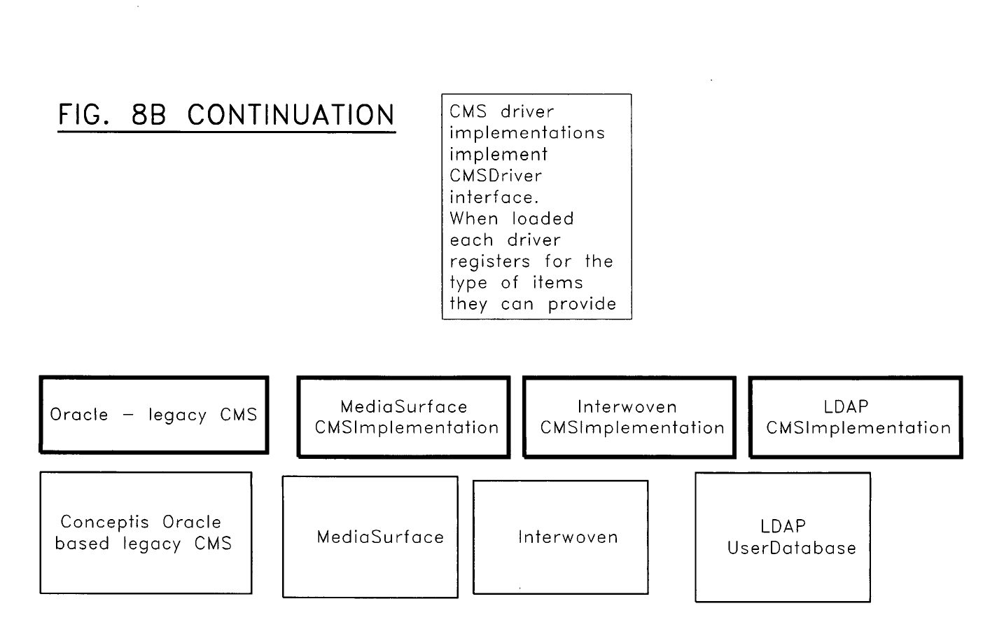

FIG. 8 shows a sample deployment model of the system of the present invention.

While a preferred embodiment of this invention have been illustrated in the accompanying drawings and described above, it will be evident to those skilled in the art that changes and modifications may be made therein without departing from the essence of this invention.

1. A method for a business process hosted on an application server to request content from at least one external content management system independently of the manner in which the content is stored, the method comprising the steps of:
a. making a content request from the business process to one of said at least one external content management ystem via a content miaiageient system server managing the content request from the business process to one of said at least one external content management system;
b. transmitting the content request between one of said at least one external content management system and the content management system server via a content management system driver interface translating a piece of content corresponding to the content request from one of said at least one external content management system into a specific object representation, the content management system driver interface being operatively associated with said at least one external content management system;
c. managing the content request from the business process to one of said at least one external content management system and keeping track of content available from one of said at least one external content management system operatively associated with the corresponding content management system driver interface via a content management system manager; and
d. relaying the specific object representation of the content from the content management system driver interface to the business process via the content management system server.

2. A system for a business process hosted on an application server to request content from at least one external content management system independently of the manner in which the content is stored, the system comprising:
a content management system server for managing a content request from the business process to the external content management system;
a content management system driver interface operatively associated with said at least one external content management system for transmitting the content request between one of said at least one external content management system and the content management system server, the content management system driver interface translating a piece of content corresponding to the content request from one of said at least one external content management system into a specific object representation; and
a content management system manager for managing the content request from the business process to one of said at least one external content managlement system and keeping track of content avaiiabie from one of said at least one external content management system operatively associated with one of the corresponding content management system driver interface,
the content management system server relaying the specific object representation of the content from the content management system driver interface to the business process.

3. The system according to claim 2, wherein the content request is a reference to an object model.

4. The system according to claim 2, wherein the content management system driver interface has a set of methods for accessing the content of the corresponding one of said at least one external content management system, the content management system driver interface forwarding the content request from the content management system server to the corresponding one of said at least one external content management system.

5. The system according to claim 2, wherein the content management system server, the content management system manager and the content management system driver interface are all class implemented.

6. The system according to claim 2, wherein the business process establishes a connection with one of said at least one external content management system via the content management system manager, the content management system manager returning a connection status to the business process.

7. The system according to claim 2, wherein the content management system driver interface comprises at least one driver, said at least one driver being operatively associated with one of said at least one external content management system, the driver establishing a connection to and communicating with the corresponding one of said at least one external content management system using specific parameters.

8. The system according to claim 7, wherein the content management system manager determines which one of said at lea-st one driver operatively associated with one of said at least one external content management system has access to a content referred to in the content request.

9. The system according to claim 7, wherein the content management system manager comprises means for registering and unregistering said at least one driver, the content management system manager providing a connection to one of said at least one external content management system via a corresponding one of said registered driver.

10. The system according to claim 7, further comprising a content management system security manager for controlling a n access to functionalities of said at least one driver.

11. The system according to claim 10, wherein the specific parameters comprise an URL and a set of credentials, the content management system security manager controlling access to one of said at least one driver according to the set of credentials.
